(19) United States
(12) Patent Application Publication
(10) Pub. No.: US 2011/0130299 A1
(43) Pub. Date: Jun. 2, 2011

(54) PLASTIDIAL MICROARRAY

(75) Inventors: Regis Mache, Biviers (FR); Silva Mache, Bivirs (FR)

(73) Assignees: UNIVERSITE JOSEPH FOURIER (GRENOBLE 1), GRENOBLE (FR); CENTRE NATIONAL DE LA RECHERCHE SCIENTIFIQUE, BIVIERS (FR)

(21) Appl. No.: 12/376,351

(22) PCT Filed: Aug. 3, 2007
(86) PCT No.: PCT/FR2007/001345

§ 371 Date: Jun. 10, 2009

(30) Foreign Application Priority Data
Aug. 4, 2006 (FR) 06/07168

(51) Int. Cl. C40B 30/04; C40B 40/06; C40B 50/00

(52) U.S. Cl. 506/9; 506/16; 506/23

(57) ABSTRACT

The present invention relates to a plastidial microarray comprising a solid support which comprises a multiplicity of elemental sites, each elemental site comprising several copies of the same nucleic acid probe, said probe being single-stranded, comprising between 50 and 70 nucleotides and corresponding to a sense oligonucleotide in a chloroplastid gene of Arabidopsis thaliana or to an antisense oligonucleotide in a chloroplastid gene of Arabidopsis thaliana, the entire chloroplastid coding genome of Arabidopsis thaliana being represented on the microarray.

The present invention relates in general to the field of microarrays and to the use thereof in measuring the expression of plant genes. More particularly, the present invention relates to a plastidial microarray on which are immobilized probes specific for the transcription products of chloroplastid genes of Arabidopsis thaliana.

Many biological functions depend on the regulation of gene expression levels, either by variation in transcription levels, for example, by controlling when and at what frequency a given gene is transcribed, or by variations in protein synthesis, for example, by selecting which mRNAs are translated by the ribosomes or by selectively activating or inactivating proteins after they have been synthesized. Microarray technology, which enables the multiple detection of DNA in a sample concomitantly by virtue of a support comprising a plurality of immobilized nucleic acid probes, lends itself perfectly to the measurement of gene expression.

The principle of the microarray is based on the hybridization technique. Single-stranded oligonucleotides specific for various genes or cDNA derived from an RT-PCR, constituting the probes, are immobilized on a solid support, also called template. The role of the probes is to detect complementary nucleic targets present in the complex mixture to be analyzed (mRNAs extracted from cells, tissues or whole organisms and converted to cDNA). These probes can be immobilized on the support or synthesized in situ. The hybridization signals are detected according to the type of labeling chosen: radioactivity or fluorescence, and optionally quantified.

A great deal of progress has been accomplished in microarray technology. Such an expansion has led to the use of instruments derived from high-tech applications and computer programs. In 1991, a method for the fabrication of an oligonucleotide chip by chemical synthesis in situ, base by base, using photolithography, which made it possible to achieve a density of 1 million probes per cm² was described. At the same time such a development led to the complexifying of the templates. In 1997, the complete genome of the yeast Saccharomyces cerevisiae was represented on a microarray. Today, several companies propose microarrays covering the entire human genome. Such microarrays require sophisticated detection systems (i.e. microarray scanners), which deprives a large number of research laboratories or small organizations of this technology.

V. Stoic et al. (PNAS 2005, 102, 4453-4458) describe the use of a microarray of the complete Arabidopsis thaliana genome, comprising 5 million 36-mer oligonucleotides. The analysis of 5 million probes present on the microarray requires the use of complex tools.

It will be noted, in addition, that chips which comprise a very large number of elemental probes have the drawback of being expensive, which further limits their use.

An object of the present invention is to provide a microarray which does not involve the use of sophisticated detection systems. This is possible due to the fact that the total number of probes immobilized on the support is less than 250, which enables direct reading without the use of sophisticated reading equipment. This is as opposed to the microarrays comprising a very large number of elemental probes, greater than 1000, or even than 10 000 or more.

Many scientific fields have found an advantage in using microarrays. This is in particular the case of plant biology, where the microarray has many applications. Mention may be made, for example, of the subfield of transgenic plants. By way of indication, in document US 2006/015970 which describes nucleotide sequences that are useful for obtaining transgenic plants, the microarray is used for measuring the mRNA levels in the transformed plant cells and it enables the simultaneous verification of levels of transcripts of thousands of genes. Once again the size of the plant genome implies complexifying of the microarray.

Another object of the present invention is to provide a microarray which is useful in the plant field and which is less complex than those described to date in the prior art.

Plant cells comprise three types of DNA: nuclear DNA, mitochondrial DNA and plastid DNA. Microarrays carrying nuclear gene sequences were the first to appear on the market.

At this time, measuring the expression of plastid genes is of great interest. This is because more and more industries use plasts, in particular chloroplasts, for the production of proteins and a system of verification must therefore be set up.

In addition, if one considers that herbicides affect chloroplast functions, the microarray also finds an application in the herbicide field, where it may, for example, make it possible to correlate the use of herbicides with the expression of a chloroplast gene.

Arabidopsis thaliana is a model plant in genetics. The sequencing of its genome indicates a genome size of 125 Mb and 29 000 genes encoding proteins are predicted. Its plastid genome is composed of about one hundred copies of a circular plastid chromosome of approximately 150 kb. Each plastid genome comprises approximately 120 genes, of which close to 80 encode proteins. Arabidopsis thaliana has many advantages related to the ease with which it can be cultured in the laboratory, its rapid development and its prolific character.

An object of the present invention is to provide a simple system for evaluating the expression of all the plastid genes, which is applicable to several higher plants.

Jean-Jacques Favory and al. (Nucleic Acids Research, 2005; 33(18): 5991-9) have studied the expression of the SIG4 gene in a sig4 mutant of Arabidopsis thaliana and used a plastidial microarray prepared from Arabidopsis thaliana, the microarray being prepared from PCR products. Immobilizing double-stranded nucleic material at the surface of the support has the drawback of not allowing a distinction to be made between the expression of the gene and the expression of the anti-sense strand, which is today fundamental in order to demonstrate new methods of regulation of plastid gene expression.

An object of the present invention is to provide a microarray which allows a very specific hybridization of the transcripts and a distinction to be made between the expression of the gene and the expression of the anti-sense strand.

The present invention provides a microarray which satisfies all these objects.

### SEQUENCE DESCRIPTION

SEQ ID No. 1: Oligonucleotide probe of the L23 gene of Arabidopsis thaliana
SEQ ID No. 2: Oligonucleotide probe of the ndhB gene of Arabidopsis thaliana
SEQ ID No. 3: Oligonucleotide probe of the gene rps7 of Arabidopsis thaliana
SEQ ID No. 4: Oligonucleotide probe of the ccsA(ycf5) gene of Arabidopsis thaliana
SEQ ID No. 5: Oligonucleotide probe of the ArthCp072 rpl32 gene of Arabidopsis thaliana
SEQ ID No. 6: Oligonucleotide probe of the L2 gene of Arabidopsis thaliana
SEQ ID No. 7: Oligonucleotide probe of the petD gene of Arabidopsis thaliana
SEQ ID No. 8: Oligonucleotide probe of the petB gene of Arabidopsis thaliana
SEQ ID No. 9: Oligonucleotide probe of the psbH gene of Arabidopsis thaliana
SEQ ID No. 10: Oligonucleotide probe of the psbT gene of Arabidopsis thaliana
SEQ ID No. 11: Oligonucleotide probe of the psbB gene of Arabidopsis thaliana
SEQ ID No. 12: Oligonucleotide probe of the rpl33 gene of Arabidopsis thaliana
SEQ ID No. 13: Oligonucleotide probe of the psaJ gene of Arabidopsis thaliana
SEQ ID No. 14: Oligonucleotide probe of the petG gene of Arabidopsis thaliana
SEQ ID No. 15: Oligonucleotide probe of the petL gene of Arabidopsis thaliana
SEQ ID No. 16: Oligonucleotide probe of the petA gene of Arabidopsis thaliana
SEQ ID No. 17: Oligonucleotide probe of the cemA(ycf10) gene of Arabidopsis thaliana
SEQ ID No. 18: Oligonucleotide probe of the ycf4 gene of Arabidopsis thaliana
SEQ ID No. 19: Oligonucleotide probe of the psal gene of Arabidopsis thaliana
SEQ ID No. 20: Oligonucleotide probe of the rbcL gene of Arabidopsis thaliana
SEQ ID No. 21: Oligonucleotide probe of the psbZ(ycf9) gene of Arabidopsis thaliana
SEQ ID No. 22: Oligonucleotide probe of the psbC gene of Arabidopsis thaliana
SEQ ID No. 23: Oligonucleotide probe of the psbD gene of Arabidopsis thaliana
SEQ ID No. 24: Oligonucleotide probe of the ycf6(petN) gene of Arabidopsis thaliana
SEQ ID No. 25: Oligonucleotide probe of the psbl gene of Arabidopsis thaliana
SEQ ID No. 26: Oligonucleotide probe of the psbK gene of Arabidopsis thaliana
SEQ ID No. 27: Oligonucleotide probe of the rps18 gene of Arabidopsis thaliana
SEQ ID No. 28: Oligonucleotide probe of the accD gene of Arabidopsis thaliana
SEQ ID No. 29: Oligonucleotide probe of the rps12(transsplicing) gene of Arabidopsis thaliana
SEQ ID No. 30: Oligonucleotide probe of the ycf2 gene of Arabidopsis thaliana
SEQ ID No. 31: Oligonucleotide probe of the orf77 gene of Arabidopsis thaliana
SEQ ID No. 32: Oligonucleotide probe of the ycf1 gene of Arabidopsis thaliana
SEQ ID No. 33: Oligonucleotide probe of the rps15 gene of Arabidopsis thaliana
SEQ ID No. 34: Oligonucleotide probe of the ndhH gene of Arabidopsis thaliana
SEQ ID No. 35: Oligonucleotide probe of the ndhA gene of Arabidopsis thaliana
SEQ ID No. 36: Oligonucleotide probe of the ndhl gene of Arabidopsis thaliana
SEQ ID No. 37: Oligonucleotide probe of the ndhG gene of Arabidopsis thaliana
SEQ ID No. 38: Oligonucleotide probe of the ndhE gene of Arabidopsis thaliana
SEQ ID No. 39: Oligonucleotide probe of the psaC gene of Arabidopsis thaliana
SEQ ID No. 40: Oligonucleotide probe of the ndhD gene of Arabidopsis thaliana
SEQ ID No. 41: Oligonucleotide probe of the ndhF gene of Arabidopsis thaliana
SEQ ID No. 42: Oligonucleotide probe of the ycf1 gene of Arabidopsis thaliana
SEQ ID No. 43: Oligonucleotide probe of the rps19 gene of Arabidopsis thaliana
SEQ ID No. 44: Oligonucleotide probe of the rpl22 gene of Arabidopsis thaliana
SEQ ID No. 45: Oligonucleotide probe of the rps3 gene of Arabidopsis thaliana
SEQ ID No. 46: Oligonucleotide probe of the rpl16 gene of Arabidopsis thaliana
SEQ ID No. 47: Oligonucleotide probe of the rpl14 gene of Arabidopsis thaliana
SEQ ID No. 48: Oligonucleotide probe of the rps8 gene of Arabidopsis thaliana
SEQ ID No. 49: Oligonucleotide probe of the rpl36 gene of Arabidopsis thaliana
SEQ ID No. 50: Oligonucleotide probe of the rps11 gene of Arabidopsis thaliana
SEQ ID No. 51: Oligonucleotide probe of the rpoA gene of Arabidopsis thaliana
SEQ ID No. 52: Oligonucleotide probe of the psbN gene of Arabidopsis thaliana
SEQ ID No. 53: Oligonucleotide probe of the clpP gene of Arabidopsis thaliana
SEQ ID No. 54: Oligonucleotide probe of the rpl20 gene of Arabidopsis thaliana
SEQ ID No. 55: Oligonucleotide probe of the psbE gene of Arabidopsis thaliana
SEQ ID No. 56: Oligonucleotide probe of the psbF gene of Arabidopsis thaliana
SEQ ID No. 57: Oligonucleotide probe of the psbL gene of Arabidopsis thaliana
SEQ ID No. 58: Oligonucleotide probe of the psbJ gene of Arabidopsis thaliana
SEQ ID No. 59: Oligonucleotide probe of the atpB gene of Arabidopsis thaliana
SEQ ID No. 60: Oligonucleotide probe of the atpE gene of Arabidopsis thaliana
SEQ ID No. 61: Oligonucleotide probe of the ndhC gene of Arabidopsis thaliana
SEQ ID No. 62: Oligonucleotide probe of the ndhK gene of Arabidopsis thaliana
SEQ ID No. 63: Oligonucleotide probe of the ndhJ gene of Arabidopsis thaliana
SEQ ID No. 64: Oligonucleotide probe of the rps4 gene of Arabidopsis thaliana
SEQ ID No. 65: Oligonucleotide probe of the ycf3(psa assembly) gene of Arabidopsis thaliana
SEQ ID No. 66: Oligonucleotide probe of the psaA gene of Arabidopsis thaliana
SEQ ID No. 67: Oligonucleotide probe of the psaB gene of Arabidopsis thaliana
SEQ ID No. 68: Oligonucleotide probe of the rps14 gene of Arabidopsis thaliana
SEQ ID No. 69: Oligonucleotide probe of the psbM gene of Arabidopsis thaliana
SEQ ID No. 70: Oligonucleotide probe of the rpoB gene of Arabidopsis thaliana
SEQ ID No. 71: Oligonucleotide probe of the rpoC1 gene of Arabidopsis thaliana
SEQ ID No. 72: Oligonucleotide probe of the rpoC2 gene of Arabidopsis thaliana
SEQ ID No. 73: Oligonucleotide probe of the rps2 gene of Arabidopsis thaliana
SEQ ID No. 74: Oligonucleotide probe of the atpl gene of Arabidopsis thaliana
SEQ ID No. 75: Oligonucleotide probe of the atpH gene of Arabidopsis thaliana
SEQ ID No. 76: Oligonucleotide probe of the atpF gene of Arabidopsis thaliana
SEQ ID No. 77: Oligonucleotide probe of the atpA gene of Arabidopsis thaliana
SEQ ID No. 78: Oligonucleotide probe of the rps16 gene of Arabidopsis thaliana
SEQ ID No. 79: Oligonucleotide probe of the matK gene of Arabidopsis thaliana
SEQ ID No. 80: Oligonucleotide probe of the psbA gene of Arabidopsis thaliana
SEQ ID No. 81: Plastid genome of Arabidopsis thaliana

### DESCRIPTION OF THE INVENTION

The present invention relates to a plastidial microarray comprising a solid support or template which comprises a multiplicity of elemental sites, each elemental site comprising several copies of the same nucleic acid probe, said probe being single-stranded, comprising between 50 and 70 nucleotides and corresponding to a sense oligonucleotide in a chloroplastid gene of Arabidopsis thaliana or to an anti-sense oligonucleotide in a chloroplastid gene of Arabidopsis thaliana, the entire chloroplastid coding genome of Arabidopsis thaliana being represented on the microarray.

The present invention also relates to a method for preparing the microarray as defined above, according to which:
a) a solid support is provided, and
b) the probes are attached to the surface of the support.
The present invention also relates to a detection method for the microarray as defined above, comprising:
a) bringing the target nucleic sample into contact with the microarray, so as to allow hybridization,
b) detecting the hybridization.

The present invention also relates to the use of the microarray as defined above, for establishing a plast gene expression profile in plants.

The present invention also relates to a set of probes for measuring plant plast gene expression, comprising at least two probes chosen from:
(a) an oligonucleotide according to any one of the sequences SEQ ID Nos:1 to 80,
(b) an antisense oligonucleotide of any one of the sequences SEQ ID Nos:1 to 80,
(c) an oligonucleotide having at least 70% identity with the oligonucleotide according to (a) or (b).

Finally, the present invention relates to a kit comprising a microarray as defined above.

### Microarray

The present invention therefore relates to a microarray for the determination (existence or not, and/or measurement) of the expression of the plant plastid genes.

The term “microarray” is intended to mean a solid support, or template, comprising nucleic material immobilized at elemental sites, where appropriate pinpointed according to any suitable reference point. According to the present invention, each elemental site comprises several copies of the same nucleic acid probe. The elemental sites are, for example, arranged in lines and columns.

The term “antisense oligonucleotide” is intended to mean any single-stranded oligonucleotide complementary to the oligonucleotide fragment of the coding strand (or sense strand). For example, the nucleotide sequence 5′ GCACG 3′ has the antisense sequence 5′ CGTGC 3′.

The support to which the nucleic material is attached is in the form of a surface which is planar, porous, or pierced with wells. It comprises a working face or operating surface comprising the immobilized nucleic material (i.e. the probes) intended to be brought into contact with the sample.

The material constituting such a support is, for example silicon, a glass, or a plastic, for example a thermoset or thermoplastic synthetic resin, for example a polypropylene or a polyacrylamide resin. The support may comprise several materials, for example a hard material, such as glass, on which a nylon membrane or a nitrocellulose membrane is deposited. According to the present invention, the material constituting the support is a non-electrically conducting material.

The microarray of the present invention is square or rectangular in shape and has a size of less than 100 cm², for example less than 10 cm².

The microarray of the invention may or may not be for single use. It is used for the purposes of a molecular biological determination.

This microarray may be used with a distinct and complementary apparatus or instrument.

The microarray of the invention is brought into contact with a liquid or fluid, immobile or moving sample of interest, comprising at least one target species, in suspension or in solution, which is optionally labelled and which produces at least one signal in relation to the presence, and/or the nature, and/or the structure and/or the amount of said target species. This sample of interest is referred to as “target nucleic sample” according to the present invention.

According to the present invention, each elemental site of the support comprises several copies of the same nucleic acid probe.

The term “probe” is intended to mean any DNA sequence corresponding to a part of a given gene and which specifically recognizes it. The probes immobilized at each elemental site of the support are single-stranded, i.e. one strand. They comprise between 50 and 70 nucleotides, preferably between 55 and 65 nucleotides, advantageously 60±1 nucleotides. The length of the probes is chosen so as to be optimal, between a minimum which would be the limit of specificity of the hybridization and a maximum which would render error-free synthesis difficult and expensive.

The probes of the present invention may be prepared by the conventional techniques of organic chemistry synthesis in automated devices. They are referred to as synthetic oligoprobes. In general, the phosphoramidite chemical process is used for the synthesis of oligonucleotides. Once synthesized by microprocessor-controlled automated machines, the oligonucleotide should be purified in order to remove the products of reactions having come to nothing. This purification may be carried out by preparative acrylamide gel electrophoresis, by HPLC on a reverse phase column or by ion exchange.

Each probe corresponds to a fragment of a chloroplastid coding gene of Arabidopsis thaliana. The nucleotide sequences of the probes are chosen so as to allow the hybridization of complementary target nucleotide sequences, isolated from various higher plants of agronomic interest. In other words, each probe should be generic. Arabidopsis thaliana is a model plant in genetics. Similarities exist between the plastid genomes of the various species of plants. For each gene considered, the inventors have therefore sought and demonstrated similarities between the sequences of various species of plants, and found probes capable of hybridizing genetic material derived from various species. The sequences chosen are common to several plants with a defined percentage identity or similarity.

The genome of Arabidopsis thaliana, including its plastid genome, has at this time been entirely sequenced. The sequences of the plastid genome of Arabidopsis thaliana are accessible on the site http://www.ncbi.nlm.nih.gov/using the code NC_{—}000932. The plastid genome of Arabidopsis thaliana is repeated in its entirety in SEQ ID No. 81. The inventors have compared the coding sequences of the chloroplastid genes of this plant with those of chloroplastid genes of other model plants, in particular tomato, rice, corn, tobacco, alfalfa, wheat and spinach, i.e. other plants of agronomic interest. The methods for measuring and identifying the degree of identity and the degree of similarity between the nucleic acid sequences are well known to those skilled in the art. Use may, for example, be made of Vector NTi Vector NTi 9.1.0, alignment program AlignX (Clustal W algorithm) (Invitrogen INFORMAX, http://www.invitrogen.com). The default parameters are preferably used.

According to one embodiment of the invention, the sequence of each probe is chosen so as to be more than 50% identical with a nucleic sequence of at least one plant chosen from tomato, alfalfa, tobacco, rice, spinach, wheat and corn.

The term “identity” or “probes having a certain percentage identity”, is intended, to mean oligonucleotides which are invariant or unchanged to within the defined percentage between two sequences. These oligonucleotides may have a deletion, an addition or a substitution of at least one nucleotide compared with the reference oligonucleotide.

Advantageously, the sequence of each probe is chosen so as to be more than 60%, 65%, 70%, 75%, 80%, 85%, 90%, 95% and preferably 98%, with a nucleic sequence of at least one plant chosen from tomato, alfalfa, tobacco, rice, spinach, wheat and corn.

According to another embodiment of the present invention, the sequence of each probe is chosen so as to be more than 50% identical with a nucleic sequence of at least two plants chosen from tomato, alfalfa, tobacco, rice, spinach, wheat and corn.

Advantageously, the sequence of each probe is chosen so as to be more than 60%, 65%, 70%, 75%, 80%, 85%, 90%, 95% and preferably 98% identical with a nucleic sequence of at least two plants chosen from tomato, alfalfa, tobacco, rice, spinach, wheat and corn.

The plastid genome of these plants is accessible at the site http://www.ncbi.nlm.nih.gov/ using the following codes:

| | |
|---|---|
| Tomato | NC_007898 |
| Alfalfa | NC_003119 |
| Tobacco | NC_001879 |
| Rice | NC_001320 |
| Spinach | NC_002202 |
| Wheat | NC_002762 |
| Corn | NC_001666 |

According to the present invention, the probes are also chosen so as not to exhibit either internal secondary structures which prevent hybridization or internal repeats above a threshold of 6 nucleotides.

The hybridization conditions are specified hereinafter.

In addition, according to one embodiment of the present invention, the probes are chosen so as to “homogenize” the distance from the first nucleotide of the probe in 5′ to the initiating codon of the corresponding Arabidopsis thaliana gene. The term “homogenize” should be understood to mean that the probes are chosen in such a way that the distance between the 1^{st} nucleotide of the probe and the initiating ATG of the chloroplastid gene of Arabidopsis thaliana is preferably less than 200 nucleotides for a maximum number of probes of the microarray. There are many advantages to homogenizing the distances. Among these is, in particular the possibility of direct analysis of the transcripts produced in vitro. In fact, such transcripts labeled in vitro can hybridize even if the extension of the transcript is incomplete. The homogenization of the distances also allows a semiquantitative analysis of the expression of the genes between one another. This is because, when the labeled sequences are located at the same distance from the initiating ATG, it is possible to readily compare the relative amounts of the transcripts from one gene to the other, for example by means of labeling the target nucleic acids by the “run on” method. Thus, advantageously as regards the probes of the plastidial microarray, at least 50% of the sequences corresponding to a sense oligonucleotide in a chloroplastid gene of Arabidopsis thaliana are chosen so as to be located less than 200 nucleotides from the initiating codon. Even more advantageously, at least 70%, 80% or 90% of the sequences corresponding to a sense oligonucleotide in a chloroplastid gene of Arabidopsis thaliana are chosen so as to be located less than 200 nucleotides from the initiating codon.

According to the present invention, the entire plastid coding genome of Arabidopsis thaliana is represented on the microarray. The plastid genome of this plant may be described as small since it comprises 111 genes, among which are 80 genes encoding proteins, the rRNA genes and tRNA genes. Thus according to the present invention, at least all the 80 genes encoding proteins of the plastid genome of Arabidopsis thaliana are represented on the microarray. Advantageously, all the 80 genes encoding proteins of the plastid genome of Arabidopsis thaliana and at least one gene of the rRNA or tRNA is represented on the microarray. Even more advantageously, the entire plastid genome of Arabidopsis thaliana is represented on the microarray, i.e. 111 genes.

According to the invention, oligoprobes of these genes and oligoprobes of the antisense strand of these genes are immobilized on the support of the microarray with a view to measuring the expression of plant plastid genes and the antisense expression of these genes. This is possible because the probes are single-stranded. The prior art overall (Nagashima, Akitomo et al. (Bioscience, Biotechnology, and Biochemistry 2004, 68(3), 694-704); Nakamura, Takahiro et al. (Plant and Cell Physiology 2003, 44(8), 861-867); Legen Julia et al. (Plant Journal 2002, 31, 2, 171-188)) describes microarrays on which PCR product deposits are made. Such microarrays do not make it possible to distinguish the sense and antisense expression of genes.

The number of probes is dependant on the number of genes represented on the microarray. When the entire plastid genome of Arabidopsis thaliana of the 80 genes encoding proteins is present on the microarray, the number of probes is 160 (80 sense oligoprobes and 80 antisense oligoprobes) if each elemental site comprises several copies of one and the same probe. If each elemental site of the support of the microarray comprises several copies of a first nucleic acid probe and several copies of a second nucleic acid probe, which is the antisense of the first probe, then the microarray comprises 80 elemental sites. When the entire plastid genome of Arabidopsis thaliana is represented on the microarray, the number of probes is 222 (111 sense oligoprobes and 111 antisense oligoprobes) if each elemental site comprises several copies of one and the same probe. In addition, on the condition that each elemental site of the support comprises several copies of one and the same probe, the support comprises between 160 and 222 elemental sites. If each elemental site of the support of the microarray comprises several copies of a first nucleic acid probe and several copies of a second nucleic acid probe, which is the antisense of the first probe, then the support comprises between 80 and 111 elemental sites.

Of course, it may be that the microarray of the present invention is represented on more than one support if it is not possible to deposit all the probes on one and the same support.

According to one embodiment of the present invention, it is possible to label the probes, rather than labeling the target nucleic sample. In general, the labeling of the nucleic material makes it possible to detect the hybridization.

According to another embodiment of the present invention, each elemental site of the support of the microarray comprises several copies of a first nucleic acid probe and several copies of a second nucleic acid probe, which is an antisense of the first probe, the two probes being labeled differently.

In a preferred embodiment, each of the probes is chosen from the group of the following sequences:
(a) an oligonucleotide according to any one of the sequences SEQ ID Nos. 1 to 80,
(b) an antisense oligonucleotide of any one of the sequences SEQ ID Nos. 1 to 80,
(c) an oligonucleotide having at least 70% identity with the oligonucleotide according to (a) or (b).

The invention relates to a microarray at the surface of which is found, at each elemental site of the support, an oligonucleotide comprising between 50 and 70 nucleotides, preferably between 55 and 65 nucleotides, advantageously 60±1 nucleotides. This oligonucleotide is chosen from the group constituted of SEQ ID Nos. 1 to 80, an antisense oligonucleotide of one of SEQ ID Nos. 1 to 80 and an oligonucleotide having at least 70% identity with the one of SEQ ID Nos. 1 to 80. The oligonucleotide may advantageously be chosen from oligonucleotides having at least 70%, 75%, 80%, 85%, 90%, 95%, 98% and preferably at least 99% identity with the one of the sequences SEQ ID Nos. 1 to 80.

The term “identity” or “oligonucleotides having a certain percentage identity”, is intended to mean oligonucleotides which are invariant or unchanged to within the defined percentage between two sequences. These oligonucleotides may, for example, have a deletion, an addition or a substitution of at least one nucleotide compared with the reference oligonucleotide.

For information purposes, many molecular biology techniques are described by Sambrook et al. (Molecular Cloning: A Laboratory Manual, 1989).

### Method for Preparing the Microarray

The present invention also relates to a method for preparing the microarray, according to which method:
a) a support as defined above is provided,
b) the probes are attached to the surface of the support.

As regards the actual attachment, a micropipette, for example manual or automated, may be used. According to one embodiment of the present invention, a substance which attaches the probes to the surface of the support is optionally added. By way of indication, mention may be made of polylysine.

### Detection Method

The present invention also relates to a detection method for the microarray as defined above, said method comprising:
a) bringing the target nucleic sample into contact with the microarray, so as to allow hybridization, and
b) detecting the hybridization.

The hybridization conditions are specified hereinafter.

The term “target nucleic sample” is intended to mean a nucleic sample capable of hybridizing selectively to the oligonucleotides immobilized at the surface of the support, called probes, and an integral part of the microarray according to the invention (G-C and T-A pairing).

The target nucleic sample needs to be prepared.

The cDNA is obtained with an RNA reverse transcriptase using a primer complementary to the transcript in a region positioned in the gene as close as possible to the oligonucleotide acting as probe or using a random hexanucleotide.

The target sequences hybridized with the probe sequences at a level significantly above the background noise. The level of the signal generated by the interaction between the sequence capable of selectively hybridizing and the probe sequence is generally 10 times, preferably 100 times, more intense than that of the interaction of the other DNA sequences generating the background noise. The stringent hybridization conditions which allow selective hybridization are well known to those skilled in the art. In general, the hybridization and washing temperature is at least 5° C. below the Tm of the reference sequence at a given pH and for a given ionic strength.

Typically, the hybridization temperature is at least 30° C. for an oligonucleotide of 15 to 50 nucleotides and at least 60° C. for an oligonucleotide of more than 50 nucleotides. By way of example, the hybridization is carried out in the following buffer: 6×SSC, 50 mM Tris-HCI (pH 7.5), 1 mM EDTA, 0.02% PVP, 0.02% Ficoll, 0.02% BSA and 500 μg/ml of denatured salmon sperm DNA. The washes are, for example carried out successively at low stringency in a 2×SSC, 0.1% SDS buffer, at medium stringency in a 0.5×SSC, 0.1% SDS buffer, and at high stringency in a 0.1×SSC, 0.1% SDS buffer. The hybridization can, of course, be carried out according to other customary methods known to those skilled in the art (see in particular Sambrook et al., Molecular Cloning: A Laboratory Manual, 1989).

Step a) of the method is also called the probe-target hybridization phase.

According to the present invention, the probe oligonucleotide or the target nucleic material may be labeled.

The term “labeling” or “labeled” is intended to mean the characteristic according to which a label, i.e. a substituent or residue which makes it possible, with or without the aid of an outside means, such as illumination, with or without a subsequent step, such as bringing into contact with a substrate, to produce a detectable signal is attached to an entity, covalently or in another manner. A distinction is made between labeling with radioactive isotopes and nonradioactive labeling. With regard to radioactive labeling, in practice ³²P, ³⁸S and ³H are the three radio elements used in molecular biology. Nucleotides labeled with ³²P must be used in the days which follow since ³²P has a short half-life (15 days). 10⁸ cpm/μg of nucleic acids are on average necessary. The lifetime of ³⁵S is four times longer, but the analyses are less sensitive. With regard to nonradioactive labeling or cold labeling, a large number of systems exist. Some make use of a pair of ligands, for example, avidin or streptavidin and biotin. In this case, the biotin is incorporated into the target nucleic material. By way of indication, mention may also be made of the system based on cytosines sulphonation and the system based on bioluminescence. The nucleic material may also be labeled using a fluorochrome.

The target nucleic sample may also be 5′-labeled with a T4 polynucleotide kinase or 3′-labeled with a T4 RNA ligase.

It may also be labeled in vitro by synthesis of RNA in the presence of a labeled nucleotide, by transcription of a template or by the “run on” technique, according to which the cells are incubated in the presence of radioactive ribonucleoside triphosphates. After washing and autoradiography, the intensity of the spots is proportional to the amount of RNA neosynthesized and therefore to the level of transcription. This technique is mainly comparative. It makes it possible to assess variations in the level of transcription, with the proviso that these variations are sufficiently large.

According to one embodiment of the present invention, the nucleic acid probes are labeled, so as to allow the detection of the hybridization.

Step b) of the method consists in detecting the hybridization. It involves determining the probes which have been effectively hybridized, that is to say identifying the places at which the probes are complementary to the targets of the nucleic sample.

The hybridization signals are detected according to the type of labeling, radioactive or fluorescence, by radiographic measurement or by fluorescence, and quantified.

For example, optical reading makes it possible to reveal the probes that have become fluorescent, hybridized with the labeled target nucleic material. The data collected can be analyzed by means of image-processing software.

According to one embodiment of the present invention, the bringing into contact step is carried out by incubation of the microarray in the presence of a hybridization buffer comprising the labeled target nucleic sample. By way of indication, this latter is labeled by fluorescence, i.e. using a fluorochrome which becomes fluorescent when it is excited by a light beam. The hybridization buffer is subsequently removed, then the microarray is exposed to a second volatile, washing buffer which does not denature the specific hybridization at the surface of the microarray. The washing is intended to remove the nonhybridized nucleic targets from the microarray. The second buffer is removed and this second buffer is allowed to evaporate for a sufficient period of time. Finally, the filter is laid on a photosensitive screen placed in a cassette, and then, after a variable exposure time in the dark, the screen is scanned with a fluorescence or radioactivity scanner (typically a phosphor imager).

### Set of Probes

The invention also relates to sets of probes for establishing a plant plastid gene expression profile. Each probe is specific for a transcription product of a chloroplastid gene of Arabidopsis thaliana. The probes are capable of hybridizing under stringent conditions or under conditions for hybridization on a microarray, with RNA transcripts of the genes of other plants, or complements of these transcripts.

In one particular embodiment, the set of probes described comprises one or more probes which are each directed against one of the following sequences:
(a) an oligonucleotide according to any one of the sequences SEQ ID Nos. 1 to 80,
(b) an antisense oligonucleotide of any one of the sequences SEQ ID Nos. 1 to 80,
(c) an oligonucleotide having at least 70% identity with the oligonucleotide according to (a) or (b).

### Use

The present invention also relates to the use of the microarray as defined above, for establishing a plast gene expression profile in plants.

### Kit

The present invention also relates to a kit comprising a microarray as defined above.

According to one embodiment of the present invention, the kit also comprises the support, the solutions for the hybridization and the labeling, for example the fluorescence labeling of the target RNA, and/or the protocols for isolating the RNA suitable for the various plants.

### DESCRIPTION OF THE FIGURES

FIG. 1: microarray after hybridization of the target nucleic sample isolated from wild-type Arabidopsis thaliana plantlets.

FIG. 2: microarray after hybridization of the target nucleic sample isolated from Arabidopsis thaliana plantlets of a particular mutant.

### EXAMPLES

### A. Fabrication of the Microarray

### 1. Choice of Probes

On the basis of the plastid genome of Arabidopsis thaliana (see reference NC_{—}000932 at http://www.ncbi.nlm.nih.gov/ with regard to the chloroplastid genome of Arabidopsis thaliana or SEQ ID no. 81), the probes of which the sequences are defined hereinafter are selected as having a universal nature, in particular with respect to the chloroplastid genes of other plants, especially tomato, rice, corn and spinach.

For example, choice of the probe SEQ ID No. 29-gene rps12

| | |
|---|---|
| | TACCAGGTATATAAGCAGTGATTTCAAATCCCGAGGTTAATCGTACTCTGGCAACTTTAC |
| Tomato | TACCGGGTATATAAGCAGTGATTTCAAATCCAGAGGTTAATCGTACTCTGGCAACTTTAC |
| NC_007898 | |
| | Position: between nucleotide No. 99942 and 100001 |
| | Identity = 58/60 i.e. 96%, Gaps = 0/60 i.e. 0% |
| | TACCAGGTATATAAGCAGTGATTTCAAATCCCGAGGTTAATCGTACTCTGGCAACTTTAC |
| Alfalfa medicago | TACCGGGTATATAAGCAGTGATTTCAAATCCAGAGGTTAAGCGTACTCTGGCAACTTTAC |
| NC_003119 | |
| | 29243 29184 |
| | Identity = 94%, gaps = 0/60 (0%) |
| | TACCAGGTATATAAGCAGTGATTTCAAATCCCGAGGTTAATCGTACTCTGGCAACTTTAC |
| Tobacco | TACCGGGTATATAAGCAGTGATTTCAAATCCAGAGGTTAATCGTACTCTGGCAACTTTAC |
| NC_001879 | |
| | 100762 100821 |
| | Identity = 96%, gaps = 0/60 (0%) |
| | TACCAGGTATATAAGCAGTGATTTCAAATCCCGAGGTTAATCGTACTCTGGCAACTTTAC |
| Rice NC_001320 | TACCAGGTATATAAGCAGTGATTTCAAATCCAGAGGTTAATCGTACTCTGGCAACTTTAC |
| | 89180 89239 |
| | Identity = 98%, gaps = 0/60 (0%) |
| | TACCAGGTATATAAGCAGTGATTTCAAATCCCGAGGTTAATCGTACTCTGGCAACTTTAC |
| Spinach | TACCAGGTATATAAGCAGTGATTTCAAATCCAGAGGTTAATCGTACTCTGGCAACTTTAC |
| NC_002202 | |
| | 88937 88996 |
| | Identity = 98%, gaps = 0/60 (0%) |
| | TACCAGGTATATAAGCAGTGATTTCAAATCCCGAGGTTAATCGTACTCTGGCAACTTTAC |
| Soft wheat | TACCAGGTATATAAGCAGTGATTTCAAATCCAGAGGTTAATCGTACTCTGGCAACTTTAC |
| (aestivum) | |
| NC_002762 | |
| | 88937 88996 |
| | Identity = 98%, gaps = 0/60 (0%) |
| | TACCAGGTATATAAGCAGTGATTTCAAATCCCGAGGTTAATCGTACTCTGGCAACTTTAC |
| Corn NC_001666 | TACCAGGTATATAAGCAGTGATTTCAAATCCAGAGGTTAATCGTACTCTGGCAACTTTAC |
| | 129729 129670 |
| | Identity = 98%, gaps = 0/60 (0%) |

Summarizing table for 8 Probes

| | rps12 | rpoA | clpP | psbF | atpB | ndhK | psaA | atpH |
|---|---|---|---|---|---|---|---|---|
| | gene | gene | gene | gene | gene | gene | gene | gene |
| | probe | probe | probe | probe | probe | probe | probe | probe |
| Tomato | 96 | 100 | 82 | 90 | 95 | 90 | 96 | 95 |
| Alfalfa | 94 | 93 | 81 | 91 | 96 | 87 | 98 | 93 |
| Tobacco | 96 | 100 | 89 | 90 | 95 | 91 | 96 | 96 |
| Rice | 98 | 83 | 80 | 88 | 95 | 91 | 96 | 90 |
| Spinach | 98 | 90 | 89 | 89 | 95 | 90 | 91 | 96 |
| Wheat | 98 | 83 | 81 | — | 96 | 91 | 96 | 91 |
| Corn | 98 | 85 | 80 | 87 | 93 | 90 | 96 | 93 |

For the 8 genes tested, the sequences of 60 nucleotides chosen from Arabidopsis thaliana are similar to those of the corresponding genes of 7 plants, with a degree of similarity of greater than 80%. This allows hybridization on an Arabidopsis plastid membrane with the RNA or cDNA of 7 other plants. Correction factors are possible.

Table of distance between the 1^{st} nucleotide of the probe and the initiating ATG of the chloroplastid gene of Arabidopsis thaliana.

| | |
|---|---|
| SEQ ID No. 1 | 146 |
| SEQ ID No. 2 | 61 |
| SEQ ID No. 3 | 173 |
| SEQ ID No. 4 | 418* |
| SEQ ID No. 5 | 26 |
| SEQ ID No. 6 | 135 |
| SEQ ID No. 7 | 32 |
| SEQ ID No. 8 | 24 |
| SEQ ID No. 9 | 112 |
| SEQ ID No. 10 | 1 |
| SEQ ID No. 11 | 151 |
| SEQ ID No. 12 | 4 |
| SEQ ID No. 13 | 34 |
| SEQ ID No. 14 | 54 |
| SEQ ID No. 15 | 20 |
| SEQ ID No. 16 | 197 |
| SEQ ID No. 17 | 217* |
| SEQ ID No. 18 | 22 |
| SEQ ID No. 19 | 37 |
| SEQ ID No. 20 | 65 |
| SEQ ID No. 21 | 40 |
| SEQ ID No. 22 | 125 |
| SEQ ID No. 23 | 36 |
| SEQ ID No. 24 | 1 |
| SEQ ID No. 25 | 40 |
| SEQ ID No. 26 | 95 |
| SEQ ID No. 27 | 1 |
| SEQ ID No. 28 | 1 254* |
| SEQ ID No. 29 | 147 |
| SEQ ID No. 30 | 190 |
| SEQ ID No. 31 | 11 |
| SEQ ID No. 32 | ? |
| SEQ ID No. 33 | 121 |
| SEQ ID No. 34 | 233* |
| SEQ ID No. 35 | 133 |
| SEQ ID No. 36 | 164 |
| SEQ ID No. 37 | 166 |
| SEQ ID No. 38 | 61 |
| SEQ ID No. 39 | 19 |
| SEQ ID No. 40 | 283* |
| SEQ ID No. 41 | 299* |
| SEQ ID No. 42 | ? |
| SEQ ID No. 43 | 47 |
| SEQ ID No. 44 | 101 |
| SEQ ID No. 45 | −1 |
| SEQ ID No. 46 | 12 |
| SEQ ID No. 47 | −1 |
| SEQ ID No. 48 | 45 |
| SEQ ID No. 49 | 20 |
| SEQ ID No. 50 | 0 |
| SEQ ID No. 51 | 75 |
| SEQ ID No. 52 | 18 |
| SEQ ID No. 53 | 11 |
| SEQ ID No. 54 | 311* |
| SEQ ID No. 55 | 50 |
| SEQ ID No. 56 | −1 |
| SEQ ID No. 57 | 0 |
| SEQ ID No. 58 | 16 |
| SEQ ID No. 59 | 185 |
| SEQ ID No. 60 | 0 |
| SEQ ID No. 61 | 24 |
| SEQ ID No. 62 | 151 |
| SEQ ID No. 63 | 125 |
| SEQ ID No. 64 | 188 |
| SEQ ID No. 65 | 4 |
| SEQ ID No. 66 | 89 |
| SEQ ID No. 67 | 3 |
| SEQ ID No. 68 | 120 |
| SEQ ID No. 69 | 0 |
| SEQ ID No. 70 | 155 |
| SEQ ID No. 71 | 9 |
| SEQ ID No. 72 | 5 |
| SEQ ID No. 73 | 48 |
| SEQ ID No. 74 | 38 |
| SEQ ID No. 75 | 185 |
| SEQ ID No. 76 | 41 |
| SEQ ID No. 77 | 116 |
| SEQ ID No. 78 | 62 |
| SEQ ID No. 79 | 1200* |
| SEQ ID No. 80 | 7 |

*distance between the 1^{st} nucleotide of the probe and the initiating ATG of the chloroplastid gene of Arabidopsis thaliana >200 nucleotides

72 probes out of the 80 exhibit a distance between the 1^{st} nucleotide of the probe and the initiating ATG of the corresponding chloroplastid gene of Arabidopsis thaliana of less than 200 nucleotides, i.e. 90% of the probes.

### 2. Probe Synthesis and Labeling

The probes are synthesized in the following manner: the reactions are carried out in a small column containing plastic or glass microbeads to which the first nucleotide in the 3′ position of the oligonucleotide to be synthesized is attached. The reactive functions of this nucleotide are blocked. A cycle of reactions will make it possible to add a further nucleotide. Each cycle is composed of the following steps: deblocking of the phosphorus in the 5′ position, activation, attachment of the next nucleotide in blocked form. One cycle has a duration of approximately 6 minutes, one nucleotide being incorporated in each cycle.

In practice, it is sufficient to load the reservoirs of the synthesis machine with the appropriate reagents, to type in the desired sequence on the keyboard and to recover the oligonucleotide synthesized.

The synthesized probes are, in the case in point, labeled after synthesis. The labeling is carried out on the 5′ end with the T4 polynucleotide kinase. The probe is incubated at 37° C. for 45 minutes in the presence of (γ³²P)ATP and the enzyme. The nucleotides which have not reacted are separated from the labeled probe.

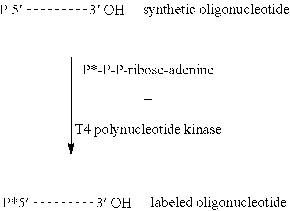

### 3. Probe Attachment

10 μmol of probe, corresponding to 190 ng, are deposited at each elemental site of the support, in the case in point a nitrocellulose membrane 12 cm×8 cm in size. The deposits are made in duplicate and placed 1 mm apart.

### B. Preparation of the Target

### 1-Preparation of RNAs

The RNAs isolated from Arabidopsis plantlets are prepared according to a standard method as indicated in Privat et al. (Plant Mol. Biol., 55, 385-399.) and are stored at −80° C. 2 μg of RNA are taken and treated twice with 2 u/μg of DNase I, at 37° C. for 30 min, the RNA being purified in a phenol/chloroform mixture (1:1, by volume). The following are added to the 2 μg of RNA: 1 μl of the mixture of 20-mer oligonucleotides (0.1 pmol/μl), synthesized according to the tables below (Tables 1 and 2), 1.5 μl of the nucleotides dA, dG, dT (10 mM), and 5 ml of α-[P32]-dCTP (10 μCi/μl, Amersham), the volume being made up to 18 μl with water. The RNAs are subsequently denatured for 5 min at 65° C. and are then kept in ice.

Example: primers-rps 12 gene

| | Position | Sequence |
|---|---|---|
| rps 12 | 1 | ATGCCAACCA TTAAACAACT TATTAGAAAT ACAAGACAGC CAATCCGAAA CGTCACGAAA |
| gene | 61 | TCCCCAGCGC TTCGGGGATG CCCTCAGCGA CGAGGAACAT GTACTCGGGT GTATACTATC |
| | 121 | ACCCCCAAAA AACCAAACTC TGCTTTACGT AAAGTTGCCA GAGTACGATT AACCTCGGGA |
| | 181 | TTTGAAATCA CTGCTTATAT ACCTGGTATT GGCCATAATT TACAAGAACA TTCTGTAGTC |
| | 241 | TTAGTAAGAG GGGGAAGGGT TAAGGATTTA CCCGGTGTGA GATATCACAT TGTTCGAGGA |
| | 301 | ACCCTAGATG CTGTCGGAGT AAAGGATCGT CAACAAGGGC GTTCTAGTGC GTTGTAGATT |
| | 361 | CTTATCCAAG ACTTGTATCA TTTGATGATG CCATGTGAAT CGCTAGAAAC ATGTGAAGTG |
| | 421 | TATGGCTAAC CCAATAACGA AAGTTTCGTA AGGGGACTGG AGCAGGCTAC CACGAGACAA |
| | 481 | AAGATCTTCT TTCAAAAGAG ATTCGATTCG GAACTCTTAT ATGTCCAAGG TTCAATATTG |
| | 541 | AAATAATTTC AGAGGTTTTC CCTGACTTTG TCCGTGTCAA CAAACAATTC GAAATGCCTC |
| | 601 | GACTTTTTTA GAACAGGTCC GGGTCAAATA GCAATGATTC GAAGCACTTA TTTTTACACT |
| | 661 | ATTTCGGAAA CCCAAGGACT CAATCGTATG GATATGTAAA ATACAGGATT TCCAATCCTA |
| | 721 | GCAGGAAAAG GAGGGAAACG GATACTCAAT TTAAAAGTGA GTAAACAGAA TTCCATACTC |
| | 781 | GATTTCAGAG ATACATATAT AATTCTGTGG AAAGCCGTAT TCGATGAAAG TCGTATGTAC |
| | 841 | GGTTTGGAGG GAGATCTTTC ATATCTTTCG AGATCCACCC TACAATATGG GGTCAAAAAG |
| | 901 | CCAAAATAA |
| Reverse | 111 | GCCCTTGTTGACGATCCTTTAC |
| primer | | |
| Forward | 48 | TCAGCGACGAGGAACATG |
| primer | | |

TABLE 1
Reverse RT primers

| | | | Position downstream |
|---|---|---|---|
| | | | with respect to the |
| Name | Sequence | Size | long oligo |
| accD_RTAS | CGGTGGAGTGACAGCTAG | 18 | 19 |
| atpA_RTAS | TTGACTGAACTTCCTTCTTGG | 21 | 72 |
| atpB_RTAS | TAGGAGATGTTGTGCGAGTATC | 22 | 127 |
| atpE_RTAS | CCGCCCATCAGAGCCATC | 18 | 116 |
| atpF_RTAS | CTTATCCGCTTCCGTTTCTAC | 21 | 160 |
| atpH_RTAS | TTAAACAAAAGGATTCGCAAAT | 22 | −21 |
| atpI_RTAS | CTGCGGAACCTAATAAGATAGC | 22 | 49 |
| ccsA(ycf5)_RTAS | GCTCTCCAGTCCCAGTGG | 18 | 4 |
| cemA_RTAS | TGGTGGAATACTAGACAATGC | 21 | 85 |
| clpP_RTAS | GCCATTCCAGATATTACCCATC | 22 | 143 |
| L2_RTAS | CGAGCACACGCAATGGAG | 18 | 86 |
| L23_RTAS | GAATCAGGATCAACTAGGACAG | 22 | 46 |
| matK_RTAS | TTACGAGCCAAAGTTTTAACAC | 22 | 109 |
| ndhA_RTAS | AATACTTGAGATGGCAATCC | 20 | 207 |
| ndhB_RTAS | ATGGCTATAACAGAGTTTCT | 20 | 41 |
| ndhC_RTAS | CTCATTGCCCACGGATACAG | 20 | 150 |
| ndhD_RTAS | AGAACTTCCTGCCGTGTAC | 19 | 181 |
| ndhE_RTAS | TGTTACGATAAATTGACGAGAC | 22 | 119 |
| ndhF_RTAS | CGAACACATTCCAACTAATTCC | 22 | 93 |
| ndhG_RTAS | ACCAACGAAGTAATCCCATTCC | 22 | 60 |
| ndhH_RTAS | CGAGCCATAACAGATGAGAAG | 21 | 41 |
| ndhI_RTAS | TCCAATTTCCAATCAACAACAG | 22 | 11 |
| ndhJ_RTAS | TCGTGGATGGCTATCATAAGTG | 22 | 174 |
| ndhK_RTAS | GCAATAACATACTTCGGTTCAG | 22 | 78 |
| orf77_RTAS | CGGTTGTTCGCTGTTCAAG | 19 | 12 |
| petA_RTAS | CTCGCTCCATATCTGTCTCAC | 21 | 133 |
| petB_RTAS | AGTAAAGTTTATGATTGGTTCG | 22 | −1 |
| petD_RTAS | AAAAAACCAGATTTGAATGATCC | 23 | −3 |
| petG_RTAS | AATCGTCTTAGGTCTAATTCC | 21 | 10 |
| petL_RTAS | ATGCCTACTATAACTAGTTATTTC | 24 | −11 |
| psaA_RTAS | ATGCCACTCAGCCAAAGAAAG | 21 | 93 |
| psaB_RTAS | CGAAGTCATGTGCGGTAGC | 19 | 12 |
| psaC_RTAS | TTGGACAGGCGGATTCAC | 18 | 81 |
| psaI_RTAS | GACAACTTTCAATAACTTACCC | 22 | 13 |
| psaJ_RTAS | CTAAAAACATATCTTTCCGTAG | 22 | 3 |
| psbA_RTAS | TGGAGGAGCAGCAATGAATG | 20 | 84 |
| psbB_RTAS | CTGCTCTAGTTGCTGGTTGG | 20 | 52 |
| psbC_RTAS | TTTAGCTTTAGCTGGTCGTG | 20 | 46 |
| psbD_RTAS | TGACTATAGCCCTTGGTAAATT | 22 | 13 |
| psbE_RTAS | AGGGCTCCCGAACACATC | 18 | 22 |
| psbF_RTAS | AACTGCATTGCTGATATTGACC | 22 | 26 |
| psbH_RTAS | CTGGTCCAAGAAGCACTACTG | 21 | 57 |
| psbI_RTAS | ATGCTTACTCTCAAACTTTT | 20 | 20 |
| psbJ_RTAS | ACCTAATCCTGAATATGAACCA | 22 | 13 |
| psbK_RTAS | AGTCGCCAAATTGCCAGAG | 19 | 11 |
| psbL_RTAS | AAACAGCAAGTACAAAAATGAG | 22 | 9 |
| psbM_RTAS | GGTTTTTACGTAAATTATAAGC | 22 | 5 |
| psbN_RTAS | CGAATGGATCTCTTAGTTGTTG | 22 | 15 |
| psbT_RTAS | ATGGAAGCATTGGTTTATAC | 20 | −19 |
| psbZ(ycf9)_RTAS | ATGACTATTGCTTTCCAATTG | 21 | 19 |
| rbcL_RTAS | CACCACAAACAGAGACTAAAGC | 22 | 39 |
| rp114_RTAS | GAGGAGTATTTGGTATTGCTTC | 22 | 73 |
| rp116_RTAS | TCCGCAGGTCTTACTGTAAC | 20 | 147 |
| rp120_RTAS | TCGTGTAAGCCGTGAATGAG | 20 | 18 |
| rp122_RTAS | CACAGTATTCCCTTGGTTCAC | 21 | 94 |
| rp132_RTAS | AAAACGTACTTCTATCTCG | 19 | 27 |
| rp133_RTAS | GGCCAAGGGTAAAGATGTTC | 20 | −18 |
| rp136_RTAS | TTGTTTATGCCTCGGGTTGG | 20 | 2 |
| rpoA_RTAS | ATGTTCCTTCTATTTCGCCAAG | 22 | 24 |
| rpoB_RTAS | TGTTCTTGCATATTCCTACTGG | 22 | 53 |
| rpoCl_RTAS | TTGTCACCTCTCCAACTATCTC | 22 | 24 |
| rpoC2_RTAS | TTGTTGTTCAGCATCTTGGAC | 21 | 148 |
| rps11_RTAS | GCGGAGGACCAAGAAATCAC | 20 | 87 |
| rps12_RTAS | GCCCTTGTTGACGATCCTTTAC | 22 | 111 |
| rps14_RTAS | ACAAACATGCCTGAACCATTTC | 22 | 72 |
| rpsl5_RTAS | AAGCCAGCAGTCGTTGACG | 19 | 15 |
| rps16_RTAS | TCCCAGCCTTCTTTGAAATATC | 22 | 82 |
| rps18_RTAS | ATGAATAAATCTAAGCGACTTT | 22 | −21 |
| rps19_RTAS | CCTTCCATTATGAATAGCGATC | 22 | 36 |
| rps2_RTAS | AACGAGCAGTTCTAGTCAG | 19 | 30 |
| rps3_RTAS | TACGTGCAATTCCCTCCATAC | 21 | 107 |
| rps4_RTAS | AGATGGTTTGGCAATTCCTCAG | 22 | 221 |
| rps7_RTAS | TGGCTTATCAAATTATCTATCG | 22 | 39 |
| rps8_RTAS | TTATTTCGTCTATGTCTTAGGG | 22 | 79 |
| ycfl_RTAS | GTTAATTGGTCACATTTTATTC | 22 | 0 |
| ycf2_RTAS | TCTTCCGATGTATCATTTCTGG | 22 | 102 |
| ycf3_RTAS | CCTGTTCTCCACGGTAATGAC | 21 | 156 |
| ycf4_RTAS | ATGAGTTGGCGATCAGAATC | 20 | 2 |
| ycf6(petN)_RTAS | ATGGATATAGTAAGTCTCGC | 20 | −19 |

TABLE 2
Forward RT primers

| | | | Position downstream |
|---|---|---|---|
| | | | with respect to the |
| Name | Sequence | Size | long oligo |
| accD_RTS | CAGCCGCTTGTGAACCTTC | 19 | 23 |
| atpA_RTS | CCATTAGAGCCGACGAAATTAG | 22 | 89 |
| atpB_RTS | ACAATGCTCTGGTGGTTAAG | 20 | 37 |
| atpE_RTS | ATGACCTTAAATCTTTGTGTAC | 22 | −20 |
| atpF_RTS | TCGTTTACTTGGGTCACTG | 19 | 2 |
| atpH_RTS | TGTTGGGCTTGCTTCTATTGG | 21 | 119 |
| atpI_RTS | TCCATCAACACACTAATAAAAG | 22 | 0 |
| ccsA(ycf5)_RTS | CCGACTTTGCGAAATGTAATC | 21 | 18 |
| cemA_RTS | GGAATAACCACTTAGAATAACG | 22 | 75 |
| clpP_RTS | GCCTATTGGCGTTCCAAAAG | 20 | −9 |
| L2_RTS | TCTCTTCTCACCATCCCCATAG | 22 | 85 |
| L23_RTS | GAATAACCCGGTTGAAGCG | 19 | 28 |
| matK_RTS | TGGGTTATCTGTCAAGTTTGC | 21 | 127 |
| ndhA_RTS | TGGGAATCATAACAGGTGTAC | 21 | 2 |
| ndhB_RTS | TCATAGTAGCCTCATTAGATCG | 22 | 34 |
| ndhC_RTS | ATGTTTCTGCTTTACGAATATG | 22 | 4 |
| ndhD_RTS | ACTGGAGAATGGGAATAGATGG | 22 | 16 |
| ndhE_RTS | ATGATACTCGAACATGTACTTG | 22 | 41 |
| ndhF_RTS | TTTGAGTTCGGTTACTTTATCG | 22 | 33 |
| ndhG_RTS | GGGTCTGGGAGTGGTATTAC | 20 | 83 |
| ndhH_RTS | TTGACTGTGAACCCATATTAGG | 22 | 101 |
| ndhI_RTS | TTATGGTCAACAAACCCTACG | 21 | 116 |
| ndhJ_RTS | GCTGGTTCATAGATCGTTGG | 20 | 69 |
| ndhK_RTS | GTCAAGACTTTCCAGCCTATG | 21 | 49 |
| orf77_RTS | TGCTACTACTGAAACATGGAAG | 22 | −10 |
| petA_RTS | GAACAGCTCCCACATTCAAAG | 21 | 52 |
| petB_RTS | GACAATAAAATATGTTGACATGC | 23 | 1 |
| petD_RTS | TCCGCAGGTTCACCAATC | 18- | 92 |
| petG_RTS | TAAAAGTCCAACTGATCACCAC | 22 | −21 |
| petL_RTS | AAGTCGTATTTTGCTTAGACC | 21 | −3 |
| psaA_RTS | CTTTCGAGGAATGGGCTAAAC | 21 | 6 |
| psaB_RTS | ATGGCATTAAGATTTCCAAGG | 21 | −16 |
| psaC_RTS | ATTCAGTAAAAATTTATGATAC | 22 | −8 |
| psaI_RTS | GAATAACTAGAACGCTCATCC | 21 | 181 |
| psaJ_RTS | TAATGCATCTGGAAATAAACG | 21 | −2 |
| psbA_RTS | ATGACTGCAATTTTAGAGAGAC | 22 | −13 |
| psbB_RTS | GCCAAATAGCTGCCAAGAAG | 20 | 111 |
| psbC_RTS | ACGGAAAGGTGTCTATAACTTC | 22 | 126 |
| psbD_RTS | AGCGAAATAGGCACAAGGAAAG | 22 | 19 |
| psbE_RTS | GGAGAACGTTCTTTTGCTG | 19 | 18 |
| psbF_RTS | TGACTATAGATAGGACCTATCC | 22 | −22 |
| psbH_RTS | CTAATTCACTGAAATTCCATCC | 22 | 30 |
| psbI_RTS | CTTCACGTCCCGGATTAC | 18 | −10 |
| psbJ_RTS | TGGCTGATACTACTGGAAGGAT | 22 | −5 |
| psbK_RTS | AAACTTACAGCGGCTTGC | 18 | 8 |
| psbL_RTS | TGACACAATCAAATCCGAAC | 20 | −19 |
| psbM_RTS | TGGAAGTAAATATTCTTGCATT | 22 | −21 |
| psbN_RTS | TGGAAACAGCAACCCTAGTC | 20 | −1 |
| psbT_RTS | AGTTGAAATTTTAGGTGGTTCC | 22 | 12 |
| psbZ(ycf9)_RTS | ACCAAGAAGACTAATCCAATCC | 22 | 41 |
| rbcL_RTS | TGGTAGCATCGTCCTTTGTAAC | 22 | 112 |
| rp114_RTS | ATGATTCAACCACAAACCT | 19 | 19 |
| rp116_RTS | ATGCTTAGTCCAAAAAGAACC | 21 | −7 |
| rp120_RTS | ATGACTAGAATTAAACGCGGA | 21 | −18 |
| rp122_RTS | AAGCACGGAGAGTAATTGATC | 21 | 6 |
| rp132_RTS | CCTGTAGAAAGTGATTTCCCTA | 22 | −18 |
| rp133_RTS | TGATTTCCCCGTGAATTGTATG | 22 | 109 |
| rp136_RTS | AAAATAAGGGCTTCCGTTCG | 20 | −1 |
| rpoA_RTS | AGTATCTACTCGGACACTACAG | 22 | 35 |
| rpoB_RTS | GAGGGAACATCTGCAATACC | 20 | 119 |
| rpoCl_RTS | GATCGATCGGTATAAACATC | 20 | −11 |
| rpoC2_RTS | TGGCGGAACGGGCCAATC | 18 | −12 |
| rps11_RTS | ATGGCAAAACCTATATTAAGA | 21 | −20 |
| rps12_RTS | TCAGCGACGAGGAACATG | 18 | 48 |
| rps14_RTS | ATCATTTGATTCGTCGATCCTC | 22 | 42 |
| rps15_RTS | TCACTAATAAGATACGAAGAC | 21 | −2 |
| rps16_RTS | CGATGTGGTAGAAAGCAACGA | 21 | 22 |
| rps18_RTS | GTCACTCTATTCACCCGTCTAG | 22 | 83 |
| rps19_RTS | TTGTAGCAAAGCATTTATTAAG | 22 | −1 |
| rps2_RTS | TTTGGAAGAGATGATGAGAG | 20 | 4 |
| rps3_RTS | TGGGACAAAAAATAAATCCAC | 21 | −21 |
| rps4_RTS | AGGCAGGAAGCGATCTTAG | 19 | 92 |
| rps7_RTS | AATAACCAACGAATGGCAAGTG | 22 | 61 |
| rps8_RTS | GCTGATATAATAACCTCTATAC | 22 | 7 |
| ycfl_RTS | TCTCAATTCTGACACAAGGAAC | 22 | 28 |
| ycf2_RTS | TGGACCCAATTCAATTCAGTG | 21 | 84 |
| ycf3_RTS | GTCGGCTCAATCTGAAGGAA | 20 | −16 |
| ycf4_RTS | TAATAAAGAGACCTGCGATCC | 21 | 128 |
| ycf6(petN)_RTS | ACTTCTTCCCCACACTACG | 19 | 3 |

### 2-Preparation of Single-Stranded DNAs by Reverse Transcription (RT).

The reaction medium contains 6 μl of 5× buffer supplied with the Superscript All (SSII) reverse transcriptase from Invitrogen, 3 μl of dithiothreitol (DTT), 0.1 M and 1 μl of RNAse inhibitor (RNA guard, Amersham). The mixture is added to the solution containing the RNA and is then placed at 42° C. for 3 min. 1.5 μl of SSII are subsequently added. The RT reaction lasts for 50 min at 42° C. and is stopped by heating at 70° C. for 15 min. The cDNA obtained are treated by adding 1 μl of RNase H for 20 min at 37° C.

3-cDNA Purification

The unincorporated nucleotides are removed by passing the cDNAs through a Sephadex G50 bead microcolumn as follows: 170 μl of Tris-EDTA (TE) buffer at pH 8 are added to the 30 μl of cDNA, followed by 200 ml of the same TE buffer. The whole is loaded onto the microcolumn and the volume having passed through is stored in an Eppendorf tube. After having loaded a further 300 μl of TE buffer, pH 8, onto the column, the radioactive eluate is recovered in another Eppendorf tube.

### 4. Verification of the Efficiency of the RT Reaction

For the purposes of verification and in order to compare the efficiency of the RT between the various samples, 1 μl of the labeled cDNA is analyzed by 6% acrylamide gel electrophoresis. The amounts used for the hybridizations are adjusted so as to have substantially equal ³²P incorporations.

### C. Hybridization of the Labeled cDNAs on the Microarrays

The hybridization buffer contains 100 ml of phosphate buffer (1 M NaHPO₄, pH 5.2), 0.4 ml of Na₂ EDTA at 0.5 mM, 70 ml of 20% SDS, 2 g of BSA, and the rest made up with H₂O for a final volume of 200 ml. The washing buffer (500 ml) contains 40 mM of NaHPO₄, pH 7.2, 1 mM of Na₂ EDTA and 7% SDS. The dehybridization buffer (500 ml) contains 0.5% of SDS and 0.01% of SSC. After prehybridization for 1 h at 65° C., the hybridization is carried out for 72 h at 65° C. and is followed by washing for 10 min at ambient temperature and for min at 65° C.

### D. Detection: Measurement of the Radioactivity Hybridized

After exposure of the microarrays for 15 days, the radioactivity is revealed with a phosphor imager and the relative amounts are measured using appropriate software.

### E. Analysis

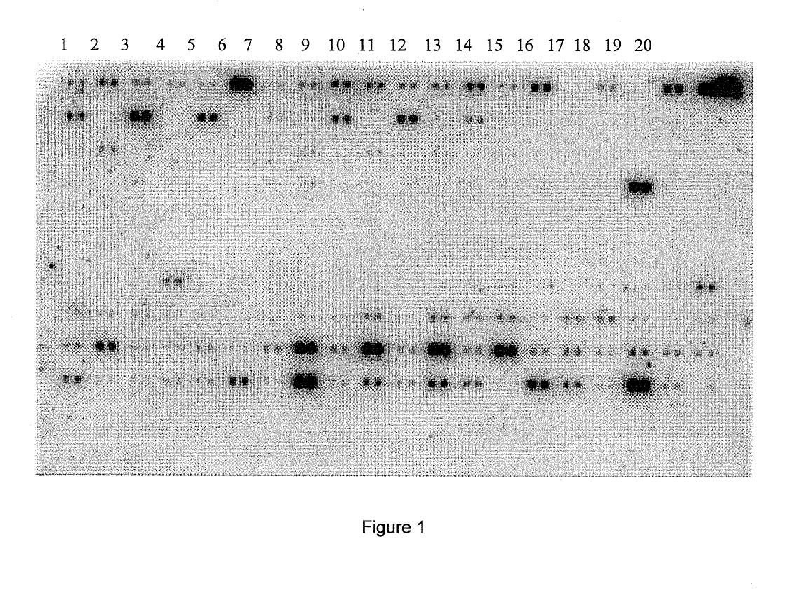

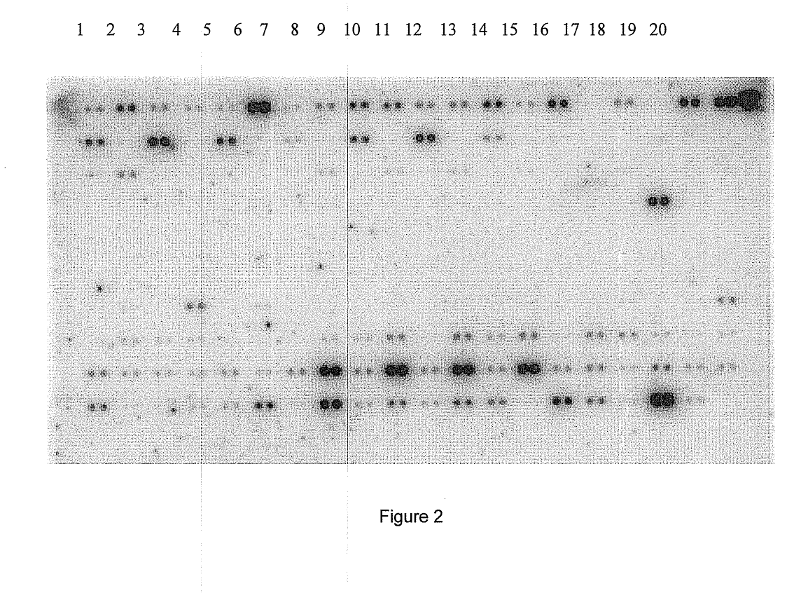

The analysis is carried out using an R software or any other suitable software. See FIGS. 1 and 2.

FIG. 1 represents a microarray after hybridization of the target nucleic sample isolated from wild-type Arabidopsis thaliana plantlets.

FIG. 2 represents a microarray after hybridization of the target nucleic sample isolated from mutant Arabidopsis thaliana plantlets.

Variations in expression are distinguished on two pairs of elemental sites by comparison between the microarrays.

The table below shows a comparison of the tomato plastid gene expression with a chip constructed according to the Arabidopsis sequences (probes and primers).

| | Probe(P) | Primer(p) | | | | |
|---|---|---|---|---|---|---|
| | Number of | Number of | Tomato | Arabidopsis | | At |
| Gene | identities* | identities** | signals | signals | Classes | Primer |
| orf77 | 59 | 17 | −/+ | ++ | S | 22 |
| rpl33 | 53 | 18 | −/+ | ++ | S | 22 |
| psaJ | 51 | 16 | −/+ | ++++++ | S | 21 |
| rpoC1 | 53 | 17 | + | ++ | S | 20 |
| psbB | 58 | 15 | + | +++ | S? | 20 |
| psaA | 58 | 16 | + | + | S | 21 |
| psbZ | 50 | 20 | + | +++ | S | 22 |
| atpH | 57 | 17 | + | ++++ | S | 22 |
| accD | 57 | 18 | + | ++ | S | 19 |
| L23 | 54 | 19 | + | +++ | S | 19 |
| rpl36 | 56 | 19 | + | + | S | 20 |
| rps14 | 51 | 21 | + | + | S | 22 |
| psbC | 53 | 19 | ++ | ++++ | S | 22 |
| ndhB | 56 | 19 | ++ | ++ | S | 22 |
| psaB | 59 | 20 | ++ | ++ | S | 21 |
| atpE | 52 | 21 | ++ | ++ | S | |
| rpoA | 58 | 22 | ++ | ++ | S | 22 |
| atpF | 58 | 17 | ++ | +++ | S | 19 |
| petL | 54 | 19 | ++ | +++ | S | 21 |
| rbcL | 58 | 22 | ++ | +++ | S | 22 |
| rps7 | 52 | 17 | +++ | +++ | S | 22 |
| petG | 55 | 20 | +++ | ++ | S | 21 |
| ndhI | 55 | 20 | +++ | +++ | S | 22 |
| psbH | 55 | 22 | +++ | +++ | S | 22 |
| psbD | 51 | 20 | ++++ | +++ | S | 20 |
| psbN | 55 | 21 | ++++ | +++ | S | 22 |
| psaC | 58 | 21 | ++++ | +++ | S | 22 |
| psbJ | 60 | 22 | ++++ | ++ | S | 22 |
| psbA | 51 | 17 | +++++ | ++++ | S | 18 |
| psbI | 49 | 20 | +++++ | ++ | S | 22 |
| psbF | 55 | 22 | +++++ | +++ | S | 22 |
| L2 | 58 | 18 | ++++++ | +++ | S | 19 |
| psbE | 55 | 18 | ++++++++ | +++ | S | 20 |
| ndhF | 50 | 22 | nd | ++ | S | |
| ndhD | 57 | 22 | nd | ++ | S | |
| rps3 | 56 | 22 | nd | ++++ | S | 22 |
| psbM | 56 | 22 | nd | ++++ | S | 22 |
| atpA | 56 | 21 | nd | ++ | S | 22 |
| ndhE | 57 | 21 | nd | + | S | 21 |
| ycf2 | 58 | 21 | nd | ++ | S | 21 |
| ycf3 | 50 | 20 | nd | ++ | S | 21 |
| rpl22 | 53 | 20 | nd | nd | S | 21 |
| rps16 | 55 | 20 | nd | ++ | S | 22 |
| rps15 | 44 | 20 | nd | ++ | ? | |
| rpoB | 50 | 19 | nd | ++ | S | 20 |
| ndhG | 51 | 19 | nd | + | S | 22 |
| rps19 | 56 | 19 | nd | +/− | S | 20 |
| rpoC2 | 51 | 18 | nd | +++ | S | 22 |
| rps18 | 54 | 18 | nd | ++ | S | 20 |
| clpP | 44 | 18 | nd | ++ | ? | 20 |
| petA | 54 | 18 | nd | +++ | ? | |
| rps2 | 50 | 17 | nd | +++ | S | 22 |
| ycfl | 55 | 17 | nd | +++ | S | 23 |
| petB | 55 | 17 | nd | ++++ | S | 18 |
| psbK | 55 | 17 | nd | nd | S | 18 |
| rps12 | 58 | 17 | nd | nd | S | |
| ycf6 | 53 | 16 | nd | + | S? | 21 |
| rpl20 | 55 | 16 | nd | + | S? | 20 |
| ccsA | 50 | 15 | nd | + | S? | 21 |
| rps4 | 56 | 15 | nd | +++ | S? | |
| psbL | 52 | 15 | nd | ++ | S? | 19 |

S = significant; S? uncertain result
*P: number of identities in tomato relative to the Arabidopsis 60-mer
**p: number of identities in tomato relative to the Arabidopsis 20-22 mer
+, the number of + indicates the size of the hybridization signal

The total RNA was isolated from Arabidopsis thaliana or from tomato (Solanum lycopersicum, var. Ailsa Craig) cultivated for 7 days at ambient temperature and was treated twice with DNase I (2 units/μg RNA) in order to remove the traces of DNA; 6 μg (Arabidopsis thaliana) or 8 μg (tomato) of RNA were considered as microarray hybridization.

The RNA was subject to a reverse transcriptase using specific primers corresponding to the 79 coded protein genes that it is desired to analyze with the microarray. The primers are located as close as possible to the 3^{rd} end of 60-mers which were pinpointed on the filters.

The reaction was carried out as described previously (Favory of al. 2005, Nucl. Acids Res. 33, 5991-5999) in the presence of 100 μCi of α³²P-ATP (Amersham Bioscience) using the Superscript II reverse transcriptase (Invitrogen). Samples were treated with RNase H at 37° C. for 15 minutes and deoxyribonucleotides were removed by passing through Sephadex G50. A sample of each of the cDNAs synthesized was analyzed on a 6% polyacrylamide gel in order to verify the quality of cDNA synthesized.

The hybridization was carried out for 3 days at 65° C. in a phosphate buffer (0.5 M NaHPO₄, pH 7.2), containing 1 mM EDTA, 20% SDS and 1% BSA.

After hybridization, the filters were washed in a washing buffer containing 40 mM of NaHPO₄, pH 7.2, 1 mM EDTA and 7% SDS at ambient temperature for 10 minutes, followed by washing for 5 minutes at 65° C.

After exposure for 3 weeks on Fujifilm lmagin Plates, the plates were analyzed using a phosphor imager (Fujifilm FLA 8000) and suitable software.

The aim of the tests described above was to validate the “universal” nature of the microarray constructed on the basis of the sequences of the plastid genome of Arabidopsis thaliana, by analyzing the plastid mRNAs of a particular plant, in this case tomato.

Firstly, it should be noted that two elements are to be taken into account in the tests concerning the “Arabidopsis” microarray: on the one hand, the probes (60-mer) and on the other hand, the primers (20-22 mer), used for the labeling of the mRNAs. The question posed is whether the “Arabidopsis” system is applicable to tomato (this is the Solanum lycopersicum plant, formerly Lycopersicum esculentum, and not simply the fruit).

(1) As regards the probes, the bioinformatic analysis shows that, for a threshold of 49 identities out of 60, 87% of the tomato plastid mRNAs can hybridize. These conclusions are drawn from data partially reported in the table. Thus, the mRNA of the psbl gene of tomato gives a strong hybridization signal with the Arabidopsis probe carried by the membrane which has only 49 identities with the corresponding part of the mRNA. Thus, it may be concluded that an identity of 49/60 is largely sufficient. With a threshold of 44/60, 93% of the probes should be able to hybridize with the tomato mRNAs.

(2) The second element involved in the hybridization is the degree of identity between the sequences of the Arabidopsis primers (used for labeling the cDNAs, by inverse transcription) and the corresponding sequences of the tomato mRNAs. The short Arabidopsis oligos (from 20 to 22 bases) should be able to hybridize with the tomato mRNAs, so as to produce cDNAs. The psbA gene (table) gives a strong signal showing that the 17 identities with the Arabidopsis primer are largely sufficient. It should be noted that a signal is also obtained for the psbB gene of which the 20 nucleotides of the Arabidopsis primer recognize only 15 identities of the corresponding tomato mRNA. Thus, for a threshold of 15 identities in the primers (tomato/Arabidopsis), 61/77 of the Arabidopsis primers, i.e. 80%, can be used for analyzing the plastid expression of tomato. The consequence of these observations is that, in order to study tomato plastid gene expression, it would be necessary to synthesize about twenty tomato-specific primers.

In conclusion, using the thresholds of 44 and 15 identities for the probes and the primers, respectively, it is possible reasonably to validate the results of the hybridizations of tomato cDNAs with the “Arabidopsis” microarray (constructed on the basis of the Arabidopsis sequences).

In summary, it may be concluded that:

The “Arabidopsis” microarray is applicable to the evaluation of tomato plastid gene expression, directly, i.e., with the Arabidopsis primers, for 93% of the genes, and, with the addition of the appropriate primers, for virtually all the genes.

1. A plastidial microarray comprising a solid support which comprises a multiplicity of elemental sites, each elemental site comprising several copies of the same nucleic acid probe, said probe being single-stranded, comprising between 50 and 70 nucleotides and corresponding to a sense oligonucleotide in a chloroplastid gene of Arabidopsis thaliana or to an antisense oligonucleotide in a chloroplastid gene of Arabidopsis thaliana, the entire chloroplastid coding genome of Arabidopsis thaliana being represented on the microarray.

2. The microarray as claimed in claim 1, in which the sequence corresponding to a sense oligonucleotide in a chloroplastid gene of Arabidopsis thaliana is chosen so as to be more than 50% identical with a nucleic sequence of at least one plant chosen from tomato, alfalfa, tobacco, rice, spinach, wheat and corn.

3. The microarray as claimed in claim 1 or 2, in which at least half the sequences corresponding to a sense oligonucleotide in a chloroplastid gene of Arabidopsis thaliana are chosen so as to be located less than 200 nucleotides from the initiating codon.

4. The microarray as claimed in any one of the preceding claims, in which the nucleic acid probes are labeled, so as to allow detection of the hybridization.

5. The microarray as claimed in claim 4, in which each elemental site of the support comprises several copies of a first nucleic acid probe and several copies of a second nucleic acid probe, which is an antisense of the first probe, the two probes being labeled differently.

6. The microarray as claimed in any one of the preceding claims, in which each elemental site comprises several copies of the same probe chosen from the following sequences:
(a) an oligonucleotide according to any one of the sequences SEQ ID Nos:1 to 80,
(b) an antisense oligonucleotide of any one of the sequences SEQ ID Nos:1 to 80,
(c) an oligonucleotide having at least 70% identity with the oligonucleotide according to (a) or (b).

7. A method for preparing the microarray as claimed in any one of claims 1 to 6, according to which:
a) a solid support is provided, and
b) the probes are attached to the surface of the support.

8. A detection method for the microarray as claimed in any one of claims 1 to 6, comprising:
a) bringing the target nucleic sample into contact with the microarray, so as to allow hybridization, and
b) detecting the hybridization.

9. The use of the microarray as claimed in claims 1 to 6, for establishing a plast gene expression profile in plants.

10. A set of probes for measuring plant plast gene expression, comprising at least two probes chosen from:
(a) an oligonucleotide according to any one of the sequences SEQ ID Nos:1 to 80,
(b) an antisense oligonucleotide of any one of the sequences SEQ ID Nos:1 to 80,
(c) an oligonucleotide having at least 70% identity with the oligonucleotide according to (a) or (b).

11. A kit comprising a microarray as claimed in any one of claims 1 to 6.

12. The kit as claimed in claim 11, also comprising the support, the solutions for the hybridization and the labeling and/or the protocols for isolating the RNAs suitable for the various plants.


SEQUENCE LISTING (81 sequences)

SEQ ID NO: 1 - DNA, 60 bp, Arabidopsis thaliana
ctatgaatagtcatcgactccccggaaaggttaaaagaatgggacctattctgggacata

SEQ ID NO: 2 - DNA, 60 bp, Arabidopsis thaliana
tgtggtgctaacgatttaataactatctttgtagctccagaatgtttcagtttatgctcc

SEQ ID NO: 3 - DNA, 60 bp, Arabidopsis thaliana
cactatctgttttacgtcaagcaatacgtggagtaactcccgatatagcagtaaaagcaa

SEQ ID NO: 4 - DNA, 60 bp, Arabidopsis thaliana
atgatgcacgtaagtatgatgatattaggctatggcgctctgttatgcggatcattatta

SEQ ID NO: 5 - DNA, 60 bp, Arabidopsis thaliana
ctatctcgaaaaagcgtattcgtaaaaaaatttggaaaaggaagggatattggacatcgt

SEQ ID NO: 6 - DNA, 60 bp, Arabidopsis thaliana
aataattaccgcaaggcatagagggggaggtcataagcgtctataccgtaaaatagattt

SEQ ID NO: 7 - DNA, 60 bp, Arabidopsis thaliana
atcctgtattacgagctaaattagctaaaggtatgggtcacaattattacggggaacccg

SEQ ID NO: 8 - DNA, 60 bp, Arabidopsis thaliana
cgaagaacgtcttgagattcaggcgattgcagatgatataactagtaaatatgttcctcc

SEQ ID NO: 9 - DNA, 60 bp, Arabidopsis thaliana
ggaacgacccctttgatgggtgttgcaatggctctatttgcggtattcctatctattatt

SEQ ID NO: 10 - DNA, 60 bp, Arabidopsis thaliana
atggaagcattggtttatacatttctcttagtatccactttagggataatttttttcgct

SEQ ID NO: 11 - DNA, 60 bp, Arabidopsis thaliana
gttcttgatccaatgtggagacaaggtatgttcgttatacctttcatgactcgtttagga

SEQ ID NO: 12 - DNA, 60 bp, Arabidopsis thaliana
gccaagggtaaagatgttcgagtaacaattattttggaatgtaccagttgtgttcgaaat

SEQ ID NO: 13 - DNA, 60 bp, Arabidopsis thaliana
ccggtactaagtactctatggttcggttcgttagcaggtttattaatagagattaatcgt

SEQ ID NO: 14 - DNA, 60 bp, Arabidopsis thaliana
ggctggattattcgtaactgcttatttacaatacagacgtggtgatcagttggactttta

SEQ ID NO: 15 - DNA, 60 bp, Arabidopsis thaliana
atttcggttttctactagcagctttaactataacctcagttctgtttattggtctaagca

SEQ ID NO: 16 - DNA, 60 bp, Arabidopsis thaliana
tggatattgaggttccacaaacggtacttcctgatactgtatttgaagcagttgttaaaa

SEQ ID NO: 17 - DNA, 60 bp, Arabidopsis thaliana
ataaaggaatacccagaaaccaatttacaacaatttcgtctaggaatccacaaagaaacg

SEQ ID NO: 18 - DNA, 60 bp, Arabidopsis thaliana
atatggatagaatttataacggggtctcgaaaaacaagtaatttctgctgggcctttatc

SEQ ID NO: 19 - DNA, 60 bp, Arabidopsis thaliana
cctttagtaggcctagtctttccggcaattgcaatggcttctttatttcttcatattcaa

SEQ ID NO: 20 - DNA, 60 bp, Arabidopsis thaliana
tgacttactatactcctgaatatgaaaccaaggatactgatatcttggcagcattccgag

SEQ ID NO: 21 - DNA, 60 bp, Arabidopsis thaliana
attacttcatcaatcttactgattagtgtacccgttgtatttgcgtctcctgatggttgg

SEQ ID NO: 22 - DNA, 60 bp, Arabidopsis thaliana
ttatcaatttatctggtaaacttttgggagctcatgtagcccatgccggattaatcgtat

SEQ ID NO: 23 - DNA, 60 bp, Arabidopsis thaliana
aaaagatttatttgatattatggatgactggttacggagggaccgcttcgtttttgtagg

SEQ ID NO: 24 - DNA, 60 bp, Arabidopsis thaliana
atggatatagtaagtctcgcatgggctgctttaatggtagtttttacattttccctctct

SEQ ID NO: 25 - DNA, 60 bp, Arabidopsis thaliana
ttctttgtttctctcttcatatttggattcctatctaatgatccaggacgtaatccggga

SEQ ID NO: 26 - DNA, 60 bp, Arabidopsis thaliana
ttttgaatccaatcgtagatgttatgcccgtaatacctcttttctttcttctcttagcct

SEQ ID NO: 27 - DNA, 60 bp, Arabidopsis thaliana; identical to SEQ ID NO: 22

SEQ ID NO: 28 - DNA, 60 bp, Arabidopsis thaliana
tatcattattgccgaaccctatgcctatattgcatttgcgggtaaaagagtaattgaaca

SEQ ID NO: 29 - DNA, 60 bp, Arabidopsis thaliana
taccaggtatataagcagtgatttcaaatcccgaggttaatcgtactctggcaactttac

SEQ ID NO: 30 - DNA, 60 bp, Arabidopsis thaliana
acaaatagtactacacccttgatcgtgaaatatcgattgcttgttgaaccctgtgaattg

SEQ ID NO: 31 - DNA, 60 bp, Arabidopsis thaliana
aggcagttcataccatccatacatagtgttttgatctaagatttcaattcttccatgttt

SEQ ID NO: 32 - DNA, 60 bp, Arabidopsis thaliana
tttagatttatgccaaggtttaagataaaaaggaaataggatttttatctgaataccatc

SEQ ID NO: 33 - DNA, 60 bp, Arabidopsis thaliana
ttcgtagaccccgctgagataaataatcttttctgtgcaattccaaatgtgaagtaagtc

SEQ ID NO: 34 - DNA, 60 bp, Arabidopsis thaliana
ggcccttttaggaacttgaatatttcccaattgttctggtccatttactgttattgcttc

SEQ ID NO: 35 - DNA, 60 bp, Arabidopsis thaliana
tcaggtccaatacgttgttgtatccctgcagatatttctctttctaaccacacaattact

SEQ ID NO: 36 - DNA, 60 bp, Arabidopsis thaliana
aggacatactcgaacacatacttcacaagcaatgcatttatcaaattcaaaatggattcg

SEQ ID NO: 37 - DNA, 60 bp, Arabidopsis thaliana
aatatgattaaaacatttatggcccccacataaataaggagttgtgcagcagctacaaaa

SEQ ID NO: 38 - DNA, 60 bp, Arabidopsis thaliana
actgcattgagtataagttcaagacacataagagccctaaccatatttcgacttgtgatc

SEQ ID NO: 39 - DNA, 60 bp, Arabidopsis thaliana
tctaatacgtctgtagggcatgctcggacacattgagtacatcctatacaagtatcataa

SEQ ID NO: 40 - DNA, 60 bp, Arabidopsis thaliana
cgagtaactggaaaagccgctaaagtggctaaagtagtaataaatcccgtcagtaaaata

SEQ ID NO: 41 - DNA, 60 bp, Arabidopsis thaliana
tccttgatcatgcgacatataattgtcactataaatcagaaccaaaatcccaacagttgt

SEQ ID NO: 42 - DNA, 60 bp, Arabidopsis thaliana
catgaaatgggttggattggtattagtctggatacagcaaaataattctattaggtctaa

SEQ ID NO: 43 - DNA, 60 bp, Arabidopsis thaliana
ccgggaccaagttattatgatttctttttccgcctttgtattaagcttctctatttttct

SEQ ID NO: 44 - DNA, 60 bp, Arabidopsis thaliana
acatcctcgataaggcataagttctaatatcataagtgcttcttcataggaacgtccacg

SEQ ID NO: 45 - DNA, 60 bp, Arabidopsis thaliana
agaatgatgactttgggttgtaccaagtctgaaaccaagtggatttattttttgtcccat

SEQ ID NO: 46 - DNA, 60 bp, Arabidopsis thaliana
tcccacgagaagatattccttttagtcttcctcgatgttgtttacgaaatctggttcttt

SEQ ID NO: 47 - DNA, 60 bp, Arabidopsis thaliana
catcaattctctagccccgctgttgtctgctacattcaaataggtttgtggttgaatcat

SEQ ID NO: 48 - DNA, 60 bp, Arabidopsis thaliana
caatactttccgtgatgttagtcgatcctatccgaaccgttccttttctattcatgtcag

SEQ ID NO: 49 - DNA, 60 bp, Arabidopsis thaliana
acaaattactataattcgtcccctcctgcggattagtcgacacttttcacaaattttacg

SEQ ID NO: 50 - DNA, 60 bp, Arabidopsis thaliana
ttttacgtgaaccactacgtgtatttttacgcgaaccaattcttaatataggttttgcca

SEQ ID NO: 51 - DNA, 60 bp, Arabidopsis thaliana
ctattgtgtcggcttggcctttcataagtggagacagaataaagcgtccataataaagac

SEQ ID NO: 52 - DNA, 60 bp, Arabidopsis thaliana
aggcagtatatagagcatacccagtaaaacttacaagtaacccagatataaagatggcga

SEQ ID NO: 53 - DNA, 60 bp, Arabidopsis thaliana
gtatatgtcaacccaagatgtatctccttctccaggacttcgaaaaggtacttttggaac

SEQ ID NO: 54 - DNA, 60 bp, Arabidopsis thaliana
gcaaataaacgaagttttgttctacgcctccgagctatatatccgcgtttaattctagtc

SEQ ID NO: 55 - DNA, 60 bp, Arabidopsis thaliana
gaataaccagcccgcaatgaatagggaaggtatagtaatgctatgaatgacccagtatcg

SEQ ID NO: 56 - DNA, 60 bp, Arabidopsis thaliana
tagtccatgaacagccaaccagcgcactgtaaaaattggataggtcctatctatagtcat

SEQ ID NO: 57 - DNA, 60 bp, Arabidopsis thaliana
cccaatagagactggtacgatttaattcaacactttgttcgttcggatttgattgtgtca

SEQ ID NO: 58 - DNA, 60 bp, Arabidopsis thaliana
cctattaaaccgatcacaagaataccagctacagtacctattacccaaagaggaatcctt

SEQ ID NO: 59 - DNA, 60 bp, Arabidopsis thaliana
tgtcgcactcatagctacagctctaactcgattatttcctaataattgctgtacttcaca

SEQ ID NO: 60 - DNA, 60 bp, Arabidopsis thaliana
cttttacttctgaatcccaaacaattcgattcggagtcagtacacaaagatttaaggtca

SEQ ID NO: 61 - DNA, 60 bp, Arabidopsis thaliana
cggaaattagaaatgccaaaacaggaatagcacttgatattagtaaaaatgcccagaaaa

SEQ ID NO: 62 - DNA, 60 bp, Arabidopsis thaliana
tgtctaggactcgatcttggtactaacccataacgatcaaagtcaaatcgggagcctatt

SEQ ID NO: 63 - DNA, 60 bp, Arabidopsis thaliana
acctggtgccacatcataggcacattgcgaacgtaaataattgtaaccatatacatataa

SEQ ID NO: 64 - DNA, 60 bp, Arabidopsis thaliana
taaaacttgacctgttgaccccttggcttttccggctatacgcacatatttaagtaattg

SEQ ID NO: 65 - DNA, 60 bp, Arabidopsis thaliana
agtcgcatagcttcataataattctgtaatgcttccgcataatttccttcagattgagcc

SEQ ID NO: 66 - DNA, 60 bp, Arabidopsis thaliana
atgtaggttccagatccaagtggtagtatcaggtcccttagctattgttcttgagaaatg

SEQ ID NO: 67 - DNA, 60 bp, Arabidopsis thaliana
aaatacgacgagtagtggggtcctgagctaagccttggctaaaccttggaaatcttaatg

SEQ ID NO: 68 - DNA, 60 bp, Arabidopsis thaliana
gatgaagacgtgtaggtgcactattacgcggtggggattgtaattttccatgaattttcc

SEQ ID NO: 69 - DNA, 60 bp, Arabidopsis thaliana
aagcagtaggaacgagaatgaagagtgcagtagcaataaatgcaagaatatttacttcca

SEQ ID NO: 70 - DNA, 60 bp, Arabidopsis thaliana
ttcatagacagcatctcgttcttttatcagaggttctaccaattgatatgtttccacaaa

SEQ ID NO: 71 - DNA, 60 bp, Arabidopsis thaliana
cccaagcacttatttgctgaggagaaactaagccaattcggagttgttgatgtttatacc

SEQ ID NO: 72 - DNA, 60 bp, Arabidopsis thaliana
aagtcgtttaatagcagttccatctatcactttattgtgaaataccagattggcccgttc

SEQ ID NO: 73 - DNA, 60 bp, Arabidopsis thaliana
cagaaatataaggtgccattctaggattccatttcctcgtaccatgtccaaaatgaactc

SEQ ID NO: 74 - DNA, 60 bp, Arabidopsis thaliana
ccctatttgccaatagaaatgttggcctacttctacaccagatatctcatataacccttc

SEQ ID NO: 75 - DNA, 60 bp, Arabidopsis thaliana
ttaaacaaaaggattcgcaaataaaagcgctaatgctacaaccaggccataaattgttaa

SEQ ID NO: 76 - DNA, 60 bp, Arabidopsis thaliana
tagatttattggatttgttgctaaaatatcggtattaaatccgaaactcccggcggatgg

SEQ ID NO: 77 - DNA, 60 bp, Arabidopsis thaliana
accctcctcaaattctactaattcacctgccattacttcatcaagaccataaatacgagc

SEQ ID NO: 78 - DNA, 60 bp, Arabidopsis thaliana
gggatcataaaaacccaccttactaagatctcttccttctcttcggtatcgaacatcaat

SEQ ID NO: 79 - DNA, 60 bp, Arabidopsis thaliana
cagaatctgatgaatccgtccaggttgctttactaatgggatgccctaatacattacaaa

SEQ ID NO: 80 - DNA, 60 bp, Arabidopsis thaliana
ctagttatccagttacagaagcgaccccataggctttcgctttcgcgtctctctaaaatt

SEQ ID NO: 81 - DNA, 154478 bp, Arabidopsis thaliana
  gene (4)..(76): trnH - brin Crick
atgggcgaacgacgggaattgaacccgcgatggtgaattcacaatccactgccttaatccacttggctacatccgcccctacgctactatctattcttttttgtattgtctaaaaaaaaaaaaaaatacaaatttcaataaaaaataaaaaaaggtagcaaattccaccttattttttttctaataaaaaatatatagtaattttttattatttattattattatttattattaatataataaataaagtaaaatatgatactctataaaaatttgctcatttttatagaaaaaaacgagtaatataagccctctttcttatttaaagaaggcttatattgctcgttttttactaaactagatctagactaacactaacgaattatccatttgtagatggagcctcaacagcagctaggtctagagggaagttgtgagcattacgttcatgcataacttccataccaaggttagcacggttaataatatcagcccaagtattaataacacgtccttgactatcaactactgattggttgaaattgaaaccatttaggttgaaagccatagtactaatacctaaagcagtaaaccaaatacctactaccggccaagccgctaagaagaaatgtaaagaacgagaattgttgaaactagcatattggaaaatcaatcggccaaaataaccgtgagcagctacaatgttgtaagtttcttcttcttgcccgaatctgtaaccttcattagcagattcattttctgtggtttccctgatcaaactagaagttaccaaggaaccatgcatagcactaaaaagggagccgccgaatacaccagctacacctaacatgtgaaatgggtgcataagaatgttgtgctcagcctggaatacaatcataaagttgaaagtaccagagattcctagaggcataccatcagaaaaacttccctgaccaattggatagatcaagaaaacagcagtcgcagctgcaacaggagctgaatatgcaacagcaatccaaggacgcatacccagacggaaactaagttcccactcacgacccatataacaagctacaccaagtaaaaagtgtagaacaattagttcataaggaccgccgttgtatagccattcatcaacggatgcagcttcccagattgggtaaaaatgcaatccaatagctgcagaagtaggaataatggcaccggaaataatattgtttccgtaaagaagagatccagaaacaggttcacgaataccatcaatatctactggaggagcagcaatgaatgcgataataaaaacagaagttgcggtcaataaggtagggatcatcaaaacaccaaaccatccaatgtaaagacggttttcagtgctagttatccagttacagaagcgaccccataggctttcgctttcgcgtctctctaaaattgcagtcatggtaaaatccttggtttatttaataatcagggactcccaagcgcacaaattctctaagtagataattgagagcttgttatgaaacagtataacatgacttatatagccatgtcaaccaatgtaaaatggataagatccttttagtttagattcataaaaaattttttgtaatcgatgaaataaattagaagcgaatccacatacatagaaatagaattgctctaggaatattttttccaaatcatatgaatacgattgaatacgatccgtagtgggttgcccgggactcgaacccggaactagtcggatggagtagataatctccttgttaaaatgaaaaaaaaaaggtaaaaaacccctccccaaaccgtgcttgcatttttcattgcacacagctttctctatgtatacatagaaaactcaatttctttggttccttataaataggactccaaattcaatactcagtaaatttaatcgtagtcttactgtatgaacatttaataatagaaataaagcacttttgataataaaaaataattgattttttttgttatctctgcataaattttaataaatttcgatttcatttatggggtctcagaacccaattattcatgattgaccaaatcattaagataaagaatatccaaataccaaattcgcactcgatataatcttttagaagcataataacttcttgggaagattaaagaaagaacttggtcttcccccgtaaggaattcttccaataaaccagagcccaacctttttaaaaaagtgcgtacagtacttttgtgtttacgagccaaagttttaacacaacaaagacgaagtatatattttattcgatacaaattctttttttttgaagatccgctgtaataatgagaaatatttctgcatatccgcacaaatcggttgagaatatcagaatctgatgaatccgtccaggttgctttactaatgggatgccctaatacattacaaaatttatctttagccaacgatccaataatagaagaaattggaattttgctatccaatttgattctaacattatctattagaaatgagttttctagcatttgactacgtaccactaaagggtttaatcgcaaacttgacagataacccagaaactctaaattatctttagataattgatttatattgaccttttgcgattgaaaccataccgaaaaataacattgccataaattaacaaaataatatttccatttattcatcagaagcggcgtatcctttgttgccagaatgcatcttccgtgatatctaacataatgtatgaaaggatccttgagcaaccctaggattgccggaaaattattaacaaaaactttgaaaaaatggtgtatttttccatagaatacaattcgctcaaaaaggacttcataagatgtcgatcgtaaatgcgaagaccgcttgcgtagaaaaaaaaagatggattcgtattcacatacatgagaattatataagaacaagaaaaatcttggattcaaaattgatttttttttaatataaaaattcttccaattacaatactcgtataaacagaaccgaaaaaaatgcaaagaagaggcatcttttacccggtaacgtagggtttgaaccaagatttctagatggatggggtaaggtattagtacatctaacacataattaaaatgtcctaatttgtcttctaaaaagggaaatattgaatgaattgattgtaaattataagatttttttaattgttttccttgaaaagaggatcctaatcttagggaaaatggaatttcgacaatcactgcaaataaaacagatatcatttgataatagaaaagactggtatgccccaaaaaggaattttggttcacatccttagtgggaataatcaaacgattctgttcatacattcgcaaaattaagcgtttcgtaattagtgaactatattttttgtcataatccgcattttccaagaaaatatagcgatttctatttaatctatttaaaccatgatcataagcaagtacataaatatactcccgaaaaaaaagtggatatagaaaactctgttgccgagccccatcgaactctaaatatccttgaaatttatccatttggattgaaattcgatttgaactgaaggtaaagtctttattttcttgagttctgaaatgacacatagtgcgatacagtcaaaataaggtattagactacgaaagctatagatatagatacctcataaacaggtagactgctaaccggattctctatctttaataggtttctgttcgttatattatagaataacaaaacaagattattagaaatcctttatttttttaacctaatcgctcttttgattttggaaatatatatattttttatcaatatactgcttcttttacacactccaacctaatccaaatggactagttaaaacaataattaggactcatgaaaaaattgataataacacgcaagaaaaaaatgccttcccatacccgtattaggcactaatctatttttaacatttaattagttggggtaatttttcaaattacgaatggaagctcgtttctttttttttcctggaataaggaaaactggtttttttatccatccatttatatttattcacttgacccaaattggaattcttttttttttttcgacatcaaaataagattgtaccgatcaggaaagcaaaaaaaaatgttatctgaattctcccttgatacgacatgctattttttccattcattcctttcaggatcagtcgtggtcttacaaactctaccgcagatctggacgaatccttttcttcatacaaatgtgtaaaagatgctagtcgcacttaaaagccgagtactctaccgttgagttagcaaccccccccaaaaaaaaaagaacgtactgcaaatatgtagatacaatcagaataaagaaaaaaatacagtcgtgtgtgcgtcagggataaatagatccatttatctatgagagaattatatttggtccatacactgttgtcaatatgattatgaatttttcatatagtcaaaagaatagaaaaaataaataaataaaaaagcttaacctcttggttcattagttcatacaatgaatgaaaactaagccagttccagttaaggtaatctcaaatctttttatactttttagatccattttttttatggcctttaattttttatttttttatgatgaagaaattattcataataatataatattattataatataataatatatatatatttttttttattcagaattatatattatatttatatacagtattattcttttctatataacaataacagtaaaattttgtatttataaaaaaattcgaatttatatactctagatccaaaaaatttttcataaatttgtgtatgattataaaacatagtagttgttagcaaggtattttttagtattcgtaccttaggaggaatactaataataaatagaaattataataaatcaaaataaatatgatggaagtgaaagagaagagtagataaaattttatatcacgttatatacgagtctttcacatcctcttttttatatttcattaatttcatttcgttttagtaagacttcattccgtaaaaatcccagccttctttgaaatatcatgagctgttcttgttggttgagctccttttttaagaaaatcgagaatagcagaaaggtttaaaaaagtttgattagttatgggatcataaaaacccaccttactaagatctcttccttctcttcggtatcgaacatcaattgcaaggattcgataaacggctcgttgggatagatgtatatgaataataccccccctagaaacgtataagaggttttggcctcgtacggctcgagaaaaaaaattcaaatagtaaattcaaatattaaatagagaaataaaaacattaaatcaattagccagtattaaaaccctaaatattttttccataaaaagcattcataacattcgtactctcgtaactcaagttaaacaactctcaaatatctcaccggagaatccttaagtactttttttattgagtagtctctagccctttttttgtttgtctcattgcaaattttagaatcaattttgattcttcagtttgatctagtttttcaaacaattgaaaacaggatttccttttttcaagattctttatccttactttgaatctttaggtttagacatgacttcggtgatattgaatcgttttattaaaaaagggcagcaacaagccccttattttgtttatgatttctgttctttctatacaaagaatcatacaaacgcttgattcacgcatgatagacttttgattcaaagaattttacaattttaagaaaatttccttttccattgtaaaattgcttgaaaggacttttttcaatataaaaagacttacgaagttgttccaacttattaattcgcactaaccctaaatccttactcctgcgaaaggactaaaaactttctattctcctcgagctccatcctgtactcttttttatattacaaaaaagtgtaggactcttgtaaaatagaatacaaaatgtcgagccaagagcacctatattcctaatataaaaataaaagtggcggatgaaaaaatccacagcagataatgtccttcaattcaagtcgtacgttgctttctaccacatcgttttaaacgaagttttaccataacattcctctagtttgtgtaattgattcaatgatggaatcatgaatagtcatagttcagtcagtatataataatctataccttttctttctctatgaatggaatagtttatttacgcgtaaaggttcggtcagaatgaaaatgaattccatattagtttgaatagaaatctatatttatatataaataaataaatatagatttttttattaaaactcttagaatctgcggttctaccttacttacccgcatcacacaaattaaaaaagcaaatagattttttttgaattcggttgaaataatgaaaaattaagtttattcttcttttcatttcaatattttattcttaaaaaatttggatttttaaacagaaagagaaagatggtgtacaaaggcaatagaagattgattctgtaatgactgtactctgggacggaaggattcgaacctccgaatagcgggaccaaaacccgttgccttaccgcttggctacgccccatttcgctttttattcaagactactaaaagagtaatattcctattggttgttcgtcaattcaaaatgaaatatagattacattggtgctaaagttttaacacgtgtagatagcaaataaaacttactttattgatcattacatagaattcaattaagatattgtatgaaaatattatttctttcattctcataagagaataaaaggatttttgattgagtaagttcaacaaagtctttttagactatctttctttattttttccttatataaaaaatatattaaaaactcaatcaaaattaaattatccacaagaacaccaatttttgttatgcttaatatatttaatttgatctgtattttttttaattctacccttttttcaagcacttttttagtcgccaaattgccagaggcctacgcctttttgaatccaatcgtagatgttatgcccgtaatacctcttttctttcttctcttagcctttgtttggcaagccgctgtaagttttcgataaaattcttaatactgtcttaaacaaattcacgattttgatttttccaacaattcaaaagatccaaaaaatcttgacgtatgaacgaactctcaattcaaacatttaatttttttggtagccatactaaatctggatcatttctatttcctaaattttatcctcttttccctaaatgaaagaacctaattagattcaagttcaccaaaaaaatatctagatgttggtatgcaaatctgtttgaatatgaaagattcgactattatcttaattacaaataactttctgaaacctttttttttattggtatcaaaattagatatttgatataaaaatagagaatctattctctttttttttagtaagatcttggagattgtgtaatgcttactctcaaactttttgtatacactgtagttatattctttgtttctctcttcatatttggattcctatctaatgatccaggacgtaatccgggacgtgaagaataaaaaagaaagtttttttattgctttatttaattcgtggaaatgctcgaattttattaggattttatctattacacaccatcaaaaggagaaggggaaagagagggattcgaaccctcggtacgattaactcgtacaatggattagcaatccaacgctttagtccactcagccatctctcctaatcgaaaagggatatttaattaggttccataaaaaaaaaaaaaggcttgaaaaagaaccttctccactttattcttaaaaagctttctttttttgttatagatattctttatctttatattatatatatatatattttttttcattttctatatttttttctatattttattatattattatatatatatatattctttttgattatttgattatataaatatatatatcctatatttaaatatataatatatatataatatatatcctatatataaattatataaatcctctattatatatataatatatatataatatatattatataatatatatattactattatataactgtttttatagaactttctcagcaattctagttacattaaaaatttagctaaagattagataaaaaaggcgcgaactcaaaaaagaaataaataaaaccataatcatagaaatagagaatcctttttttattttgtctcgtcaaaacaaaaacacaagtaaaagatcttttttattttaatagcctggcctggtcagtccccagccgggcctttttttgttaaaattaaaaagactcatccgatggatttttagataaaaaaagatttgaaataaaaaaaaaagtggaattgaattcgcttttactaattttcttaagtcaactctagttttttctaaattttttcagatttttttattacacccccgattactttgttcgacaaaaggttaatttatatgcaataattgcattgtagcgggtatagtttagtggtaaaagtgtgattcgttcctttaatccctttaatagttaaagggtctctcggtttgattaatcttccgatcaaaaattttatttcttaaaaggatttagtcctttccctttcaatgaaagattcaaggaagattatagattctcgtaatttatatccaaagactctaatcaattgtaaatttggattatgaaattccgaaacataatttttgaattggatgactatttacaattcaataagtataacaagaggatccatggataaagctagaaaagtgtctttctaatcgtaactaaatcttcagttctattcattgtttggtatagaaaaattgaagcaaaatagctattaaacgagaactttggtttactaaagacatcgacatattatattgttttagctcggtagaaaccaaatacttttcctaaggattccgttaaatagaaataaagaacgaagtaactagaaagattgttcgagttggcccgatctatcttctagaaggatcatctagaaagcaaaattttctgtgaaagtacccagacggaaaaaagctcacatagatgttatgggtcgaatttttatttcgttcccgtctttttttatttgggaatttctccatccatcataaaggagccgaatgaaaccaaagtttcatgttcggttttgaattagagacgttaaaaatataaaaatgatcaatcgacgtcgactaaaacccttagccttccaagctaacgatgcgggttcgattcccgctacccgctctaaattcacaattgccctttttttttattagagaaaatttgttatattagaattgtctaatagcaattgtgtattgaattcacttcaatacacaattgctaaaaagattttgcacattctttttttttaacaataggaaagtaaaaaaaagcgaaaagcgtccattgtctaatggataggacataggtcttctaaacctttggtataggttcaaatcctattggacgcaatataaatatatctatattgatatttatctattatttccatttctatatattatatataatatctatttcgaaaaaagataagaaataaatagaataagaaagaaattctgaatgctttaagatttaatattaaacagatattagttagatacttctttctattatatatacttgacttatagacttctatttctagaatttcttaaaaaattaattaaaattaaagagtaaaattgactaaagaatcaaaaattaagaataatccgtttcgttttttatactttctcctgaagtaggaaacgttctagttgctcttgaataccttctttcaaaaagctttctgcttcagcggttaatgtcttggtagaggctatgatttcttgaaactgaggtttattcgtttttaagtaagtgcgtaattgaacgagaaattttcttacttgtccaatttctaatccatccagataaccatttgttccggtataaatggtcattatctgttcttccactgtgaggggggctgattgggattgtttcagtaactcacgcaatcgttgacctcttgccaattgattctgagtagctttatcgagatcagaagaaaattgggaaaaggcttctaattcagcgaattgagccaattccaattttaattttccagctacctgtttcatagctttaatttgagcggcggatcctactctcgagacagaaatccctacattaatagcaggtctgattccagcattaaaaagatcggcggataagaatatttgtccatctgtaatggaaattacattagtaggaatataagctgaaacatctcctgactgggtctcgacgattggtaaggcagtcatactcccttcacctaattgagagcttaatttagcggctctttctaaaagacgtgaatgtaaataaaaaacatctcctggataagcttcacgacccggcggtcttcgtaatagaagagacatttgtcgataagcttgtgcttgtttggaaagatcatcataaattattaaagtgtgttgttcacggtacataaaatattcagccaaggctgctcctgtataaggcgcgaggtattgtaacgtagctggggaatcggccgtttcagctaccacaatagtgtattccattgcccctcgttcctgtaaactggtcactacctgagccacggaagaagctttttgaccaatagctacataaacacatattacattttggccttgttgattgagaattgtatctgtggctactgctgttttaccggtctgtctgtcaccaataattaattctcgctggccgcgtcctatagggatcatggaatcaatagcaataagtcctgtttgaagaggctcatatacagaacgtctcgaaataatacctggggcaggagattcaattaaccgagattcagaagcggaaatcttacctcgaccatcaatagggttagccaaggcgtttataacacgccccaaataagcctcactcaccggtatctgagcaatttttcccgtagctttgactgaacttccttcttggatcatcaaaccgtcacccattaatacaacaccaacattattggattctaaattaagggcaatacctatagtaccctcctcaaattctactaattcacctgccattacttcatcaagaccataaatacgagcgatgccatcgcccacttgaagtacggtaccggtatttacaatcgttacttctctattatattgctcaatacgttcacggataatattactaatttcgtcggctctaatggttaccatgagtattgtcctgattcttttgttggaagaaaaaaaaataatgcctataataatcgtaaggaaataattaatcagttatttctttcatcgtaccaaacatcccaatatttgcattaatagtacgtaaatgtaactcattactcaaacaactatttagggttcctatagctccttgtaaagcttgttggaaaacccgttcgcggacttgattaattgttctttgttgctcaaaaagaatggtttcatttttgtaattttctaattgtttcaaagttttataagttgaattaatcaaattcaatttttctcgttcgatttcagagtatccattcacgcgaaacttatccgcttccgtttctacgttacgcaagcgcgcccgggcattttctaattgttgaatagctccttcacgcagttcttctgaatttcgaatagtatttaatatcctctgctttcggttatctaataaatcatttaatgaaagtagattatctttccattcattaaaaaaaaagttctatgatcccttcccgaaccaaacatgaatctttcgattcatttggctctcatgctcacttattccaatcaattatttatgagacttcccttcccatctttttcatgcaatgagcctaccctctcccgagtttttttattcaattcatattcaatatatatttctatcgaaaaagatcaccaatccaagataaaaatattcggaggattcttctgaccaatgaaaaattaataattgtcagcaaagttgtttctttttttcttgaaatccaaagaattcttattattttatacgtaggttatcaattctgcattataaaaaaagactcaaaaaattttatcgacatgagtgttttatatcgaaaaaagtataacaattctttttgaaaattttattcatttttttatttagtctacatttagactatatatagtagaaagagtaccatgttgcatctgaacttcaaacggtttagctttaaccatgttaattaattgtcccaatttttggttaatagagaatcaaagtaaagcggacttaccaaagaataacgaaaggctatggttctcaaatatgatttttttattcagaagtaattcgcgggattatgcactctttcctagttatagtgccactgggtgaatccagcctattcttgaaatgaacaactcacacacactccctttccaaaaaagatcaatacaccgaaaactacacttagatttattggatttgttgctaaaatatcggtattaaatccgaaactcccggcggatggccagtgacccaagtaaacgaaagaatcggttaaatttttcatataatctcctcttctagctaaactataaaaaaggaactctgtccttttttttttattctttttattgaaaataaaaagaaatttgaatttaataatttaatttacctatttggatatttgtaaacagaatcaaaaacctattctatttacaaacgtattttccaaaatttttaattttcaataataataatgagacttattagaattaagctagaatttgagaccaagttttatgtcaagttcaaaaaacctaaacctacttttttcgcaacactccttaaaaaaaagtttctattaaactaaaagaataaggggaaggaagaaagcgaatcgatgtgctaattccccatcctcaaattagtccttcccaaggattgttgtctcaatgaataattgtaggagttaaatcttgatagaattaaaaaaactacaaaaaaaatccagaattttgtgatttctgggcttaaacaaaaggattcgcaaataaaagcgctaatgctacaaccaggccataaattgttaaagcttccataaaagccaaactaagcaataaagtacctcgtatttttccttctgcctcaggttgtctcgcgataccttcgacagcttgacccgcagctgtaccttgaccgactccaggtccaatagaagcaagcccaacagccaacccagcagcaataaccgaagcagcagaaaccagtggattcatgataagttcctcacaccaaaataaagaaatagttaatgatacaatcatccaatgacttaggacgtaattctaattaagtaatcgctaagattaatccagccaaaaaaaccaaaaactttaattgaaatatgaaataatataataaaattattgaatcataagaattactttgatagtagttcctatccgcgggatttttaaaaatccataatatatatacgacttttttatgccattttttttatgaaccattctttgaattcttcgttctttttttatcattttttcagccaattcacagataaaaaggaagaacttctaatcgaatccctatctaaatctaaatagaaattcacaaaaatagtagagcagattcagattatatagatctttaactcatatatacctaggcaatatcaaatatcacatatacaagtgtttcttacataatgtaaaccaactattctataattaattgggctaacctaaaaaagaatattaaaaaaaaaaccattaatgatgaccttccatagactcacctatataagccgcagctaaagtggcaaaaatgagagcttgaatcccgcttgtaaataatccaaggaacataacaggtataggaaccactaaaggtactaaagaaacaagaacaacaacgactaattcatcggctaatatatttccgaaaagtcgaaaactaagtgataggggttttgtaaaatcttctaagatgttaatgggtaaaagaattggggttggttgaatgtatttactgaaataccctaatccttttttgctaagccccgcataaaaataggctactgatgtgagtaaagctaaagcaaccgtcgtatttatatcattcgttggtgctgctaactccccttgaggtaactggataattttccacggtaaaagggctcctgaccagttagaaacaaaaataaataaaaacagggttccaataaagggaacccatggaccatattcttctccaatctgggttttactcacgtctcgaatgaattcaaggacaaattcaaagaaattttggccgtcagttggaattgtttgtggattgcgaatcgctagaactgcggaacctaataagatagcaattacaacccaagaagtaataagaacttgggcatggacctggaaaccccctatttgccaatagaaatgttggcctacttctacaccagatatctcatataacccttcttttattagtgtgttgatggaacatgataaaacattcatattgccctctgacagaaataagaactttaaattattttgattcaagaccccccctttttttttacttatttacttaaattttatattttagttttggatcccaactaaacaaatcacacaatatccccagttttttctctctttttcttttctacaattcaggagtagtaaccgatttttgaaatcgaaatacagggagcccctccctaaaaaaaaaattgatttatttatcttattattaatcaagaattttgtatatagctagaacggccctcacaaattgcgaatactaatttgttaagaatgaatcgaattgaagctatagcgtcatcatttgcgggaatagaaatatccgcgagatcgggattacaatttgtatcgattaaagaaatggttggaattcccaaagtgatacattctctaagagccgtatattcttcttgctgatcgaggatgattacaatatcaggcaatcccgtcatatatttaatcccgcctagatatgtttccaagcgagataattgtctcttcaacacagctgcatcccttttcggaagacggttgaatccctctgtcttttgttcagttctcaagtccctaaacttatgaagtcttttttcggtagtggaccaatttgttaacatgccgccgagccattttttattaacataatgacaccgagcccgtattgcagcccgcgacactaaatcagctgctttattttttgtcccaacaattaagaattgttttcccctacttgccgcatcaaaaactaaatcacaagcttctgataaaaaacgagcagttctagtcagatttataatatgaatacctttacgctttgcagaaatataaggtgccattctaggattccatttcctcgtaccatgtccaaaatgaactcctgctctcatcatctcttccaaatcgatgttccaatatctttttgtcatttcttttcacacttaaaaaggggggcaccccaaactaaaataaaattttgttccgatggaaccttctcttgtaccggggatggccatttatgcatgaaccaagccattattttgtattgattattatctttattagtgttaacaaattacgaaagcaaatgactacagcaaacaacaaaaactaaaattttaaatagtccgctattagaaatcattaaatcctagaaaagtcagatttggaaatagaagagtcacaaaattccctgtggtagaataaaatatctctcatatctccctcgaataaagctaaattctttgtttttttttccaaaataatgttggtatgttgccgtgaacaatgcaccaatcctttgttgaatccggtcccggcggggatcaccccccctagaacaacattttctttcaggcctttcaaccaatcgatacgaccccgaagagcagcttttgctaaaactcgagcagtttcttgaaaacttgcttcggatataaaactttgagtattcaaagatgctcgagttattcctaataaaacggctcgataacagattgcttcttctaaagcacgccccgttcgttctgctcgtaataatccaataagttctccaggtaaaaaaacattagacattccctcttcggaaaccaaaacttttgatgttatttgacgtacaataatttcgatatgcctattatgaatctgcaccccctgggatcgataaaccttttgaatcttattaaccaaagaaatacgactttgcactatagttaactcagcaccaatcaagaatccccaaggaattccaagaattcttgttatacacttgttccaacccttaatccgcttttctaagttcaacgatattgaatcaatcgagcggacttctaaaacttgttctacttttggaagaccttgggttatatcaccggatctcgatttttcatatataaatgtaactaatgtatccccttcgtaaagaatttcgctgtaatgcccatgaacttttgctcccggagtagccaaatagggcttagcggatcttattactgcggaatccctttgaacaattaaaacttgacccgattttaggtgcggttcttttttagctatacatacattttcacaaaaaaattgtccaagactaattattgtggacgtttcctcacaataattatgatgataattttgatgaagaaaataccaattcaatttgaatggattcaaaacaacgttactatatgggtcgagatttaaaattattccgttttcatcgattaaataagagttaattttttgaaaaatatattttaagttatcaagttgaaaatatttaattaaagagatctgattataagttagtaaaggcaaaaacgaataaaaatttgaaattggggtagctgttcctaaggggcccgacgaatttttaattgtaattagagtatttttttttattgattggtttatcacattgtgatgttttacatgattaaatggacccattctaaaacaattagatgatgataaaattaacaaagattgggactccttatttcgatttaagaacatgcgaatagttccgtgattttgtctaagtgattgttgaagaatgccagacttgggcgaaatcgaataaaacggattcatgtgatctgcagagatcaatcccgaatctggcgaattattcctttttcttatatatgaaatatgggatttcactaagccaattcttatgaaatcttgaatcaaaccctttgtacttacttcaacaaagaaagcacggacctcctcgagagaagaatttttgtcccaattcaagactaaacaagttcgaactaattgaatacttgtgtcagaaattcctcgagttggtttgccatttccataaaggatatagttgaaaactcgaagttgaatattatccttttcccgaaagagatcttgtgggaagagtgttgccaaatttatactgtccgctatctcataggtggctacgggccgcaccaaaacaaaaaactttttcttggttggtgtaatccgttggacataaatccaatttttaaattttttggattccttcgagtttttttttcctcttcctggcggtatcaagatgccactgtgtcgggatattttatctgtcttgtccggaaaatggatatcccctgaaaatattttgagttcaatcctttttttttttttctctactcggatcaacccgccgacttggcttcttatatttaaagtgagtcgtgtatccactccaatgatactatagttctgtaccattatggcagaggattcgggtaaaatatgcacttcctcaggaatgaaaaaaaagcgatctactttcatttcgtattttgtcttaattttttggactcctcgatactcaatcatatcctctttttggatgattgaatccgcctttagagtcccatatttaagaattccggaactctttcttcggtatctaggatcatcaaaaaaagcaaaaatactatttctacggaaaataccatttatgggtatttcaaccgagatacctgactgcggtatgaattctttctcttgctcttgaatcgattggaatggaatgagaaatctatttcttcgtctttttgctaataaatccgagttctcatgaaaaatagcagaatatattaaattataatgactagtacctaagtttccattcaattctgaataatcgtaaatccctaatttttttggatcggcaaaatcggaactaaaaaatttttggctcacttgatcattattcactgagaggctagaaatagattttctttcggcggaaagaaagggtatattcatttgatcttgatctttatggatcgaaaaacgaattagactagatccacatgaacctccggataatatccataaatgacttgtttttggtaagaggtggacattactatatgtaaattcgggtgcatgggacacatcagtactccagtgcatttcgccctctgagtcagaataaatatattttctaaccctctctttaaaatgaaaagtgtatgttccctcgcgaatctcagcaatcacttgttctgattccacatattgatcattttgaactaaaagaaaactttttggtggaatagtcacgctatgtataatatcttcgctctcaataattacagacaagtctatataacatagaaaggcaggatgcccgtgacgtgtacgtgtaggatgaaccaaatcctcattgaatttgatttttccattataaggggctcgtacatgttcggcagtacctcctgtaaatactccgccggtatgaaaagttcttaatgttagttgagtccccggttcgccgatcgattgacccgcgataatacctacagcttcccccaattcaacgaggtcaccatgagtgggactccgaccataacataatcgacagatccaagatgtactccgacaagtaaagggagttcgaatggatattgattgtgttccaaaggttattaatcgattgacaagtccaatcccaagatcttgatttcgaaaggcgacacatcgggaacctatatatatatcgtctgctaagacacgaccaattaatgtttggataaaaattctttctgacatcatccgatttttatttcgaggactcaccgaaatccctcggatagtgccacaatctgttctacgtacaacaatatgttgaactacttcaacaagtcgacgcgtaagatatccagcatctgatgtgcgtacagcagtatctacaactcctttacgggctccatagcaagaaataatatattctgttaaagacagtccttcgcgtaaattgctttgaataggtaaatcaatcatttgtccttggggatccgacattaatcctctcatacctactaattgatgtacttgagatgcatttcccctagctcccgaaaaagacatcatatggactggattgaaggggtccgtcatcctaaaattaggattcatttcttgtcgcaaatattcacttgtagcataccatatctcaatagattggcgtaatttttctaccgcatgtacattcccataatgatggtgtttttccaaaatccaactttgttgttcagcatcttggacaagccagcccttagaaggtatcgttaaaagatcatcaattcctaatgaaatggatgtagcagtggcttgctggaaacccagagtctttacttgatctaggatgtgtgatgtatatgccatcccgaagtgatctattaatcggctaataagtcgtttaatagcagttccatctatcactttattgtgaaataccagattggcccgttccgccataagtacctccatattctgctgaatgggattcgacaatgagtttgagtcaatgattgcaaaacttccttttctcgatcttgatttgcgtagaattttaggtcaggaactatggtccgatttgaatcggagaggtccgaattcacacgggtgtcctagaattccttttttttaatagcatattattaggtatcatatgaacaggcttgagaaaaaccttgtatagcttcctcgatttctcgataaaaagaaatatgaccaactgtggttcgaatatatatacaaaaattttctttttttacacttcttactattagatagtgtgcataaatctcatgatagttaccaaaagattcatagtgaacttcgataggaacttctcttgaagcaataacgcgttgatctaattgccaccgaagccacaaaggactatctaaattgatttttttctgtcgataagctccaattgcatcataggaattgcaaaaaaagggttctttcgtatacttatagtttgtttcgtaaattctttcattttgatagttttttcgattacatggattatatctgtttgcacaaatacctcgacgagtgccgctcgttaatacatagagtccaataagcatatcttgagtcggtaccgaaatgggatctccaatagctggagataagagattcatatgagaaaacataagtaaacgagcctctgcttgagcctctaaagataaaggcacatgaacagccatttgatccccatcaaagtctgcattgaaccccttacaaactaatggatgtaaacaaatagtgcgtccttccactaaaataggttggaatgactgtatgcctaatctatgtagggtaggtgctctattcagtaatacgggatgcccctgcatgacttcttgaaggatttcccagacaatcggctttttttcacgaatttgactcttagcaactcctatgttcgaagccaggtgttgtctaattaaaccacgaattacaaatgtctggaagagctctattgctatttcgcgaggcaatccacagcgatgtaatgaaagtgaaggtccaacgacaatcaccgagcgccccgaataatcgacccgtttcccaagcagagtctcgcgaaatcttccctctttgccttcaattacatctgaaaatgacttgtaaaccttattatgaccatccctcatgggttgtccacggattccattatcaagaagtgtatccacggcttcttgtaccaatttttcctgacacattactaattcccccggtgtagatctacttgttgttaatagatcggtaagagtattgttccgatagataactcttctatagagttcattaatatctgaactcattagtttacccccttctatctgaatgatgggtctcaactcgggaggaagaaccggtaagagacataaaaccatccattcgggttctatatttgttcgaataaaatgcttagctaattccatacgtctaactaaaaaatcttttcttcttacaatttttcgatcttcccattcattccccgtaggcccttcttctcctaattgtttccattctaccaacgaattttctataataattcgcaaatctaaatcggctaattgttctcggatagcacccgccccagtagaaatttctcgatttcgaaatatatcgaaaccttgagtagtaaaaaaaagtgggatgctgtatttccaggattgaatttcatattcaaatgaacctcgtaatcgtaagaaagtaggttttttagttatgggcctagcaaaagaaaaattgggatagggtccactataagatctcccccctcaaaaccggacatgaaagtttcctctcatccggctcaagtagttataccaaataaagaaaggggtctcgctttcaaatttcattttataaaataaagtgaaaaacccaaaaagaatctacgccttactcaagttctcagtgcaaaccaaccaacatttcattgattcaattaattcttctttgatttctatttaaattctttagtgaattaaaaattacgacagaaaaaaatgtcaaattcttgagtagtctacttcccttcgaatgccggaatactctttaccttaagtgaaaggaatgccttaaaattcatacgggatttatttgtctatgtattgttccattcgatcttttaggtcctgcgtcacctcgatggttatgccacaatattcttaaagcttatatgcgatgtatagacttctgcaaccatgacatatttgtttactttatataaaaataaaataatataaaactataaaaaaccaaatttattttcttttagaaagataagggaatgcgtaattcgacaaaacaaggtcttcttttcacgaggtacgcctatcaatttgaatttctgaatcgaccatagaccaatcgcctttttttttatttgggagtattgaatacacccacaattctgagcttcatgttactcttttcaagagacatgtcagatcgagggcatcccaaattgattgaaggggatgagagtttatcattcttaatctgtaaaagaaaaatttcgatcaaatcacacatcgcagtatactaggccttctaattctttaagaggtttatctaaaagattcgcaatataactaggaagacgtttcaaataccatacatgagttacaggacatgtcagttttatgtatcccatttgatatcttcgtatccgagaatcaacaaattcaactccacattgttcacaaaactttgggtcttctttttcatctccgatcactcgataatttccacaagcgcaaattccactctttataggtccaaaaatcctttcacaaaataatccatctttttccggtttattggttttgtaatgaaaagtatagggttttgtcacctctccaactatctctccattaggtattattttagtggcccaagcacttatttgctgaggagaaactaagccaattcggagttgttgatgtttataccgatcgatcatataagaaattttgtgattcattccgattaaacttccttcctattaatctggaaattcttctcagatacaaggaaatgattcagttccagagccaaagatcgtagttctcgaacaagtaatcgaaaagattccggagcatcttctggtttaggtattgttcctccaatgatagtggtaccaagtacttcttggcgagctctaatatgatcagatttataagtaagcatctcttgtaaaatatgagcaacaccaaacccctccagagcccaaacctccatttcgcctacccgctgccccccctgcttggaacggcctctaaggggttgttgtgtaacaagtgcataatgtccactagaacgtccgtgtattttatcatcaacctgatgaattaatttcaagatatagggctttcctattatcacaggctgttcaaaaggatctcctgttcttccatcaaaaatgcggctttttcctggatactcgggttcaaatacccatggattcgctgtttgcttactggcttcatataattctgaaaacaccagttttctcgaagcctcttgttcatatctctcatcaaaaggggctattcgataatgtctatctagcagacttcccgctaacccaagcgagcattcaaatatctgtcctacattcatgcgtgagggtactcctaatgggttgaagaccatatccacgggtctcccgtcttgcaaataaggcatatcctgtctaggcaaaatttttgaaatgatacctttatttccatgtcttccagctactttatcacctacttttatttcacgtttctgtgaaatatatacacgaattatttctgggttataacttgaaccaccctttttctgaacccacctcacatcaataactcgacctctaccacctataggcaattttaaacaagtttcttttgaagtcgatacctgaatgccaagtatagctcgtaataacctatcttccggagcataggaggattctttcgccacttgaggtgttaatttacctactaaaatatcacctgtttcaacccacgatcctagcatcacaattccatttttgtctaaatttcggagtaaacgaccttctagatgcggtatttctttagtgatcctttcaggaccttgggttgtcacatgcgtctgaatttcatatttccgtatgtggaaagaagtataaatatcaccatatactagacactcactaatgagtaccgcatcttcaaaattgtatccttcccatggcatataagccactaatatatttttccccaaagcgagttccccaccaactgtagcagcaccatccgctaaaatttgtccctttttaatgcatttaccccgacgaacctgaggtttttgatgcatacaagtatttttgtttgagcgttgatacataattaatggaatgcttagagtatcaccattgcccgaaaaaacgatcttctcagtgtcagtataaaggatttttccctcgtgttcggctatagcgggaacccctgaatctaaagccacttggcgttccaacccagttccaacaatgcacttttcggaccgagaaagtggaactgcttgacgttgcatattagaactcattaaagctcgattcgcatcattatgttcgataaaaggaattagagaagctccaatggaaaaatattggaaagggaaaatgcttcgaagatgaacctcttcccatgcgatagtcaaaaattcttggcggtatcgagctggaacagcctgttcttcttgaatgccccgattaagagccaaagaatttcctgccgctatcatataatattcatcttgacttggtgataaaaaaagcatccgtatccgtgctttttttgatttctcaaagagttcataaaatggactttctaacgacccccaatcaccaatcctggcatgaattgataaagatccaataagtccaacattgattccttcagacgtgtcaatgggacaaatacgcccatagtgactaggatggatatctcgtatccgaaaattagcagttcgccctgttaatccgccagggcccaaataactcaattttctcccatgaacgatttgtgtcaatggatttgttcgatccaaaacttgagataatgggtgtaatccgaaaaaggattcataagtagttgttaacggagttgaagttaccaaattctgaggagtaggtatcaatttatgcctaattgctccggagatagttcccttaactacattttctaaacgagccagagccaacccgagctggtcttgtaaaagatccgctacagagcgaatacgtttatttttcaaatgattcatatcatcaagtgtacccattccaaatttcatcccaatcaaatgatcggcagctgctaacacatctcgtggtaacaaaaatatattgttctgaggtatattaagattcagtctccaattaatatttcggcgaccaatccttcctaattcacacctttggtgaaagaattttttttgtaattccttacataaggattcagaaaatataggatccccacctacacaagaaaattgttgataaaactccaaaatagcattttcttttgatcctattttttttttctccttatcggtcaagaaagataagaaaatttcagggtagcaaacattctctagaatttctcgtagattcaaacccatagctgatgatagaactagaatagatattttttgtttcctactcacccgagcccatattcttgcttttttatcaatctctaattctaacctgcctccccaatctgatattatggtgccggtatagaccgaaatcccattatgatccaattctgactggtaatagataccgggactttgcaatatttgattgatcacaattcggtaaattccgtttactatagaagttccaagggaattcattaaaggaatgtttccaataaaaattctttgttcttgcatattcctactggttttccaaattaatcccgcggatacatataattcagaagaatatgtaagtgattcatagacagcatctcgttcttttatcagaggttctaccaattgatatgtttccacaaataattgaaattcaatttcgtgatctatatcttcaatttttggaaacttagcaagttcttctattaaaccctgatcaataaaccgataaaacccttcaaattgtatctgattaaatccgggtattgcagatgttccctctttttcatccccaagcatcttttttgaatttcccatttatccgtttattgaaaaaatcccatcccatttctcattcttcaccgaatcatatccatagaattcgatctagcaataatggaatttctattctgtttactgaatcacatgaaattttatccaactccaagatatatggaatgtattaaatacgtatgaagggagactatattcaattggaattttttataagaaatagatccaaatggaacagaattgagaaataccgctggaacttacggagttttgtaaagactagaaaaaaaaagtaatttcattttcacctatgatattacatattccaattcgattgcataccataaaaaatgtattcatcattggatctgttcgagcagataaacatataataaatagaaaactttttttttaaccactttactttttcatgtattttttttcattgttcaaacaaatatttgcagaaaagagatttatttttacctgttttgaatagaataggaagtaggtaagaaaactttttttttatttattaattgttttattattaaaataaaaaagaatgcacagatatatatgtctctttttcttcttttattgtggtacagttctatttgggacagcgcatgctgggctctataaaaaaggaaatgttctcttcaagggaaaaatggaaatataaaaatttattgagaattactcctcaaaagcatctctagagagataaaataccccattatagagctatagttctataacacaacgtaacgtatgttctgattctggggtttacatatactcatcattactgttataatttaaattgaagaagatttctttttaattgaaaaaaactcaatatagattagttagaaatgcatttctaatgattttcttaatattattagaaataaaaaactggagattttaattttcattcaaaaaaggtcatgaatttacagtcaatagttaatggttctggtttgtactagattcgatattttgtgattgaaaatctatatatagatttttttcggaatcgttttggcggcatggccgagtggtaaggcgggggactgcaaatcctttttccccagttcaaatccgggtgccgcctcagcaacaaactttaaataacaaacgtaggaaaagactctttatactttcttttcattattctaagcccctggctcgcgaggttctattctctaccctaaagttttgcctatcagattcaaggaaaacttaaagtagtggagggaaatctgtaaatctttacttgccactactaatttagttccacttactgagtcttcaattagattggatagccggagagagatttaaattaatagttttgaaaaggacctaagatactttggatatatactcatgaaagtctcggaatgctcagacattcaatcaatattagattagattaagaattgcctttcattttacttccaaaaataaaaaacgataaaagaaataaaaagtattcttctttctacatgtgagtcagattccttggatacttcaaaaatgtcggtttgcttgtgtttacatcttgtcgattctactagaaattctataaaaaaaaagaatcactcattataagataagtggatttttggagtagttcatcaatggtgaccaaaaacctctcccttttttttgactctgcaccagtgatttcactattattagtgaacaataatggaatagtttcttcatattcatagaaatagggggcagaattcacatggatatagtaagtctcgcatgggctgctttaatggtagtttttacattttccctctctctcgtagtgtggggaagaagtggactctagaaatacttctaattgcggtaataatcaaactctatcaacctgtatcaattgttttcgttttctagaccgttcggcaattttttttaagattttttttttagaaattggatttatgttttattgactcattttctatttttctatcagggtttacacggttaaccattcatggggtaacccctttcgaaatctgaagaagcttccatcgaattgggattatctgtattaaatggatcaaacaaacaaatgaaattgacaaagtatgtacatacttttcatattctatttcatttatattgacgtttataaagaaaaagagagatataggtggattcctatatattaagatatttcacttgtatctttatacattacaataaccataatggctagtatggtagaaagagatctctttctaccatactagcggaccccttaggatactactactgagtctaatgcgttcctttcatttaagacgagaaattgaaatctttttttttttttgatagtaaaattttattcaaattaatcattttgactaacggtttttacgtaaattataagcaaaaaagcagtaggaacgagaatgaagagtgcagtagcaataaatgcaagaatatttacttccataatttaatcgtttattattattattttttttttctttggaatatctcgggatttaatcccatagagatgagaaatctttcgcttgtaaacttactcagatgaattagattgcgatgatatcgaatgaaagaaatatcatgaataacaatatcggagctataaaatcgattcatcgtcaagaatttaatagtataacataggaagatcttttatccacaccgaatacataatgagattcccgatccaataaaaaaaaaagttctttatgattctttttcccggctttcctttctaaaacctagtagtttactttccttgtacaatcatctgatgaagtatcataaaaaacttcgattctttacaaaaagagtttctaaagaaccttaaataaacaatagaaatcaatatagagaaaacaagtacgaagttcaatttgaaataaaaaaattgaaagggtttatcatctttttggaaaacaaagaaagggaatgtgacaaagacgagtcccggtaaaaaaacgaaaatattcaaaaaaaattaacgagttaatttttcttacgagttttttattcgacatcgactctaatctttaaaaagagcctattcattagggaagacacattttatctttattaaaaaaaaacctctttccttggttgaattcgaactatttaaaattccttgacttcatagaaagaaaagtatatataggtactcttggcaaatgtattatacgcgatcctattccattttcctacacgaaattatgggagagcggttgacaaaaagcggaaaccccatacagtatctctttcttgaagtgttgaatgctctcaataattcatttacatatgtttctctaccctagttaaaataatcgaccctttcttttgctttatgaaaaaagaaaaatcaaataaaaagataaatgaaaccattttcatccccttgctcggaaacaaaaaggggagttgatgtattgaatccgccgggactgacggggctcgaacccgcagcttccgccttgacagggcggtgctctgaccaattgaactacaatcccatggaaataaagcgggtagcttacatattccttcttatgatttcattttaatcatttcaattttaaattcaaatttttgttttgtaacaaagaaagtcacaagtgatatattgatatctatatggatatcactttagtgagagcaagacggattactgggtaatccttacattattatcaaatcaattgataatctattttttacaaaaaaatagattattttatcgactctgttcattaaagtttctctttaaaggatccatatcggaatccttagcaagatcaagatcggaattttttatggaaaaaaaaagtaactaaacataagaaataaagaaaaaagtaaagtcgaactataccctataccctgaaatttgacctttttttcttaccccttctctgtcatttatgcaaaaaaaaaaaaatggttatgtagacagctaattattgggccgagctggatttgaaccagcgtagacatattgccaacgaatttacagtccgtccccattaaccgctcgggcatcgacccaggaagaatctattctaactttatggataatccatgatcaacttcctttcgtagtaccctacccccaggggaagtcgaatccccgctgcctccttgaaagagagatgtcctgaaccactagacgatgggggcatacttgctcaaccgccatcatactatgatcatagtatgatcagtttttttaaattgtcaatataatgaaatgaaatggtatgactagcttataaggttttttcttttttctatagaattctatatcattttttttttacatttgtattcatattctaatcataattctataacaaataaatatactttctttttatatttgaagtggaaatattaaaattaaaaaataaataaaaaaaaatctaaaaatcgtctagtacggaatcttttcaagaagtgattggtctaacataaaaaaaaaaaagaaaaaaagagggttaagtttcgttttttttttactttccttgatagattgcctcatctcattgttaagaaatagtagtatccctgtctaacactaatccaagaaagtcagccagaatccatcttctaattagggaaaaaggtggatttataagttaagttatcaaaaatttgctttttttttttttagaaaattattgttcagaggataatccgtatctcttcatcacatgtcaagataaaatatcttgggtgtatgtcaacttgctgagtacatgtataaatcaaattaatttcgttcgatgcgctaggctattaaaaaaaaattcattgcatggatatttatcaaatccaatattaaaaaagcaaaaaataccccgttaagtaaatttgaagtcaattcaaattctcatttctagttcccaaatgagctactaaccactatgcgtctattgtatatatatttaatatatatatatatatagattttatttactaccggctcagtcaggaattaaaccaagacggcccttttaactcagtggtagagtaacgccatggtaaggcgtaagtcatcggttcaaatccgataaggggcttttacgttctttactttctaatagtcaaaatttcatttgaaagtctataatttaatttcaaattttgttaatttcattctaataaatttcattctaataatataataactaataataaagttagcgagtaatttaaaaaataaaaatgaacatttgtatattataatacaattacaatgaataatgataagtcgtctcttgaatcgccaaatatatattctttttttttcgatttttcgatagattagaaatcgacaaatccaaaagaaaaagtaagtggacctaacccatcgaatcatgactatatccactattctgatattcaaattcgatagagattaaattgaaacagtagattttttttatttcatatttttgtattaggaaatccgtcgatatctcttattgaatcttcttgtttctatatatttcataggaaatatattgcgttcctgcctagagaaagagagtatttttgcaaagtaataactaaaagggcgtttcaatattttttttgattcgagaacataacaagatcctacattctctttgtattaagaatcaatttgtattaaaaataaacaaaaatcgaatcataatcatggcttcagatatcaattaaatatttccatattgatgcatccgagatgacaatgtaatgtgatcgaaggtgtatgtgagaaagaaactctcatttacagtttcctataattttatttaaatattgaattaaatataaataagaaattttccccttttttgacagatacataagggcatgtacatatagatatcaaagaaaatagaaaaaaatattaaaagttccctttttgcttcaacccgtcaactaaaaaaagggtataaaaggaaaataacaatagttgatactatagtatttaatagacaagtatttaatacacgcaaaaaagaaaaaaaaaagttctttattctttatctgaataatgagtcatccgacaattcatgatttagattcaactacttatacttattaataaactaatagcaaggaagaaacaaattgagttgatccgtttacctaagtaaggaccaataaaatcaaaaattttgatcttcgaaaccaattaaatgaaattctaagggttccattttatggggcagtgcgcgagaaattaaatcataaacaaatgatagaatttgagcgccctgaaaatgccataatatataacatcaaaatctataacattaaggtgttcggaaatggttgaagtagatgaataggaggatcgctatgactatagcccttggtaaatttaccaaagacgaaaaagatttatttgatattatggatgactggttacggagggaccgcttcgtttttgtaggttggtctggtctattgctctttccttgtgcctatttcgctttagggggttggttcacaggtacaacctttgtaacttcatggtatactcatggattggccagttcctatttagaaggttgcaattttttaaccgctgcagtttctactcctgctaatagtttagcgcattctttgttgttactgtggggtcctgaagcacaaggagattttactcgttggtgtcaattaggtggtctatgggcttttgttgctctccacggcgctttcgcattaataggttttatgttacgtcaatttgaacttgctcgatctgttcaattgcgaccttataatgcaatcgcattctctggtcccattgctgtttttgtttctgtcttcctaatttatccactaggtcaatctggttggttctttgcgcctagttttggtgtagcggctatatttcgattcatcctctttttccaagggtttcataattggacattgaacccatttcatatgatgggagtcgccggtgtactgggcgcggctctgctatgcgctattcatggtgctactgtagaaaatactttatttgaagatggtgatggtgcaaatacattccgtgcttttaacccaactcaagccgaagaaacttattcaatggtcaccgctaaccgcttttggtcacaaatctttggggttgctttttccaataaacgttggttacatttctttatgttatttgtaccggtaactggtttatggatgagtgctcttggagtagtcggtttagctttgaacctacgtgcctatgacttcgtttcccaggaaatccgtgcagcggaagatccagaatttgagactttctatactaaaaatattcttttaaacgaaggtattcgtgcttggatggcggctcaagatcagcctcatgaaaaccttatattccctgaggaggttctaccacgtggaaacgctctttaatggaactttagctttagctggtcgtgaccaagaaaccaccggtttcgcttggtgggccgggaatgcccgacttatcaatttatctggtaaacttttgggagctcatgtagcccatgccggattaatcgtattctgggccggagcaatgaacttatttgaagtggcccattttgtacctgaaaagcccatgtatgaacaaggattaattttacttccccacctagccactttaggatggggggtaggtcctgggggagaagttatagacacctttccgtactttgtatctggagtacttcacttaatttcttctgcagttttgggctttggcggtatttatcatgcacttctgggacccgaaactcttgaagaatcttttccctttttcggttatgtatggaaagatagaaataaaatgaccaccattttgggtattcacttaattttgttaggtgtaggtgcctttcttctagtattcaaggctctctattttgggggcgtatatgatacctgggctccgggagggggggatgtaagaaaaattacaaacttgactcttagcccaagtgttatatttggttatttactaaaatctccctttgggggagaaggatggattgttagtgtggacgatttggaagatataattggaggacatgtatggttaggttccatttgtatatttggtggaatctggcatatcttaaccaagccttttgcatgggctcgccgcgcacttgtatggtctggggaggcttacttgtcttatagtttagctgctttatctgtttgtggtttcattgcttgttgttttgtctggtttaataataccgcttaccctagtgagttttacggacctacggggccagaagcttctcaagctcaagcatttacttttctagttagagaccaacgtcttggagctaacgtggggtctgctcaaggacctacaggtttaggtaaatacttaatgcgttctccgactggagaagttatttttggaggagaaacaatgcgtttttgggatctgcgtgctccctggttagaacctttaaggggtcctaacggtttggacttgagtaggttgaaaaaagacatacaaccttggcaagaacgacgttcggcagaatatatgactcatgctcctttaggttcgttaaattctgtagggggcgtagctactgagatcaatgcagtcaattatgtctctccgagaagttggttatctacctctcattttgttctaggatttttcctattcgtgggtcatttatggcacgcgggaagggctcgggcagcggcagcgggatttgaaaaaggaattgatcgtgattttgaacctgttctttccatgactcctcttaactaaagtagtaggtaaaacaaataggttcatattaaaaagtcttctttgtttctttcaattcaatctaaatttttctggctcggctatactatccagccgagccagaaaaatttatttatcatgctaagaagtaaaaaaagccaataaagagaaaaatagattcatccaacaaaaggagagagagggattcgaaccctcgatagttatttttatgaactataccggttttcaagaccggagccatcaaccactcggccatctctccgaaagataatttctattttatttttttttcgccaaatagaacatagccctatgagttaatacgatcactatgtagagaaagatatagggtgtgactttctttaataggtctataaatctggctatataaataaatgagatacgcgatccagtatacccgtttgtgaagtaaaaaagaacctttaacttcatgtccgaatagactaaaagtggtaaaaagaaattggaactaagtcatctcgaatcaacggattcatgataaaatccctttatttattaaaaatttttagtgggtaagaggattaaatggtgtatattcttttgttaatagcttggaggattaaaaacatgactattgctttccaattggcagtttttgcattaattattacttcatcaatcttactgattagtgtacccgttgtatttgcgtctcctgatggttggtcgagtaacaaaaatgttgtattttctggtacatctttatggattggattagtcttcttggtgggtatccttaattctcttatctcttgaattcattcgttgcagatccaaaaatgagatgaccccctcccattccttgaattacacattcaaattcaatataagtccataaaatgcaaataaagaaaaaattagagggggggtcgaacttatggaacttgaatgaaatatgaataaaagattaataaatagttactaaatatgaaatagttcctaaatatgaaatagtaataaaaaaaaataaataaaaaaaacgaataaaaaattgagatctgatatcaagtcaatatagaatataatattttatggaaatataagaataatatattcttgaatctggaattcaatattaaattaaattaatattcaagaattaatattaatatattaatatatagaataaatataatatatattattaatatatatatttataatatatatatatatattaatagaattgttaattgaatttatttggtggtagaattttatgaaatgaccccaaaccaaagagtgtatctcgtctagctttgaacaaatattatccataaatttcttataaagaagggcaaaaaatgcggatatagtcgaatggtaaaatttctccttgccaaggagaagacgcgggttcgattcccgctatccgcccaaatataaatggattcaaaaagagaaaatattcggtatagttgaccgggaaatattgtaattttttcctcgcgtcccaaaagacacgtattaatttatgacttgttagtagaatcaaacttacatttcttgaaaaaaaaaagttgcggagacaggatttgaacccgtgacctcaaggttatgagccttgcgagctaccaaactgctctaccccgcgctgaaacaaaaaaacttggattaaactctaataaacaaagaataattgaaggagcccctcttccatatctgtacaaatagaatagcctatttagacagaatggtaaaggggcctcatcgatcatagaaaaaaatagaaaaattaagggatacttaaatccttaccagcttgatcttgttgcccctggcaacaaacatgcctgaaccatttcccgaaggatgtgtccagatagtccaaagtctcgatagttagctctcggtcttccggtcgaaaagcaacgtcgatgaagacgtgtaggtgcactattacgcggtggggattgtaattttccatgaattttccatttctcacttagcgacggaatcttacttatttccttttttgaggatcgacgaatcaaatgatattttttttccaatttttgcctcttcttctccctataaatcaaacttttctttgccataatgcttcagttcctgttattatcaatgataatgatacaaatcggatcctagatgtagaaataaatataagagtgcatacctatattttttttattaaaaaaaatatatgattgcggatagaatacataaataattaaccgaatttgcccgatgtggaggcaatcaagaaagccgcataagtgaatatataacctacagaaaagtgagctaatccaaccaatcttgcttgcacgattgaaagagctactggtttatctttccagcgaatcaaatttgccaaaggtgtgcgttcatgagcccacgctaaagtttcaatcaattcctgccaataaccacgccaggaaattaagaacataaatcctgtagcccaaacaagatgcccaaataagaacatccatgcccagactgataaactattcataccaaacgggttatatccattgataagttgtgaagagtttaaccatagataatctcttaaccatcccatcaaataagtggaagattcattaaactgtgaaacgttaccctgccataatgtgatgtgtttccaatgccaataaaaagtaacccatccaatagtatttaacatccagaaaactgccaaataaaatgcgtcccaagccgaaatatcacaagtaccacctcgtcccggaccatcgcaaggaaaactatacccgaaatcctttttatctggcattaacttggaaccacgtgcatctaaagcaccttttactaagatcaatgtagttgtatgtaaacctaaagcaatagcatgatgaaccaagaaatctccaggacctattgttaagaataatgaattactattctcattaatagcatttaaccagccaggcaaccatatgctgcgacccgcattaaatgctgggccacttgtcgaagataaaagtacatcaaatccatatgaagttttcccatgagcagattgtatccattgggcaaatataggttcgatcaagatttgtttttcgggagtaccaaaagcaagcatgacgtcgttatgaacataaagtcccaaagtatggaaccctagaaagaggctggcccaacttaaatgggatatgatagcttctttatggtctaacattcttgctaatacgttatcctcattctgttctggattgtaatctctaataaaaaagatagctccatgagcaaaagctcctgtcatgatgaatcctgcaatatattggtgatgggtatataacgcagcttgagtcgtaaaatcttgcgctatgaacgcataagcaggtaaagagtacatgtgttgagctaccaaggaagtaataactcctaaggaggctagagcaaggcctaattgaaaatgaatcgaattattgattgtgtcataaagacccttatgcccacgccccaatcgtcctcccggaggaatatgtgcttctaaaagatcttttatactgtgtccgattccaaagttcgttctatacatatgacccgcaatgaggaaaagaattgcgatagctaaatgatgatgtgccatatcggttagccataaactttgcgtttgtggatggaatcccccaagaagggttagaatggcagttccggatccttgggaggtaccaaataaatgactactcgagtcggggttttgagcataaagattccactgacccgtaaaaagtgggcctaacccttggggatgcggtaatacatttaagaaattattccatcgaacatattcccccctggatgcaggaatagcgacatggactaaatgacctgtccaagccaatgagcttaccccgaatagtcctgacaaatgatgattcagacgagattcagcatttttgaaccacgaaactcttggtttccattttggttgtaggtgtaaccaaccccctattaaggatagggcagaaagaaataatagaaaaagagctccagtataaagatcttcattagtacgtaaaccgattgtataccaccactgataaacaccagaataagctatattcaccgggccaagagcacctcctcgagtaaacgcttccacagccggttgaccaaaatgaggatcccaaatagcatgagcaatcggtcttacatgtaaagggtcttgtacccatgtctcaaaatttccttgccaagctacatgaaacaaatttccggaagtccacagaaaaattattgctaattgcccgaaatgagaagcaaaaatattctgataaagacgttcttcagtaatatcatcatgactctcgaagtcatgtgcggtagcaataccaaaccaaatacgacgagtagtggggtcctgagctaagccttggctaaaccttggaaatcttaatgccataatgcctttcaaatcctcctagccattatcctactgcaataattcttgctaagaagaacgcccatgttgtggcaattccacccagaaggtaatgggttactcctacagcacgtccttgtataatgctcaaggctctaggctgagtagcaggagcaacttttaatttattatgagcccaaacaatggattcaataagttcttgccaataaccacgcccgctgaatagaaacattaaactgaaagcccatacaaaatgagcacctaggaaaaaaagaccatatgcagataacgaagaaccataagactgaattacctgagatgcttgtgcccataagaaatcgcggagccacccattaatagtaatggaactctgtgcaaagtttcctccagtaatatgagttaccaccccttgatcacttatactaccccaaacatctgactgcattttccaactgaaatggaatattactacggaaatagcattgtacatccagaatagtcctaagaagacatgatcccaagcagatacttgacatgttcctcctcttcccggcccatcacaagggaaacgaaaaccaagatttgctttatctggtattaaacgcgagctacgagcaaatagaacacctttcaacagtatcaataccgtcacatgaattgtaaatgcatgaatatgatgtaccaaaaaatctgccgttcctaatggaataggtaacaaagctactttgccacccactgctactaactcaccgcccccccaagtcaaactggtgctcgctgtttcaccaggggctgttacaccaggtgctaaagcatgggtattttgtatccattgagcaaagactggttgtaattgtatagcagtatctgaaaacatatcttgtggacgccctaaagcactcatggtatcattatgaatatacaaaccaaaactgtggaagcctagaaatatacatacccagttgagatgtgatatgattgcatcgcgatgcctcaggacacgatctaataaatcgttatatcgattagttggatcatagtctcttaccataaaaatggctgcatgcgcagcagcaccaactatgagaaatccaccaatccacatgtgatgtgtgaacaatgacagttgtgtagcatagtcagtagctagatatggataagggggcatggaatacatatggtgagctacaataatggttaaagagcctaacatagctaggttaagagataattgagcatgccatgatgttgttagaatttcatataggcctttatggccttggcctgtaaatggacctttatgagcctctaaaatatcttttataccatgaccaataccccagttggtcctatacatatgacccgcgattagaaaaagaattgcgatagctaaatgatgatgtgctatatcggttaaccatagacccccagtcactggatctaatccgccacgaaaagtaagaaattccgagtattttgaccaatttaaggtaaaaaagggagttgctccttcagcaaaacttggataaagttgagccaaaagatcccgattcaagataaattcatgaggaagcggtatttctttaggatctactccagcgtttagaaattggttaatcggtaaagatacatgtacttgatgtcctgcccaagaaagggacccaagtcctagtagccctgctaaatggtgattcaacatagattctacatcttggaaccaagccaattttggagctgctttgtgataatggaaccaaccagcaaaaagcattaaggctgcgaagaccaatgcgccaattgcggtacaataaagttgtaattcactagttattccggatgctcgccaaatctgaaaaaagcctgaggttatttgtattcctcggaagcctccgcccacatctccattcaggatttcttggcccactattggccaaaccacctgagcactaggtccaatgtgagtaggatcactcagccatgcttcataattggaaaaacgagcaccatggaaatacatgccactcagccaaagaaagatgatagagagttggccgaaatgggcactaaatacttttcgagagatttcctccaaatcactggtatgactatcaaaatcgtgagcatcagcatgtaggttccagatccaagtggtagtatcaggtcccttagctattgttcttgagaaatgaccgggtttagcccattcctcgaaagaagtttttatgggatccctatctaccaaaattttgacttctggttccggcgaacgaataatcattgagtcctcctctttccggacaacacatacaaagaaacccgccaacagtcactcaagtaattagtgaaccgatgatagatacttagaatttttttttctttctcttctatcttccatctattcatctattttctttagttattcactagagcaattatgatctggaagtcgatctggggcaagtgttcggatctattatgacatatccatagggtgctcaacggacccttttttataattaaaaaaagttttagcgcctttacattggtacacaaagagctttttttataacctaatcgagtgtattcatatttcaattattaagttccgaaatgtagcctattttttttatagataatattatcctatttcaataaatgcttattagtcattactaagaaaaagtctagtattgatatttagtcattttgaaatatcttttattggttttagttttaatagtagaaaataacaaatagaaaaaactaaatatatagatattctcatattcatgtactacttacccctagagactaccagataaaatagaacgatttgagaaaaggatataatgaaatttttgtcttttattggttcttctaatagaaacaaggatctgttttatttgaccgagaggaccaagaaaccaaaaaacaattaattataaaaacaaatagcaaatattatagaatagaataaaaaaaaaaagaaacaaagggaaagttcttattcgaagcgcctcgtgatcgtcaaccaattctgtgcttcaatataattaccaggagtaagcgttatagcctgtttccaatactcagcggcttgagcgaaccaagcctccgccatttcagaatctccttgttgaatggcctgttctccacggtcggaataggcggatcaattccctccctgagaaccgtacttgagagtttcctacctcatacggctcgacaaccaactcttttgttttggtgtaccagttttttaactttaacctactttgaactttatatctaattgaatgtctaattgaatgagatttcttatagattttttgtttttcttggattaaacaaaagagagtaattacatgagtttcaaactttcattttgatttaattaatatattaattaatataataagttttatcttttctcctaccttcagaaaaaaaagcatgtccactgttattagatattagaattttctgaaaggtaactatcccgctttcatataaaaatttatatagaatctttgaaaaagactttttcatacttcataaaaaagaaaaagacttactgtctttaggatctgatgctacaccgctgctcaataccttcggggattactctattacataagtagattcctaagatttatctcatattatgatataaataaacagctcttgttgtgtcggtccaaaacctttccaattgatctttacggtgcttcctctatcaattaaatctttttttatccatagaaaagaaagtatttaggcatatctagtcttcacttcatatttcgatggatgaagtttagttatttgctacagctgataaaaatcgttttaggcgatgcttatgtagaaagccctttttttgtgtttctagtattttattgactagcgttcgttctttttttctatagtggagatagtcgcacgtaatgacagatcacagccatattattaaaagcttgtggtaaaaaggggtttcgttctaatgcccgaaaataatattctaaagctttggtatgttccccattacttgtatggataaggcctatattatagagtatataacttcgatcataggggtcaatttctagtcgcatagcttcataataattctgtaatgcttccgcataatttccttcagattgagccgacatccgttacggtcgtcattcgctttaacgaactctccgtttcagaaccgtatgtgagattttcatctcatacggctcctcctttaggtgcataatgaaaataatatatgtaaaaatgtgatgtcattatgaactaagcggggctaatgtttttacaagaaatccctagccaaccttcttgcaaaagatcttttcttactaccaagtgggttcatgctagataaaaataaaaaaggaaactctaaaaatttctttgttctcaacgcccctaagtttccaggaattagtcacttcaacagtcttcaatggttatacgggtatccaaaatacgaacgagatggatgtttattgttccaaccattttaattagtcccaatcccaacgaagaagaagaaagggaatcatttttaagaaagttttcgtgttgttgatttctcggcgtagtgcttcttcccctatgcctcctattcgtatattgtattagtgtagtaggattgatctgtaatacgggaaccataggtaaaaaccttttgctcaatactataattcacaattgaagcatctaaggctgcattaatcgtggatacatgacagaagggattgttttttttatattataaacttcaccttcaaaagcgtagattttttttcaatactcgtttttctttctattccaatcaaaatcggcgagaaaaaaaataatgataatcaaatcgcaccatctctgtaataagtaaatgcctctttttctccggaagttgtcggaatgactcgtaataagatatcggctacaattgtaaaggttttatcaataaaatttccatttatacgcgatcttggcataggtagtaatccattctctaactctttttatttcctttaccttttcttttgtgagaaaattttctcacaaacaaaggaattgtatagtacgaactaacataaaagcggactcattaaaaaaaaccttctatctacttccaaattttccggtcaaaaagggtatctattaaccataatctaaaaaacgatgaataactcgctattcacccagatactcagtcataatcttgatgtcggagagatggccgagtggttgaaggcgtaacattggaactgttatgtagacttttgtttaccgagggttcgaatccctctctttccgtactttcaacaaattcaccaatcttacgtgattgaccacaatgtatcaaatccaataaaaaagaatcgatataagatctaccttgttttgattttgaaatagattctctattcctaatttctttcatatggaaaatgctgggaagagcaaacaagggatcccaatctccctaccaatctatgatacatgaataggaaaaatattctttgacaaaatcccttaccttgtgcctttttatttttaatggaaaaggggagttgtccgaactcttgtttttagtaatttttttttttacttaagttaggtttattaagtctgtcgagagtaatattctacgacaagcaattcatttattttcaaaccgacgcatttcctatctattatttgattgactaacccttcatattggaatgtgtgaagagtcagatggtttggcaattcctcaggggcagatgaatcaagaagattttgaaccaaagttctagagttttgttcatccttcactgtaataatatctcggggtttgcagcgataacttggtatatcaactatacgaccattaactaaaatatgtccatgattaactaattggcgcgcttgaggaatagtcaaagccatacccaatcgaaaaaggatgttatccaaacgcatttcaagtaattgtagtaaaacttgacctgttgaccccttggcttttccggctatacgcacatatttaagtaattggtgttctgtaagaccataatgaaaacgcaatttttgtttttcttctaaacgaatacgatattgagatttttttacggagcgtgattggtttctaagatcgcttcctgccttaggccttttactagttagtcccggtaaagcccccagacggcgtatttttttaaaacgaggccctcggtaacgtgacataaagactccttttttgattgaaattgtacaaaactaaataaaattaaaactgaactaaatgataatgataaatgacgtgaaatacactccactattggaatacaaagagtaagaagatatattctctcaatatacagattttttttattgtatatacaatatatataaatcaactaaatcacaaaaattttcctttattttcttgattaattttgcaaagatcaaactcttttacccaatatatattcctaatatggaagtttatatgacataatataaatggagtggtaactcttggaaaaaggtcaaagaagtcttttcaatcttctttgattttgaaagtacattaaaaatcatgtaaaaaaaaacgaaaaaatatggaaaagccggctatcggaatcgaaccgatgaccatcgcattacaaatgcgatgctctaacctctgagctaagcgggctcaaataaaatagcgcatgcatacaaattcactaaactactagatcgtatcaattaactattctattaatatttttccttatctagttagaattaatgatattctatatattctagaacagaatatagctcacataaatagtgactatcattcatcattaaataaataaaacataaccttaattctatatatatatctatatagtcatagaatagtatagaattattagaatttcaaatttacgaagtagacttataatttttttccattgcacattgtagaattctaagtttcaataataataataataaatttcttttcatgaaagtaaaaaaaaaaaaaagaatcgaccgttcgactatttctgaaaatttaagccaaagatgaaaaaaaaaagaacatatatatgttatgtaatatataaccatattgaattgcaaatacaaaaatgatagaatctttgttgattagactaaatcaatatggatggagctcaaaaaaataaaagaagataacaaagacataaaataagtatctataatgtaatgaatcccgaggtttcggcataagaaaaaaaaggaaagacatcataatgagatcctaaaaaaggggatatggcggaattggtagacgctacggacttaattggattgagccttggtatggaaacctactaagtgataactttcaaattcagagaaaccctggaattaacaatgggcaatcctgagccaaatcctggtttacgcgaacaaaccggagtttacaaagcgcgaaaaaagggataggtgcagagactcaatggaagctgttctaacaaatggagttcactaccttgtgttcataaaggaatccttcgatcgaaacttcaaatcaaaaaggatgaaggataaaaacctatattgtataaatttaggtaacacaaaacgatctcaaaaatgacgacctgaatctcgatttctatttttttataaacaaaatcaaaatgttgtgaatcaattcgaagtttaagaaataatatttcttgattaaaataaaattattcacttcatagtctgatagatccttgatggaacttaattaatcggacgagaataaagatagagtcccattttacatgtcaatactgacaacaatgaaatttatagtaagatgaaaatccgttgacttttaaaatcgtgagggttcaagtccctctatccccagctctactccccgaaaaggttgacaccttacctttttttcgttattatttatttgaattatttataatctatatcatttttcattttcaaacttagaaagtcttcttttatttataaaatccaagaaattcccggtccacaactttttgaatttactacttttgagtttcttttcattgacatagacctaagtcatatattaaaatgatactgatacttcagtagattatacttcggtaatggtacacatagcttaattgcgggggactgaaaatccttgtgtcaccattagtaaaagcaagatgatccttcggtaatggtcgacatagcttagttgcagaggactgaaaatccttatgtcaccattagtagaggactgaaaatccttatgtcaccattagtaaaagcaagatgatacttcagtagatgatacctcagtaatggtcggcatagcttaattgcgggggacttaaaatccctgtgtcacatgataatgatccttcagtaaaggtagacatagcttttttgcagaggactcgaaatcctcgtgtcaccattaggaaaacgagcatgatacttcagtagatgatacttgatacttcagtagactaatggtggacatagcttttttccgggggacttgaaatcgttgtgccaccattcgtaaaacgaggatgatccttcgccgggatagctcagttggtagagcagaggactgaaaatcctcgtgtcaccagttcaaatctggttcttggcagaggatttattaattttgataagtttttattcttcaaattaaacgtatctttagtaaaaaaagtgcaattatgctttatcccctctcttttttttgttcatgttgtgaatccagccgttcaaaaagaatgtataatacttgatacataatacatatccgaaaggaaaggttaaatgagttccgttgaatcaaacaagtaaaaaaaggtctatatgtatagtatactatagttgaagggcaaaaataccccaaggttcattagatacaatagaaatagaattgtatcccccccttcatttattgctttccgatcttatttattcattcccagttatgtgactaaagttgactaagttatgtgcgcgatacaaagttcataatgcagaactctttttttttagttcatcctattggctcattttttatcattcaataagcatcttgtatttcataaaaattgggggcaatataatccttacgtaaaggccaccctatccaactctcgggcattaggatccgtttcagtcgtggatggctatcataagtgattcctaacatatcataagattcccgttcttgaaaatccgtacttttccaaacccagaaaacggatggaattctaggattactcctgtgagtaaatacttttatgcagacttcttccgcttgattaacaccatattctattctcgtaagatgatacacgctggctaagaggccacctggtgccacatcataggcacattgcgaacgtaaataattgtaaccatatacatataaaattacagcaatagaatgccaatcttcgggctttatttgtaaagtctctattccttgataatcgaagcccaacgatctatgaaccagcccgcgtttggctagccaaacggacaaagtgccctgcatcttttttatttcccccacaccttttttatataaaattaagtatttcacatttaccgttaattctaatttatgaagatttttttctgattctctaaaagcctccctaattcactaattcgtgggacgatactggacttttgtatttaaaaaatgtttcagtagagatctctgaagtagatgatggtggatagagtagttcttgatcataatttccaatatgcggactgcgtacaacaaaaaacttgtgattggtagtaaaacaccgattaccctgttgaggtctaattcgatccttatagatttctctagctattttcttacgaagctttgttatagcgtctataacagcctctggtttaggtggacaacccggcaaatagacatctacaggaattagcttatcaactcctcgaacagtactataagaatcggtactgaacatcccccctgtaattgtacaggctcccatagcaataacatacttcggttcaggcatttgttcatataatcgcactaaagaaggagccattttcattgttactgtacctgctgttaaaataaggtccgcctgtctaggactcgatcttggtactaacccataacgatcaaagtcaaatcgggagcctattaatgaggcaaattcaatgaaacaacaactggtaccataaagaagcggccataggctggaaagtcttgaccaatttgaaagatcatttaacgtagttgaaataacggaattttttgttgttcgatcaagtatgggaaacttaatggaattcataattgtttcaatggttttttttactttttttttttttattattgtatcaagtattcggtaaacgaactaagaccattccaatgctccttttcgccatgcataaactaaaccaagaattaggataagcacgaaaatgaaagcttctataaaagcagatacccccagtacatcgaaactcattgcccacggatacagaaaaacagtttcaacatcaaaaacaacaaaaactagagcaaacatataataacggattctaaattgtaaccaagcatccccgatcggttctatacctgattcataactagaaagtttctccggccccttcctaattggagataaaactccggaaattagaaatgccaaaacaggaatagcacttgatattagtaaaaatgcccagaaaatatcatattcgtaaagcagaaacatagacgaactcctatgaatgtggaaaaaatacccgcttagtcaattccaatcggagtggattgggcaagggatatagaactcttgagtcaaaacaaaaattcaggttaatcgaatcattttttttcgtttggttgttgtggtagacgtctcgttttaagatttattgatttcttattttcagtacacttattacttaatagttccatgtttctattactaatagtttctaatataataatataatattaatctgattaataactagtaattttttttatttctgtttatgtttaaaaaaatttttcgaaaaatctcttcgttttttaaatgatgacgtatcaaaaaatccagtaagactttaccatactcatcttacttagtattagatagattgaattttggttgaatttaattagatttctttttttatttttaaacaaggccgtgtgataaaaaaagtaaccaagattgagtggggatacaaaaaaaaaaagaaagtattatgaactttttgattgtagctagtgaacgaggaaaattcatataaaaaaattacaactatgaaaattaatgaagaaaaaggtttattctaaattataaattaagtatctatctcgatatatcgatagatagtgattggctccattgaaataaaatgaaattttccgttttattctgaacgatccccaggacttatggtttatgatatggaaattttttttatgaaccgagcaattaaaagtaacctgttagaaataaagaatacaaaaaaaagtaaaaaaatttatccaattattttgattttaatgtgattttttagaataaatttcttagttagggctatacggactcgaaccgtagacctgctcggtaaaagagttcgaacttattattatcaaaatgattcgaactctttcaaagacccaacatgcatttttttttgcattgggctctttcattaactgatcgaaagatcagttagtctaccatattttttcttaaaaaaaagataagaaatggttccaagtactctgattgattatttttgaattctaatacaatacagaagaactaccaaagtgtttcaaagaagggttctcttgacgtaggtttgcttttggtctagatcaacttaagttaaatatagtctctaacatcctgattaaaaaatcaaacatgaaacttgatacaccttaaggttcataggacgaaaagatcatttttgagttccttatactcattctacctagcattgagtagactgggtattcaccctatcaatatctcaaatcaatgatgggttctattcattccctacctaacggggtactttaataggacctaatgtcaggctgttgttctcctcttttttcctaaaaaaaagtcatggagtaagacatcgatttcttaataagatcaatcaattagtttgattgcgtgatggactcctctgaaaaactttggcgcacgtgtaaacgaggtgctctacctaactgagctatagcccttgtgtttgtgatacacattttatcttatcatgtagataatttcttgtcaagattaatattacatgatcgaacattatatctctttgatctcattgtttattggtattgcttagaaataatattggatttataatcctatcgatgtgataggtatcccctttccttctctttacaatgataaataacctacttaactcagtggttagagtattgctttcatacggcaggagtcattggttcaaatccaatagtaggtataacttattagacaccatgatcaatggtgtctaataagtttttgtaaccagctttttttattttattgtttttatcgtctttcgatcctattttttttatacattctttttttttacacgtcagctagttacaaaatcaaatcgtattgagagcctcgactcgtgtccgagctcgtctgagagctagattagcctcaattgtctgtctcttaccttcagcttttctcaagttagcttctgctatttcaagagtttgctgagcttcttgtggatcaatgtcactattcttctctgcatcatttactaaaatagtgatttcattattgcctattctagcaaaaccgcccatcagagccatcgttaaccattggttagcaaggcgtattttcaaaatacctatatcaacagctgtggcaatcggcgcgtggtttgctaatacaccaatttgtccactattagtagataaaatgatttcttttacttctgaatcccaaacaattcgattcggagtcagtacacaaagatttaaggtcatttcttcaatttactctccatttctaagttcgtagccttcgcagtagcttcatcgatgttacccactaagtaaaaggcctgttcgggaagagaatcaaattctccggaaaggatcaaattaaaccctctaattgtttccgctagaccaacatattttcccggagaacctgtaaatacttctgctacgaaaaagggttgtgataagaaacgctcaatttttcgtgctcttgctacggttaagcgatcctcttcggataattcatccaaccccaggatagctataatgtcctgaagctccttgtaacgttgtaaagtttgttttacttgttgcgcagtttcataatgttcctcgccaacgattcgaggttgtagcatagttgacgttgaatctaaaggatctaccgctggatagatacctttggcagctaatcctcttgatagtacggtagtcgcatctaaatgtgcaaatgtggtggcaggtgcggggtcagtcaaatcatctgcaggtacataaactgcttgaatagaggttatggacccctttttcgtagaagtaattctttcttgtaaagtacccatttcggtactaagggtgggttgataacccacagcagaaggcattctacccaataaggcggatacctcggatcctgcttgtacgaaacggaagatattgtcgataaatagaagtacgtcttgctcattaacatctcggaaatattctgccatagttaaggcagtcagaccaactctcatacgagctcctggcggttcattcatctgaccataaactagggccactttggattccgcaagattttgttcattaatgactccagattctttcatttccatgtaaagatcatttccttcacgagtccgttcgcctactccaccaaatacggatacaccaccatgagctttagcaatgttgttgatcaattccataattagtactgttttacccacgccagccccaccgaatagtccaatttttcccccacgacgataaggggccaaaagatctactactttaattcctgtttcaaaaatcgataattttgtatctaattctataaaagcaggcgcggatttatggataggagatgttgtgcgagtatcgacaggacctaaattatcaacgggttccccaagcacgttgaaaattcgtcctagagtcgctccgccgactggaacacttagaggatttcccatatcaaccacgtccattcctctctttaaaccctctgtcgcactcatagctacagctctaactcgattatttcctaataattgctgtacttcacaagtcacattaatttcttgaccaagagtatctcgacccttaaccaccagagcattgtaaatattaggcattttgcccggggggaaggctacatccagtaccggaccaatgatttgggcgatacgtcccaggttttttttttcacgtatcgaaacctctggatttgaagtagtaggatttgttctcataataaaaaaaatatgttaaattttgttacgaattttttcgaatacagaaaaaatcttcgatagcaaattaatcggttaattcaataaaaagtgggagtaagcactcgatttcgttggtcccacccaagcggatgtggaattcaattttttattcattcaatgaaggaatagtcattttcaagctcaactaactgaaacctagttttaaaataaaaaatatatgaataaaaaaattttttgcggaaagtcttttatttttttatcataataggaataggcaagcctttgttttatctagcgaattcgaaacggaactttagttatgattcattatttcgatctcattagccttttttttcgtattttcattttagcatatccggttatgcgtcccatttattcatccctttagcaacccccccttgtttttcattttcatggatgaattccgcatattgtcatatctaggatttacatatacaacagatattactgtcaagagtgattttattaatattttaattttaatattaaatatttggatttataaaaagtcaaagattcaaaacttgaaaaagaagtattaggttgcgctatacatatgaaagaatatacaataatgatgtatttggcgaatcaaatatcatggtctaataaagaataattctgattagttgataattttgtgaaagattcctgtgaaaaaggttaattaaatctattcctaatttatgtcgagtagaccttgttgttttgttttattgcaagaattctaaattcatgacttgtagggagggacttatgtcaccacaaacagagactaaagcaagtgttgggttcaaagctggtgttaaagagtataaattgacttactatactcctgaatatgaaaccaaggatactgatatcttggcagcattccgagtaactcctcaacctggagttccacctgaagaagcaggggctgcggtagctgctgaatcttctactggtacatggacaactgtgtggaccgatgggcttaccagccttgatcgttacaaaggacgatgctaccacatcgagcccgttccaggagaagaaactcaatttattgcgtatgtagcttatcccttagacctttttgaagaaggttcggttactaacatgtttacctcgattgtgggtaatgtatttgggttcaaagccctggctgctctacgtctagaggatctgcgaatccctcctgcttatactaaaactttccaaggaccacctcatggtatccaagttgaaagagataaattgaacaagtatggacgtcccctattaggatgtactattaaaccaaaattggggttatccgcgaaaaactatggtagagcagtttatgaatgtctacgtggtggacttgattttaccaaagatgatgagaatgtgaactcccaaccatttatgcgttggagagaccgtttcttattttgtgccgaagctatttataaatcacaggctgaaacaggtgaaatcaaagggcattatttgaatgctactgcgggtacatgcgaagaaatgatcaaaagagctgtatttgccagagaattgggagttcctatcgtaatgcatgactacttaacagggggattcaccgcaaatactagtttgtctcattattgccgagataatggcctacttcttcacatccaccgtgcaatgcacgctgttattgatagacagaagaatcatggtatgcacttccgtgtactagctaaagctttacgtctatctggtggagatcatattcacgcgggtacagtagtaggtaaacttgaaggagacagggagtcaactttgggctttgttgatttactgcgcgatgattatgttgaaaaagatcgaagccgcggtatctttttcactcaagattgggtctcactacctggtgttctgcctgtggcttcagggggtattcacgtttggcatatgcctgctttgaccgagatctttggagatgattctgtactacaattcggtggaggaactttaggccacccttggggaaatgcaccgggtgccgtagccaaccgagtagctctggaagcatgtgtacaagctcgtaatgagggacgtgatcttgcagtcgagggtaatgaaattatccgtgaagcttgcaaatggagtcctgaactagctgctgcttgtgaagtatggaaagagatcacatttaacttcccaaccatcgataaattagatggccaagagtagatgaattagatttagtaattcacgtttgttttattagtttaattgcactcggctcaatcttttttttactaaaaaagattgagccgaggttatctgttgtatatactattttttttgatagatacatacttaaatttagatagaaaaaaaactcttcaataaaaaaaagaagattaaacacaactacaattttgttattgtagtgttgtgtccacaagaaatcctatacgaaacatggattcttaattcttaggagtgttatattctttcgtgtcagggcttgaaccaagtatccccgcttcttctaccccatcctgcatgttgtccttttcttttcattccgtattggaataaaaaaagtttttttttatattagtatacgagattttactaaaaaagttcttaatattcttatattcataagcgaagaacaaatatttcttttttttttatgagaattttacacaatataagaaaatccttcttttcatttagaattaaaattgattcatttcaattactttacttaataatcttagcaattgcatcgatatgttttgcttactctgaatagaaaatgaactattcaaaaaaattttgcatttttcaattttttcattgaatgactattcatctattgttattgtattttcatttaaatagaggccagaagctctatggaaaaatcgtggttcaattttatgttttctaagggagaattggaatacagaggtgagctaagtaaagcaatggatagttttgctcctggtgaaaagactactataagtcaagaccgttttatatatgatatggataaaaacttttatggttgggatgagcgttctagttattcttctagttattccaataatgttgatcttttagttagctccaaggacattcgcaatttcatatcggatgacaccttttttgttagggatagtaataagaatagttattctatattttttgataaaaaaaaaaaaatttttgagattgacaatgattttagtgacctagaaaaatttttttatagttattgtagttctagttatctaaataatagatctaaaggtgacaacgatctgcactatgatccttacattaaggatactaaatataattgtactaatcacattaatagttgcattgattcttattttcgttcttacatctgtattgataataactttttaatcgatagtaataattttaatgaaagttacatttataatttcatttgtagtgaaagcggaaagattcgtgaaagtaaaaattacaagataagaactaataggaatcgtagtaatttaataagttctaaggatttcgatataactcaaaactacaatcaattgtggattcaatgcgacaattgttatggattaatgtataagaaagtcaaaatgaatgtttgtgaacaatgtggacattatttgaaaatgagtagttcagaaagaatcgagctttcgattgatccgggtacttggaatcctatggatgaagacatggtctctgcggatcccattaaatttcattcgaaggaggaaccttataaaaaccgtattgactctgcgcaaaaaactacaggattgactgacgctgttcaaacaggtacaggtcaactaaacggtattccggtagcccttggggttatggattttcggtttatggggggtagtatgggatccgtagtaggcgaaaaaataactcgtttgatcgagtatgctaccaatcaatgtttacctcttattttagtgtgttcttccggaggagcacgaatgcaagaaggaagtttaagtttgatgcaaatggctaaaatttcttcggttttatgtgattatcaatcaagtaaaaagttattctatatatcaattcttacatctcctactaccggtggagtgacagctagttttggtatgttgggggatatcattattgccgaaccctatgcctatattgcatttgcgggtaaaagagtaattgaacaaacattgaaaaaagccgtgcctgaaggttcacaagcggctgaatctttattacgtaagggcttattggatgcaattgtaccacgtaatcttttaaaaggtgttctgagcgagttatttcagctccatgctttttttcctttgaacacaaattaaataaaatagaacggttagtttatcagaattaaacgaaaacccagaaaaatgcatttttctttcaaatcatttttttttatcgatattcttgtttactactcagtaaacctctatcaacaagctaaaaagtgaatttttttgggggggaagttcaaattagactagacaaacaaaaaaaagttcattttcctcccttgcttgcatatgtatagataattcaaatatagatagatgcagatctatagagagtcttccatctttttgcatttcccgaaaattccctgttgttagatcagattctaatttctaatcaattttgtagaaatttgtaatggaagaaaaatttttctttattaatgactattaactattataagatattaagacaaaaagaataataaatctaacaaggggattatgatacatctagttgtagttgattttgaaagatgaataagtccatttatttagtttggctttttttgtacctatttttttattctatttctatttctattcggttctattctatatatttctattaggttgtatattaatattagatatatatttacttaaagatacttagtataattatataatagatataatagaaataataaaaatacaagatattctaagatatctttagaattcagaatataacaataacaggtacaaatattaaattgaggtacccattttatgacaactttcaataacttaccctctatttttgtgcctttagtaggcctagtctttccggcaattgcaatggcttctttatttcttcatattcaaaaaaataagattttttagatcggctgagaccgaatcatatcacctttttttttttattttaaaaacttcgattcgataagacccatttggtagaatgttgtataacacatagattcctacaaacataaataaaaaaaactcttatgcatgtgtaaacgtaaaaaaatttgcgctcttttgaaaaatggatcatcgtcgggccgatgtctgaaattccagtcaatctatttatttgtatgtatataactataggggatcatataaaggaaggagatgttatttttttagatataaacaattctatgaattactcctaaggtaaaggttcacaacaaaatagtttatattataagagttactttgaaaacaaaaaaaaggaaagtcatattttctcaattccaaaaaattgtataactggatctaatatatatgagttggcgatcagaatctatatggatagaatttataacggggtctcgaaaaacaagtaatttctgctgggcctttatcctatttttaggttcattaggattcttattggttggaacttccagttatcttggtagaaatgttatatcgttatttccgtcccagcaaatcattttttttccacaagggattgtgatgtctttctatgggatcgcaggtctctttattagttgctatttgtggtgcactattttgtggaatgtgggtagtggttatgatcttttcgaccgaaaagaaggaatagtgcgtatttttcgttggggatttcctggaaaaagtcgtcgcatctttttacgattctttatgaaagatattcagtccatcagaatagaagttaaagagggtgtttctgcccggcgtgtcctttatatggaaattcgaggtcaaggggctattcctttaattcgtactgatgagaattttactacacgagaaattgagcaaaaagctgctgaattggcttacttcttgcgtgtaccaattgaagtattttgaaatgaattaattaaatgctttggcagtaggaagaaaaaacgaaagaatttctttcttttttttttcaattgaatattcatctcttcttttatgctcgtttttttgatatatttgatagaaaagaaaaggagtttatttgtctcgaaattagtattgatcgaaaaaggggggaataacatcccggaaaccccattttttcttgattcaagttggaagtgtattctgagtctgtttctgtattctttctagattcaaagcaaagactcagtattgaatcaacagcaaaagataaaatggattcataggctcactatattctattcgaattagaatagaaacacatgctcgatagaaatattagatctaatagaatcaacaaatgaggtaggttcattaacaactcacagattcaaaatggcaaaaaagaaagcattcattccttttttttattttctatctatagtctttttgccctggttgatctctctctgctgtaataaaagtttgaaaacttggattactaattggtggaatactagacaatgcgaaacttttttgaatgatattcaagaaaaaagttttctagaaaaattcatacaattagaggaactattccagctcgatgaaatgataaaggaatacccagaaaccaatttacaacaatttcgtctaggaatccacaaagaaacgatccaattcatcaagatacacaatgagtataatatccatacaatcttgcacttctcgacaaatctaatatctttcgttattctaagtggttattccttttggggtaaggaaaagctttttattctgaattcttgggttcaagaattcctatataatttaagtgatacaattaaagctttttcgattcttttattaactgatttatgtatcggattccattcgcctcacggttgggaactaatgattggttatatttacaaagattttgggtttgctcattatgagcaaattttatctggtctagtttctacctttccagtaattcttgatacaatttttaaatattggatttttcgttatttaaatcgtgtatctccgtcacttgtagtgatttatcatgcaataaacgactaaaaaaagattcactgatccaattttaatctttcgtaccttatacatcataaccaaatcaaagtcgtatttactttactttttttacccatgagggattccttgtatatttcaacaaaaaaaatttgatttttttcagtaaatgtaaatagcagaattgtggctagggaagtatattatcgacctagctaactttattgtagaaattttcgggataaatgattggaccatgcaaactagaaataccttttcttggataagggaagagattactcgctccatatctgtctcactcataatatatataataacttgggcatccatttcaagtgcatatccgatttttgcccagcagaattatgaaaatccacgagaggcgactgggcgtattgtatgtgccaattgccatttagctaataagcccgtggatattgaggttccacaaacggtacttcctgatactgtatttgaagcagttgttaaaattccttatgatatgcaactaaaacaagttctagctaatggtaaaaaaggggctttgaatgtgggagctgttcttattttaccggagggttttgaattagccccccccgatcgtatttcacccgagatgaaagaaaagataggaaatctttcttttcagaattatcgtcccaataaaaaaaatattcttgtgataggtcctgttcctggtcaaaaatatagtgaaataacctttcctattcttgctccagaccctgctactaataaagatgttcacttcttaaaatatcctatatatgtaggtggaaacaggggaaggggtcagatttatcctgatggtagcaaaagtaacaatacagtttataatgctacggcaggagggataataagtaaaattttacgaaaagaaaaggggggatacgaaataaccatagtggatgcatcgaatggacgcgaagttattgatattatccctcgaggcctagaacttcttgtttcagagggcgaatccattaaactcgatcaaccattaacgagtaatcctaatgtgggtggatttggtcagggggatgcggaaatagtacttcaagatccattacgtgtccaaggtcttttgttcttcttaggatcggttgttttggcacaaatctttttggttcttaaaaagaaacagtttgagaaggttcaattatccgaaatgaatttttagatctgtctatttagctttatcaaattcgtaaaaaagaacaaaaaattatgaaaaccttttgcctctctttagatttgctattccttttcgactagatgtcaggaattacttatatcatagtcctaatactagtatgtatattgagaagaattcactttacccccctttatttatttttcaataaaaatttgaaaaatgagaaggggtgtgatgtaactctgtcgttattgaccaattgaaattgatagaatgtatcaataatcaagagtttttttctagtcaaatggcaaaatttgactagatactaaaataagataaggaacacacgcgccgaaaaaaaggggaaccataaatcggcgaaacaacaagttttagggactatagggagtattttttgtcttgctagtcttcgacacaagaaaaggaattttagacatccttttcttgtgtcgatcttgtccttcttgattcaattcgttaaaaactcctattcttagtttacatatatatatatatattatagtagttactttttgtagttttctttttttttttttcaattttgatgaaatactaaataaataaaatcagaaaaaacttctatttcgattctattatagtatagaccaaattttaaattttaatgatagatctaatgataaaaactattgtgtcagccggggaagcaggaaaagggaatgaagtgattccccttttttattctatctttgaaagattaaaaaatactatatgttcataatatactaatttagttaagttcatttttcaaaaacacgataaaaaattgttctgattattagcagttcaacgggaccccctcgaatcagacaaagaaggaagagttgggccccgttgagttcttatgttttcacgtctataactcagctcatccaatttctacagggatgaacctaatcctgaatatgaaccataaaagaaaatacctattaaaccgatcacaagaataccagctacagtacctattacccaaagaggaatccttccagtagtatcagccatttatcccgcttccctccacatttaatcgagtggtcatgctagaaacataaacagtcagagataattattatatataatccatccgaatgggataataaaattactactctttattttttattttattattctacgctcttttcttaattgaagaaataattcgaaaataaaacagcaagtacaaaaatgagtaataacccccaatagagactggtacgatttaattcaacactttgttcgttcggatttgattgtgtcatagctctataattgaattaggtttatcgttggatgaactgcattgctgatattgaccccaaaaaagaaacggtaggtacagctagtccatgaacagccaaccagcgcactgtaaaaattggataggtcctatctatagtcattgggtcctcctaaaaagatctactaaattcatcgagttgttccaaaggatcaaaacggcctgttattaatggaatgccttgtcggctctctgtaaaatactcgtttggacgagggctcccgaacacatcgtaagctaaaccggtgctgacgaataaccagcccgcaatgaatagggaaggtatagtaatgctatgaatgacccagtatcgaatactggtaataatatcagcaaaagaacgttctcctgtgcttccagacatactgaactccagatattctcgtagggaatcgattctgtaaaagatgaataagtaaattaaaattcactgagattgcatctttgtgagatcgtcaataaagtaccaagggtatttttagagtctaccgaatcagtatagctatccttcttctgacacagcaacgcaatttgaattagtatagaaatggggtgttacataatttctttttttcttgcttgtcgatgtataaccgtgtcccactttttcaaattactgtaatctataggggctttgatcctttattcgttttggactagaaaataaactaaagattagataaaatgaaaatccaagaagttggtttctaattctaataattcatgaagcaaattttcatatggtcccaagttaattgaatgaaaaatttataaatttcattttcattgcatatgcataattgtagaatagatttttttatgataatgtgatccccccttttactttttgtttcattttaaggaattaatttgcagaaacaagaaaaagaacaatagttttggattggattggatcaattaaaaagaacaacaaataaaaataataaaaaaagactaaatatttgtaatgcgtgcattgttttgttgtattcaattcacaattcaaaggtttttttctttctttaactaactacaagggtgatgggtttttcactctattttctatataatctcgaaagaaaaaaacctaaaacctcgaaaggaaacgataatagaaattgctaattacaagttttaaaaatctagttatcgtttaaaatctagttaaaataaataaatctttttttttactaatctcgttctccgtgtaggatacctcttttctttttagtctcattcgatagattaaatgaagaaaactgctctactatttaatttaatctaatgagtttaaattttagtaaattcaattttaataaagtagaaagaggcgtattctaggttctaaggtcaataaaaaaaaagaatcaaacaacttattttcaaatttttacatattcattcaaaaaaagttatatgttttgactgaagttagataatagagttattttttttatgtattatttttttttatgattaatttcttaaagagtttttcaattaataagttacgttaattctgactcctgagatagtgcagatgccaaagacgatgaattgagttctttttatctttctctattttttttcataccacctataatgattgataattcacaaattttcaattgaatttttttaattcttggaactagttatctttctctatttcttaaaaaaaatttcaattgaaacttagggaagtactttaagaaacatatgtataaaaaaacatattttattgagtcccttcatgcctactataactagttatttcggttttctactagcagctttaactataacctcagttctgtttattggtctaagcaaaatacgacttatttgaaattaattgaatgcagatttttttataaaaaaggatttcgttggtatttattaatatgttcgatagttccttaccgtgttaattaccaaattttggtcattgagattcattggcaatacagattaagagctaggaatagatagtacctctcttttctccctttcaaaaatgaaaacaaaagaaaattcaaatgattgaagtttttttatttggaatcgtcttaggtctaattcctattactttggctggattattcgtaactgcttatttacaatacagacgtggtgatcagttggacttttaattaattaacatctcgtttttttactaacctccttcttgctttcctatgcgggaggtctaattcagactgctgctcagtaatttgtgaacagtggaattttgatacaatctatgaaatcacgctctgtaggatttgaacctacgacattgggttttggagacccacgttctaccgaactgaactaagagcgtttttctttttttttttttctaaaaaacgaaaaggctagaaagagggcattctttaacccgactcgattttgtacgtatatactatatcatacatagtatatcataaatttcagaattaaatgtatgtccgataaaaaaaattgatcaaaatagatacctcgttactgctcttctgagcagtaataggtagggatgacaggatttgaacccgtgacattttgtacccaaaacaaacgcgctaccaagctgcgctacatccctttcaataggtttacagtgtcattgtagagaattcctgtcttgttttccacatcctccttcttttttattggtatatcaaattcatttcttctttttttctcatatcagataacaaagatataattaaaaaatttacttttttttttttttttattctctcaattttacataaataggcctttacgttttcaaatggaatcgataagatcgttctagtcgacaatattaaaattctaattttgaaagcggggggacggaagttacatatacaaatacaagaacttcttaattacatgtacatctgtaattatatatattactatatataatgtaatacaataaagaagaaagaaggaggatttctaatgcgagatctaaaaacatatctttccgtagcaccggtactaagtactctatggttcggttcgttagcaggtttattaatagagattaatcgtttatttccagatgcattaacatttccctttttttcattctagttattaacatcagaaaggggtgaaaaatttagagatacaatcaacaatcggggactaacccccccaccttttctaattagtagaataaattagaaaaggtgggggggggggggaaaggtcataaaaacgagggttcaggatccaatgaaattagtaatagaacgaaaaaaagtgttgctagggaacctatcagatacttaaaaaaactactgtacaaagattttaaatatagttttcacaaaatcataaatcattgtattacttattttttttatttaattactaataaataaaatattaattgtaacgaaatatttcagaattttttttagttaacagcttctattttttttgttcttgttctttctggatcctaaaattaaaatagaagattgaggtgaatcataaatccaaaggaggtttcatggccaagggtaaagatgttcgagtaacaattattttggaatgtaccagttgtgttcgaaatgatattaagaaagaagccgcgggaatttccagatatattactcaaaagaatcggcataacacccctagtcgattggaattgagaaaattctgtccctattgttataaacatacaattcacggggaaatcaagaaatagatcaaattgagtgcttgtatgtcaacttttattttaagaacaggaataatgctagtatctatatattattacatatatataaatataaacaaataaatcaatagaaagaaatctaatccgatattcttaattctatatagaaattctatcctatatagaaatagaaatcgtttttattttgatccgatcaaaataggattttagagataaggaataaaaataaaaattatgaataaatctaagcgactttttactaaatccaagcgatcttttcgtaggcgtttgcccccgatccaatcgggggatcgaattgattatagaaacatgagtttaattagtcgatttattagtgaacaaggaaaaatattatctagacgggtgaatagagtgactttaaaacaacaacgattaatcactattgctataaaacaagctcgtattttatctttgttaccttttcttaataatcagaaacaatttgaaagaagtgagtcgactcctagaactactagtcttagaaccagaaaaaaatagacttatttttcaattgaataacaattccaatctgaaggaattaaaaaagagattaatgttttgttcaaaaaatccaatcaagaataaaaatttgattgttacgtctgtgtctattataaaaaaaaaaagaaaagaatcgtcgaaaagcataactcgttttttcgaaactatatactctcgttttgttttgacgactttttttttaatactaatttctactctaccttccccgagctcattctccttagaactctatttcaaatattttcgtggatttcttccaatccccttatttttttatgtcattcgaaattgtataaagacaactcctatttaatagagctatttgtgcaagtattttccgattaagaagtaattgcttcttgtatagattgtgtatgaattcattataactatagaatacccccatttcgtgaattacggcatttattcgagtgatccataaacggcgaaaatctctttttcttttacccctatcccgatgagccgaaactaaagctcttattctctgttgagtcatagttcgtgtaagccgtgaatgagcccctcgaaagcttgatgcaaataaacgaagttttgttctacgcctccgagctatatatccgcgtttaattctagtcattgaataaatcaaactttgatgaataactaattctttttttagttattcttttcccctttactagtctattaataaccaaacgaattattccaatgtataaaaaaaattccaatggcttttgctactctaaccttccccaccactattttttgctaggtattttcctttactttgaaaggccttgatataaaaaaatagaataactacaaaacgtagtaaatagaattggataaatagtgggttccatcgtttctatggttacttctaaaacggtgaggtcctctctatacaccggagctccttcttttaattaatcaatactattggtaacttgtacaattcacattctttggctctaccccatgaatattccagtaataggtctttcacaatgagatcccctttatacagtaacggtatttcattttgaaaattgattaggtcatttaccctgttagtccgttcttttctttcaagagtgaaatcttttttctaaaaaatggaatttcccccgcttaatggatactcatttgttatcattgggggttttctaaaaaatggagttgattggatttgcaccaatgtaaaccataagtttcagacacaatagagtatatgaacgatctatattttgtaaataatgaatcgagttcgtccattctattttattcataggtactgatccgtgatatttcaaaaagaatttcctttttatgtctcagtctatgatctaaacgagtcgcacatacacccgagtacatgttcctcgtcgctgagggcatccccgaagcgctggggatttcgtgacgtttcggattggctgtcttgtatttctaataagttgtttaatggttggcatacggaatcatataaataatgggctggtttagattagttctaaccggctaattctgaattacttctcttcaagattctcttcaatatttttttatttttatattgaagagaatattaaactaaacctttaatctaaaaagatataaaattctaaattgtagatttgcatgaaatcgctcctattttttattgaaccgctacaagatcaacaattccatgagcttgggcttctgttgctgacataaaaacatcccgttccatgtcttcggatataacccatataggtttgcccgttctttgtacataaacccttgtgatggtttcgcgaagtttaagtaattcttccgcttccaagataaattctcccgtttgtgcctcataaaacgaactagcgggttgatggatcattaccctgatgatataatagaaaaggtttttctatttcgcagaatgagacgggataacaaaaaaaaaaaaatagataaatttgaataaccgtacaggctttttttgtgcattgcatacggctccacaatggaattgacttttttgacctttccttaaatcatccaattaccatccttcttttttttgtaggagttaaaaaaatactatgatggttccgttgctttatatatcattgttttgattcgtcgatgattcagcaatcccaaagtgtctttttttttttttacggtgtgaaaacaaagtttgtgacgctgaaatgtgcccgaataggtaagatatcatttgaaaaacctcttccttatctcatactactctttcaatatataatcgaatttttttttaatctaaaaaatttcatattgaattcgaagtgccatgctattattacttaactaattcatatttcaaatggcgaaggcatagtatttttttctcgaaaataaaaaaactcattggcgccaagcgtgagggaatgctatacgtttggtaattgctcctccgactaggataaaggatgctattgaagcggccaatcccatgcatattgtctgtacatcgggtcgcacaaattgcatagtatcataaatagccattccagatattacccatccaccaggagagtttataaacaaataaagatctttggtatccttttctatactgagatatatcataagactaataagttgattcgagatttcggtatcaacctcttggcctaaaaaaaataatctttctcgataaagtcggttgattaggataattttttattccttaggagccgtacaggcaccttttggtgcatacggttcaataaaaattgtgaaaaaatcaatgtgttgattccaacctacccttttttcatagagggtttttctttctaacttataacggaagggcttgccccaaaagtaaaagaaattttgagttttggcgccttttattagatattaaaatcctctaaaaaaatgattgattcattgatatttttttttttcatcgagattcagttgaaatggcgatggttttttcttgttcctgaacgggcttcttcctttttttattccattttttaggtttatgctctaccccgagtaaaaggaaaaatttgcccgattttgatttgcacatataggacaaatgaaccaaataccgcgtctttttttactactccttcttttttttcaattcagttctttcacttgtcttctgtcaaatagtcaacaaattttgaattatattatatattatttgtatttgatttgagcaacagttttagatcgccctgtttcaattttttttatagagtttttatcataattttgcatataatagaagtagtaattataaaaatattatatattaattatcaattgggtttttgctaaacggagcctggatacttcattttattagtccgatcacgtaaaccataaaaaaattttgataatctaatatcaatctaaatactccctgcatttaattccactttattttttgcgcttcgcgttacaaatttttgataattcaatcaatctttttgagcgaaacagaggatatctcgatcgagggagaaaatggggaaatcccatatagcccgatatatctgacaagtcgcactatatgtcaacccaagatgtatctccttctccaggacttcgaaaaggtacttttggaacgccaataggcatgaaatgaaaaaaaaagagaatgaagttctctatttcactttgatgtggaaacgtaaaattggggtttcgttttttaatactattatccttttttcctactttattaatcatatttaaattaatgatatttaatacataagttgaataagctaaaataaaatataaaataaaagtaaagtaagagagaatgaataaaactaaaggaaattttttacgaacgggcttctgaatgatcaacaacaatagctatcttggttcatagaaaataggattaacccccattgcatattggtacttatcggatatagaatagatccgcttccctttttttctatgaattgaattgttccattattactaacagaatagaacaaatattaatcctttctccgaaataattacctaaaaagggggggtacgtagcatagttttttccaatgcaataaagttacatagtgtctatttttcgttgataaaggggtatttccatgggtttgccttggtatcgtgttcatactgttgtattgaatgatcccggtcgtttacttgctgttcatataatgcatactgctctagttgctggttgggctggttcgatggctctatatgaattagcagtttttgatccctccgaccccgttcttgatccaatgtggagacaaggtatgttcgttatacctttcatgactcgtttaggaataaccaattcttggggcggttggaatattacaggggggactataacgaatccgggtctttggagttacgaaggggtagccggagcacatatagtgttttctggtttgtgcttcttggcagctatttggcattgggtatattgggatctagaaattttttgtgatgaacgtacaggaaaaccttctttggatttgcccaagatttttggaattcatttatttctttcaggagtggcttgcttcggttttggcgcatttcatgtaacaggattatatggtcctggaatatgggtatccgacccttatggactaaccggaaaggtacaacccgtaaacccggcgtggggcgtggagggttttgacccttttgttccgggaggaatagcctctcatcatattgcagcagggacgttgggtatattagcgggcctattccatcttagtgttcgtccgcctcaacgtctatacaaaggattacgtatgggcaatattgaaaccgtcctttccagtagtattgctgctgtcttttttgcagcttttgttgttgctggaactatgtggtatggttctgcaactactcccatcgaattatttggtcctactcgttatcaatgggatcagggatactttcaacaagaaatatatcgaagagttagtgctggactggctgaaaatcaaagtttatcagaagcttgggcgaaaattcctgaaaaattagctttttatgattatattggtaataatccagcaaaaggggggttattccgagcgggttcaatggacaatggggatggaatagctgttggatggttaggccaccccgtctttagaaataaagaagggcgtgaactttttgtacgccgcatgcctactttttttgaaacttttccggtagttttggtagacggagacggaattgttagagctgacgtcccgtttagaagggcagaatcaaaatatagtgtcgaacaagtaggtgtaactgttgagttttatggtggtgaactcaatggagtgagttatagtgatcccgcaactgtgaaaaaatatgctagacgggctcaattgggtgagatttttgaattagatcgtgcgactttgaaatctgatggtgtttttcgtagcagcccaagaggttggtttacgtttggacatgcttcgtttgctctacttttcttctttggacacatttggcatggtgctagaaccctcttcagagatgtttttgctggtattgatccagatttggatgctcaagtggaattcggggcattccaaaaacttggagatccaactacaaaacgacaagcagtctgatgcaacattgctttttttcttctagtttctgtttgttattttatttaataggtagggtactgtaggaatctttatttaaatcgctgccgtttctttgactctttttctttctttatcctcccaagtaaacaaaacgtaaacaaaacaggtatgaaagctataattgtaaaccacgatcaaatttatggaagcattggtttatacatttctcttagtatccactttagggataatttttttcgctattttttttcgggaaccacctaaaatttcaactaaaaaatgaaataatttttcattatcttcattaacgtaatcagcctccaaatatttggaggctgattacgttaactagtccccgtgttcctcgaatggatctcttagttgttgagagggttgcccaaaggcagtatatagagcatacccagtaaaacttacaagtaacccagatataaagatggcgactagggttgctgtttccattattatagaattgaaagaccacaccggatctatgctaagatcatttatttacaacggaatggtatacaaagtcaacagatcgtaatgaatacaaaataagatttatggctacacaaactgttgaagatagttctagatctggtccaagaagcactactgtagggaagttattgaaaccattgaattccgaatatggtaaagtagctcccggatggggaacgacccctttgatgggtgttgcaatggctctatttgcggtattcctatctattattttggagatttataattcttctgttctactggatggaatttcagtgaattagactgagaagaatcttgaagttctagcttttagctcgatacaaaaaagtaaagtatgcaggtctaacaattttagcctattctcctttggtagttcgaccgcgaaatttttttctgcattgtatatttccggaatatgagtgtgtgacttgttagaattgaccctatggatagtacagagaatggggtctgtcatctttatcaagatggttttacttcgtcggatattcattcgagtatctggagcacgaaatagatcaaatagatcacaaagtattcgaactatgattcatacttaaatactcaaacctcgtagccggacttctttccgttctatcttataaactttaataaatcaaaaaaattttctgcttttaaactcttatttggatcaaaggacaaacgcttctttgtattttatgtttttagtcattatagctttttttttattgaataagtgatgatccaatggttctcactcagtgaactttggactttgaaggtttcattaaattatcgtggttctcgtatgaatctgaggtttcaattgattagttaagtagggtcttaacaagagaattcctatcaataataaagaaaacaagaagaaatccctgtccccgttccatacaaataccaaataaaaaaagacaataaagataggtaatctagaagattcaagaggcctgtaacgatcaacacaacataaagacgaatgagcttacttgattttttggcatttaaccacaaagacgagctttcgcattttgactctttcatatctttaaataataaaaaataatattgaatgagagacaagtttaaaactttatattccatatctgtttcaatcagtatttgggtctttttttgtttgagctgtacgagatgaaattctcatatacagttcttggagggggagtaaccttggtttacctatctcaataaagtttatgattggttcgaagaacgtcttgagattcaggcgattgcagatgatataactagtaaatatgttcctccgcatgtcaacatattttattgtctaggcggaattacccttacttgttttttagtacaagtagctacgggatttgctatgactttttattaccgtccaaccgttactgaagcttttgcttctgttcaatatataatgactgaagctaactttggttggttaatccgatcagttcatcgatggtcggcaagtatgatggtcctaatgatgatcctgcacgtatttcgtgtatacctcaccggtggttttaaaaaacctcgcgaattaacttgggttactggtgtggttctgggtgtattgaccgcatcttttggtgtaacaggttattctttaccttgggatcaaattggttattgggcggtcaaaattgtaacaggtgtacctgacgctattccggtaataggatcacctcttgtagaattattacgcggaagtgctagtgttggacaatccactttgactcgtttttatagtttacacacttttgtattacctcttcttacggccgtctttatgttaatgcatttcctaatgatacgtaagcaaggtatttctggtcccttataaataatatagattctaggtatttgtacttacttattacttggtgaaggaacgatagtattttattgctataaatatggattattaaaaaaataaaacatgtatttggatatttcccttcaactccacaatattttattatttttttgacataaaaagttgaagggaattctatgaagagataatggattatgggagtgtgtgacttgaactattgatcgggccgtgcagaaatattactttatctgctacattggaattcacaaccaaatgtgtctttgttccaaccactgtgtaagccccatacaggggataggctggttcacttgaagagaatcttttctatgatcgtacccgacgctgtcgtggatgagtgggctccgtaaaatccagtagattaagggatggaacaaaatcctgattatgtttttagttattttggactaaaaaaaaaaaagaaaataattattaatagtaatagtatgtaaatgcattcattttctctgcatcgactcgatttatgatactatcggagtgaatacaggatctaatgaagagtagagggtagactccattagtaacaagtaaatcctttgtatttgaaaaatctcgatataattgttgagattaaggacgaatttataaggtatgagacgacccagaaagcacttaatcatgataaactttttaagcttacgtgggtgttgagcatttacctgtaagaatggaatttcttgaatctttagttgcaataactttggaatcggataattaatttttacatattaaattatattttttgtatgtattcatttagtttggttaattcttgctcgagccggatgataaaaaattatcatgtccggttccctcgggggatggatccataagaattcacctatcccaataacaaaaaaaccagatttgaatgatcctgtattacgagctaaattagctaaaggtatgggtcacaattattacggggaacccgcatggcccaacgaccttttatatatttttccagtagttattcttggtaccattgcctgtaacgtaggcttagcggttttagaaccatcaatgattggtgaacctgcggatccttttgcaactcctttggaaatattacctgaatggtatttctttcctgtatttcaaatacttcgtacagtgcctaacaaattattgggtgttcttttaatggtttcagtaccagcgggattattaaccgtaccctttttggaaaatgttaataagtttcaaaatccatttcgtcgtccagtagcgacaaccgtctttttgattggcaccgcggcggccctgtggttaggtattggagcaacattaccgattgataaatctctaactttaggtcttttttaattcaatttattcaattgtaaaataaacgacgtgggtatctagggaggtatctagggagtagtcatttccaaatgaattctccctagatacatatctaattctaattaatttaattaattaattaaaatgggttcgactggaaaatagaaattacgttgaaatttgaaaatccatttcaatttcaaattgactttttagtcttagtcaattttttttgaaatgttttttctattttttttctagaatgtctaatatcttttttacatcttctacgtgaaaatgttcaattttgataaggtcttcttgactgttattcaaaaggtccaataatgtatgtatattggattttttgagacaattgtagattctgggaggcaattctaattggtcaataaaaatatattgaaaggctagttcttttgttttttttttttttcttaggttaactaatcgattatgaaaaggaaaaaagggtaaagtaacttgatgttgattgttctctaaatagaacgtttcttcttctacatgtagaaaaggaataaataaattaatcaaattccgggaggcttgatgaagtgcttctttaggagttaaacttccatttgtccatatttctagaaaaagaatctcttgtttttcattcccattcccataagaatgaatactatgattggcattttcaacaggcatgaatacagcatcgataggataacttctgtcttcaaagttatttgacatttttagactatatccgcgattcctctcaatttttaattcaatacacaaatctattggttctgttaaggtagctatatgctgtgtattatcaatgatttccacagcgggcggtaaaataatgtctcgagcagttatatatccaggaccttggacacaaataagcgcgttgcgcgttccatatagattacttcttaatacaatctcgttcaaattcattaaaatttcatgtactgattcttgaatacctgctatgttagaatagtcatgtggtatgttctcagattttgcacgtgtaatacatgttccttctatttcgccaagtaaagctcttcgcatcgcaatgcctattgtgtcggcttggcctttcataagtggagacagaataaagcgtccataataaagacgcttactgtctctttttgattcaacacacttccactgtagtgtccgagtagatactttgactttctctcgaaccatagtaattttatttgatcagatcgttgaatcgtttatttctcttgaaacccttttagcctttttttagttctatacacgtctttttttagggggtctacaaccattatgtggcataggggttacatctcgtacgaaacttaaaagtataccgcttctacgaatagctcgtaatgccgcatctcttccgagtccagggccttttatccttacttcagctcgttgcataccttgatccactactgctcgaatagcatttcctgctgcggtttgggcagcaaagggtgttcctcttcttgtaccccggaatccacaagtacctgcggaggaccaagaaatcacccgaccccgtacatctgtaacggttacaatggtattgttgaaacttgcttgaacatgaataactccctttggtattctacgtacatttttacgtgaaccactacgtgtatttttacgcgaaccaattcttaatataggttttgccattttttttcatttcacaagaaatatatggatatatccatttcaggtcaaaatagacccttttttccaactctttggaagtgccttttcttttactttagttcctttagtaagattatccttgtctttgtttatgcctcgggttggaacaaattactataattcgtcccctcctgcggattagtcgacacttttcacaaattttacgaacggaagcccttattttcatagttgttattccttaattctgtgaatatatttattggtggacgaaaaaaaggtttcttgatatttttgaatcttgaattgtatcttcgtgaaaggaatggttgaaattgaaaaaacacttactcatttgaatacttattatggagtctagaaaatggctgtccccttattaacttatacttaagaacttactcaaaattttacctttttatcctataggtatacctatacaaaaatatgtcgaatcctttcagaagcatgaacgaaaaaaaatctttagtatctaaacaaaatcgaaccatgccgttcggaagtgattaagaaagaaaacttttattaattcattttttctttaatttcattcgaagtaaaacatccgaaacttttttgaacaggggtggtattacacaacccccttttttcacaaattgtaagttacagatatctaatttttatattagaaggattaccatatataacacaaaatttctccgccgattctttttagtcgagcttctcggtctgtcattataccttgagaagtcgaaaggattacaattcctattccgcctaaaattcgtggaattcgttgagagttagaatagattcgtagacccggtcgacttattctctttaaatttaaaatcgttttgtaggattctttcttatttcgtctatgtcttagggttaaaatcaaaaaatattggttgttttcgcgatgtttccttacgttttcgataaaaccctctcgtaaaaggattttaacaatactttccgtgatgttagtcgatcctatccgaaccgttccttttctattcatgtcagcatttcgtatagaggttattatatcagcaatggtgtctttccccatgataagttaaaattccttattgttctataattttgatataatcaacatgttctttttcttttatttatatatagatatagacgaattatatattaatatatgaattaaattcttaatattttattattaagggtatatgcgtgatacagaatctattaattaattttatttcaatacctgtttttttaatccgatactaactatcgctatcgatatttagatcttataatacctcaggagctaatgaaactattttagtaaagtttaattgtctcaattcccgtgggatcgccccaaaaactcgagttccttttggatttccttcttgatcaatgacaactgcggcattgtcatcatatcgtattatcgtcccattgttacgtttgagttctttacaagtacgtacaattacagctctaatcacttctgatctttctagaggagtatttggtattgcttctttgattacagcaacaataacgtcaccaatatgagcatatcggcgattactagctcctattattcgaatacacatcaattctctagccccgctgttgtctgctacattcaaataggtttgtggttgaatcatatcattttttttgtatctcttcttttaatgcaaaggacgaagtaaaaaaatattgtttgtcaaaaaaagaaaacttataatctttttacccttaaatgttatttagttttttcattatatattcctattcagaaataatgaattgggtttttataggcatttttgatgccgctattgaaatagcttttcttgctatattttcgggtacaccacccatttcataaaggattttacctggtttaaccacagctacccaatactcaggggatcctttcccagaacccatacgcgtttccgcaggtcttactgtaactggtttgtctggaaatatacgtacccaaatttttccaccacgtcgtacatttcgtgtcattgcgcgtcgccctgcttctatttgtctagatgtgatccaagcgggttcaagtgtttgaagagcatatctgccaaaacaaatacgattcccacgagaagatattccttttagtcttcctcgatgttgtttacgaaatctggttctttttgggttatagttgatggttctaaattagaaattccatctctactacagaactgaacgtgagagtttcttctcatccagctcctcgcgaataaaaggactaaaaaagcttgtattaagatatagttaatgattaattctattaatcatgatattcaatttcatctgatctcttctaaatttgtgtatgtctttttcgaaatggaatccaagattaattctatttatttaaaaataacgtaacgtaatatcatcatctcgaatgtcgtttttgttagaatattctaacaaatccttattttcttttatctttttaatttttgttttttattacttttattaaaaaaaaagtattcgccggcgaatatttactctttcaatatctatattaagtttgttgtttatcccaggagatctctgaataaaaataagaatagataataatctggtttattccgccatcctgtccaatgaattactaagatttatttttcaatagaatcctctatattcatgggttccgtcgttcccatcgcttcttgattaatcattaggcccgaattctacaatggagctcttatatgaaatcgggaatttcattttttttatttgtttttgagtcaattttcttagtttttattggctcaaggctcttaattttttttgttttcggaacagatttatctaattattctgaatgaatctgtattgatgctttattacattgcttttcttacagtgacctcatagactttccaaattggaataatatatcattaatattcaattttttctctctttctttcatccttccactgaatccgcatacttttcgattacctttcataacttataattatagttctttattctttttttttttcagttgctacaataatatgatcaatccatcatatcttgactgatttttttatccagataatgtgaagcaatgagttgcttaggttatttattaatgctatagttattagtttctgttataggtaagttcttttttcttttttttttatctttatctaatcctaaaccaacgagtcacacactaagcatagcaattatatcaaaggagttttgatggaaatttttattcaatcttatagaattgcttattttatttttaaacataaaaaagaagactgcaattttttattactgtctgtatcgtgttatataattttcgtttttttatcgtcggataaaatataaagataaagaaagtttttttattcttcgtctacgaatatccaaatttttattcctaaaaccccataaatagttcgaactgtataggaacaataatcaattttagcttcaattgtttgtaaaggaactctgccttctctgatccattcaacacgtgcaatttcttttccgtcgatacgtcctgcaatttgtacttgaattccttttgtattcgcctgttcagttaattcaatagcttttttcattgcttttcgaaaagaaacgcgattttttaattgtccagcgataaattctgcaagaatattaggatccccatacggattggaaattctggtaatagcaatgttgagttttctattgacacaatttagttctttttgaacattcatctgtaattcttcgactcttcggggtttatcttcaattaataatttaggaaatcccatatagattatgatctggatgagatcgattcttttttgaatttcaatacgtgcaattccctccataccagaggatattcttatatttttttggacataatttttaatacagtctcgtatttttttatcttcttctaaaccttcagaatacttttttggttgtgcaaaccaaagagaatgatgactttgggttgtaccaagtctgaaaccaagtggatttattttttgtcccataggcctccactactatatgtatcataacatgttagatttctgttttcattgctgcatccaggtttttttaaatacattaaatattcttcatattgttgatagaaggatatatcttccaatacgatagttatatgacaagtggatcgttttattgggtaacttcgtcctcgggcacgaggttttaattttttcacagtattcccttggttcacctcagctttactaatgactaaattggtttctttgaaacccttattgtgactagcgttcgctgcagcagaataaaccaatttaaaaatgggataacatcctcgataaggcataagttctaatatcataagtgcttcttcataggaacgtccacgtatttgatcaattactctccgtgctttatgggcagacatagatatatattgccctaaagcatatacttccgtatatgatttcttttttctcttctttatcataaggtttacctctcactcaaaaaaaatctatattcattttttttaatttatttaattaacgacgagatctattatcatttttggcatgtcctcgaaaatttatagtaggtgaaaattctcctaatttatgtcctaccataagatctattatataaacgggtaagtgttcccttccattatgaatagcgatcgtatggccaatcattgtgggtataatggtggatgcccgggaccaagttattatgatttctttttccgcctttgtattaagcttctctatttttcttaataaatgctttgctacaaaagggtttttttttagtgaacgtgtcacagttaattaactcctatttttttaagacgaagaaagaaattcgattttctctcctatttactacggcgacgaagaatcaaagtctcactatattttttcctttttctagttcttcttccaagtgcaggataaccccagggggttacgggtttttttctaccaattggagccctcccttcaccacctccatggggatggtcgacagggttcataactactcctcttactacaggacgtttacctagccaacatttcgatccggctctacccaaacttttctggtttaccccaacatttcccacttgtccgactgttgctgagcagtttttggatatcaaacggacctctccagaaggtaattttaatgtggccgatttcccctcttttgcaatcagtttcgctacagcacccgctgctctagctaattgtccaccccttccaagtgtgatttctatattatgtatggccgtgcctaagggcatatcggttgaagtagattcttctttttgatcaatcaaaaccccttcccaaactgtacaagcttcttccaaagcatacggctttctggatgtagatgatgatatctatacggatggatcttatatatatcgtagaattcttctatatatggtagaagtaccacacgagtggatatataggaatcaaaatctgccgaataacttatgttatgatcttctacatcctaggtcttcccgttccgtcatctggcttatgttcttcatgtagcattcagaccgaatgactctatgaaattacgtcgatacttccacatattatgggtaacgtaggagacatctctatttttccccgggggaatctttagaattaccactgcttagctttcaattcgcctctgaccatcaaatgaaatgtgaataacccgtcctcctctctttgaaacaaggggcgcttatggttctgtcggtgcttgaaacaattttgtcttctccatattactatatctctagagtcaataattttatatgaggaactactgaactcaatcacttgctgccgttactcttcagttttctgttgaggtctatcctgtagaggtactcaaattggatcagtgatcgatttctaggtttcgtcgtaaacctaattggttacttccaattacgtaaatcaaatagttcaaaccgcactcaaaggtagggcatttcccatttttataggaacttctgtaccagaaacaatggtatctccaattatagcccctctgggatgtaaaatatatctcttctcaccatccccatagtgtatgagacaaatgtatgcatttcgattagggtcgtattctatggttacgattctaccatatatgtcttttgcatttcgtcgaaaatctattttacggtatagacgcttatgacctccccctctatgccttgcggtaattattcctctggcattacgacctttaccacaatgatgctgcccacagatcaaattatttcgtggattggatttcacttgactgtctacggctccattgcgtgtgctcggggtagaagttttgtataaatgtatcgccatgctattaagtattttgatttaagttcttttctttctaagaggtggaatagaataacccggttgaagcgtaatgatcatacgtctgtaatgcattgtatgtcccagaataggtcccattcttttaacctttccggggagtcgatgactattcatagctattaccttgacaccaaagaagagttcgacccaatgctttatttctgtcctagttgatcctgattcgacattaaaagtatattgatttttccccaataaccgaatacttttgtctgtaaatactgcatatttgattccatccataaatcgattttcttccctatgagttctagtctcaataagaatgctagttcttactgttcatatgttatgatatgaatataccacaccaattcgttatgtatagatgatgagaagattccattgatacagagccaattccaatagacttattggagggtccgattggcgtgcatccagtaggaattgaacctacgaattcgccaattatgagttgggcgctttaaccattcagccatggatgcttagtggggatcctcgtacatggtgaataaccaaattccaattgaaatgaaatctttaggataaatcaatgcaatttaggaggaatcaatgaaaggacatcaattcaaatcctggattttcgaattgagagaaatagtgagagagatcaagaatgctcactatttcttagattcatggacccaattcaattcagtgggatctttcattcatatttttttccaccaagaacgttttagaaaactcttggaccctcggatttttagtatcctacttttgcgcaattcacagggttcaacaagcaatcgatatttcacgatcaagggtgtagtactatttgtagtagcggcccttctatatcgtattaacaatcgaaatatggtcgaaagcaaaaatctctatttgaaagggcttcttcctatacctatgaattccattggacccagaaatgatacatcggaagaatcttttgggtcttgcaatatcaataggttgattgtttcgctcctgtatcttacaaaaggaaaaaagatctctgagagctgtttccgggatccgaaagagagtacttgggttctcccaataactcaaaagtgtatcatgcctgaatctaactggagttcgcggtggtggaggaactggatcggaaaaaagaggggtttttgttgtaagatatctaatgaaaccgtcgctggaattgatatctcatttaaagagaaagatatcaaatatctggagtttctttttgtatattatatggatgatccgatccgcaagggccatgattgggaattgtttgatcgtctttctccgagtaagaggcgaaacataatcaacttgaattcgggacagctattcgaaatcttagtgaaagactggatttgttatctcatgtttgcttttcgtgaaaaaataccaattgaagtggagggtttctgcaaacaacaaggagctgggtcaactattcaatcaaatgatattgagcatgtttcccatctcttctcgagaaacaagtgggctatttctttgcaaaattgtgctcaatttcatatgtggcaattccaccaagatctcttcgttagttgggggaagaatccgcacgaatcggatttttttaggaaaatatcgagagagaattggatttggttagacaatgtgtggttggtaaacaaggatagattttttagcaaggtacgaaacgtatcgtcaaatattcaatatgattctacaagatctagtttcgttcaagtaacggattctagccaattgaacggatcttctgatcaattcatagatcctttcgattccattagtaatgaggattcggaatatcactatcacacattgatcaatcaaagagagattcaacaactaaaagaaagatcgattcttttggatccttcctttattcaaacggaaggaagagagatagaatcagaccgattccctaaatacctttctggctattcctcaatgccccggctattcacggaacgtgagaagcgaatgaataatcatctgcttccggaagaaagcgaagaatttcttgggaatcctacaagagccattcgttcttttttctctgacagatggtcagaacttcatctgggttcgaatcctactgagaggtccactagggatcagaaattgttgaagaaagaacaagatgtttcttttgtcccttccaggcgatcggaaaataaagaaatagttaatatattcaagataattacgtatttacaaaataccgtctcaattcatcctatttcatcagatctgggatgtgatatggttccgaaggatgaactggatatggacagttccaataagatttcattcttgaacaaaaatccattttttgatttatttcatctattccatgaacggaagagggggggatacacgttacgccacgagtcagaagagagatttcaagaaatggcagatctattcactctatcaataaccgagccggatctggtgtatcataagggatttgccttttctattgattcctacggattggatcaaagacaattcttgaaggaggttttcaacttcagggatgaatcaaaaaagaaatctttattggttctacctcctattttttatgaagaaaatgaatctttttatcgaaggctcagaaaaatttgggtccggatctcctgcgggaattatttggaagatcaaaaaagagtggtatttgctagcaacaacataatggaggcagtcaatcaatatagattgatccgaaatatgattcaaatccaattccaatatagtccctatgggtacataagaaatgtattgaatcgattctttttaatgaagagacctgatcgcaacttcgaatatggaattcaaagggatctaataggaaatgatactctgaatcatagaactataatgaaagatacgatcaaccaacatttatcgaatttgaaaaagagtcagaagaaatggttcgatcctcttatttttctttctcaaaccgagagatccataaatcgggatcctaatgcatatagatacaaatggtccaatgggagcaagaatttccaggagcatttggaacatttcgtttctgagcggaagagccgttttcaagtagtgttcgatcaattatgtattaatcaatattcgattgattggtctgaggttattgataaaaaagatttgtctaagtcacttcgtttctttttgtctaagttacttcgtttctttttgtccaagttacttctttttttgtccaagttacttctctttttgtctaactcacttccttttttctttgtgagtttcgagaatatccctattcataggtctgagatccacatctatgaattgaaaggtccgaacgatcaactctgcaatcagttgttagaatcaataggtcttcaaatcgttcatttgaaaaagttgaaaccctttttattggatgatcataatacttctcaaaaatcgaaattcttgatcaatggaggaacaatatcaccatttttgttcaataaaataccaaagtggatgattgactcattccatactagaaagaatcgcaggaaatcttttgataacacggattcagcctatttctcaatcgtatcccacgatcaagacaattggctgaatcccgtgaaaccatttcagagaagttcattgatatcttctttttctaaagcaaatcgacttcgattcttgaataatccacatcacttctgtttctattgtaacaaaagattccctttttatgtggaaaaggcccgtctcaataattctgattttacgtttacgtatggacaattcctcactatcttgttcattcacaacaaaacattttcttcgtgcggtggtaaaaaaaaacatgcttttttggagagagatactatttcaccttcgtcaatcgagtcacaggtatctaacatattcatatctaacgattttccacaaagtggtgacgaaaggtataacttgtacaaatctttccattttccaattcgatccgatccattagttcgtagagctatttactcgattgcagacatttctggaacacctctaatagagggacaaagagtcaattttgaaagaacgtattgtcaaactctttcagatatgaatctatccgattcagaagagaagagcttgcatcagtatctcaatttcaattcaaacatgggtttgattcacactccatgttctgagaaatatttacagaggaaaaaacggagtctttgcctaaaaaaatgcgttgacaaagggcagatggatagaacctttcaacgagatagtgctttttcaactctctcaaaatggaatctattccaaacatatatgccatggttctttacttcgacagggtacaaatatctaaatttgatatttttagatactttttcagacctattgcggatactaagtagcagtcaaaaatttgtatccatttttcatgatattatgcatggattagatatatcatggcgaattcttcagaaaaaattgtgtcttccacaaaggaatctgataagtgagatttcgagtaagtctttacataatcttcttctgtccgaagaaatgattcatcgaaataatgagtcatcattgatatcgacacatctgagatcgccaaatgttcgtgaggtcctctattcaatccttttccttcttcttgttgctggatatatcgttcgtacacatcttctctttgtttcccgagcctatagtgagttacagacagagttcgaaaagatcaaatctttgatgattccatcatacatgattgagttgcgaaaacttctggataggtatcctacatctgaactgaattctttctggttaaagaatctttttctagttgctctggaacaattaggagattgtctagaagaaatacggggttctggcggcaacatgctatggggtggtgatcccgcttatggggtcaaatcaatacgttctaagaagaaagatttgaaaataaatttcatcgatatcatcgatctcataagtatcataccaaatcccatcaatcgaatcactttttcgagaaatacgagacatctaagtcatacaagtaaagagatctattcattgataagaaaaagaaaaaacgtgagcggtgattggattgatgataaaatagaatcctgggtcgcgaacagtgattcgattgatgataaagaaagagaattcttggttcagttctccaccttaagggcagaaaaaaggattgatcaaattctattgagtctgactcatagtgatcatttatcaaagaatgactctggttatcaaatgattgaacaaccgggaacaatttacttacgatacttagttgacattcataaaaagtatctaatgaattatgagttcaatacatcctgtttagcagaaagacggatattccttgctcattatcagacaatcacttattcacaaacttcgtgtggggctaatagttttcatttcccgtctcatggaaaacccttttcgctccgcttagccctatccccctctaggagtattttagtgataggttctataggaactggacgatcctatttggtcaaatacctagcgacaaactcctatgttcctttcattacagtatttctgaacaagttcctggataacaagccgaaaggtttttttattgatgatatcgatattgatgatagtgacgatattgatgctagtaacgatattgatcgtgaacttgatacggagctggagcttctaactatgatgaatgcgctaactatggatatgatgttggaaatagaccgattttatatcacccttcaattcgaattagcaaaagcaatgtctccttgcataatatggattccaaacattcatgatcttgatgtgaatgagtcgagttacttagccctcggtctattggtgaactctctctccagggattgtgaaagatgttccactagaaatattcttgttattgcttcgactcatattccccaaaaagtggatcccgctctaatagccccgaataaattaaatacatgcattaaaatacgaaggcttcttattccacaacaacgaaagcactttttcactctttcctatactaggggatttcacttggaaaagaaaatgttccatactaatggattcgagtctataaccatgggttccagtgcacgagatcttgtagcacttaccaatgaggccctatcaattagtattacacagaagaaatcaattatagacactaatacaattagatctgctcttcatagacaaacttgggatttgcgatcccaggtaagatcggttcaggatcatgggatccttttctatcagataggaagggctgttgcacaaaatgtacttataagtaattgccccatagatcctatatctatctatatgaagaagaaatcatgtaacgaaggggattcttatttgtacaaatggtacttcgagcttggaacgagcatgaagaaattcacgatacttctttatcttttgagttgttctgccggatcggtcgctcaagacctttggtctctacccgtacccgatgaaaaaaataggatcacttcttatggattcgttgagaatgattcggatctagttcatggcctattagaagtgcaaggcgctttggtgggatcctcacggacagaaaaagattgcagtcagtttgataatgatcgagtgacattgctttttcgctccgaaccaagggatcccttatatatgatgcaagatggatcttgttctatcgttgatcagagatttctctatgaaaaatacgaatcggagtttgaagaaggggaaggagaaggagtcctcgacccgcaacagatagaggaggatttattcaatcacatagtttgggctcctagaatatggcgccctcggggctttctatttgattgtatcgaaaggcctaatgaattgggatttccctattcggccgggtcatttcggggcaagcggatcatttatgatgaaaagtatgagcttcaagagaatgattcggagttcttgcagagcggaaccatgcagtaccagagacgagataggtcttccaaagaacaaggcttttttagaataagccaattcatttgggaccccgcagatccactctttttcctattcaaagatcaaccctttgtctctgtgttttcacatcgagaattctttgcagatgaagagatgtcaaaggggcttcttacttcccaaacggatcctcctacatctatatataaacgctggtttatcaagaatacgcaagaaaagcacttcgaattgttgattcagcgccagagatggcttagaaccaatagttcattatctaatggatttttccgttctaatactcgatccgagagttatcagtatttatcaaatctgttcatatctaacggaacgctattggatcgaatgacaaagacattgttgaaaaaaagatggcttttctcggatgaaatgaaaataggattcatgtaatgtaacaggagaagggtttcccattacttagccggaaagatatgtggccatgaaatagggattaagtggaacggaattgactgggtggtagagttgtataaacacctgtttcttccacttagctccatggaacaatatgctactactgaaacatggaagaattgaaatcttagatcaaaacactatgtatggatggtatgaactgcctaaacaagaattcttgaacagcgaacaaccggagctattactcactacatcaaaaaaatttccattaataaaagatggaaatccattggaaaatcaaaaatacgcatgtcggattaaattgttgttgctatctgttccaataacgaatcaactgaataactaaataaaatagatagacctttctcttcgtctcaggtcgatagatcttctcaattggaagatcccctatatggataagacacattccagttgaccgagcctaattctaattgttttgttccgaagtaaagatatccacggagtggttcgccctattcagatattcacgaccaagaagtactggattctctttaggataggtcctgaaaggagaaggaaggctggaatgccgccaggcgtctattattgaattcacccgacccgatagtaccaattttggtaacgtccatccagtgccaaagtcactgaatgggtaagtcaccaatccctaaaacggactatgtaatgtacttgaatctgccgggttacggggggctttttaccagaggtttagattgtatcaatctacccttgtgtgattcctgttgaatcatatactgcggggcgcagggcggacgatttcaaagcggactccccctccccattcattagatagagaagatcgccaatatttcgcgatccgctgccgaacttattccatttcaatattatgccttgaagaggactcgaacctccacgctctttagcacgagattttgagtctcgcgtgtctaccatttcaccaccaaggcatcttcaaagtgaatcgtattccataaatatgatatctatctagtaaggtattgaatatatgacaaaagtggagtgttgaagtatttctattgatcggtcatgtcatataggcccgagtcggacatctaattgcttagatttgaattatccggaggatgccttatatatatattaatatatattatatcaaaaagatggacaatcaaatctatttctcgattcaatagaagtccaaccaaagaggtgaatagggtcccaaataacgagagatatgtaaaaagtaggtcagatttcgcctattcctaatcctaaatggaatgtaacgacgtagggatccctatgtaaacatagtatctatttagatacgctcgaatgaccccttctcataatgagaatgtatataaccttattccggtctggtccggtatggaatgaacttataatcatggaatcgactcgatcatcagattatagattataagttcataaccttagtccattcccattttgggcggaaccgatctactaattctttgattccagttagtattagtaagagggatcttgaactaagaaatagattctagaagctaaaaagggtatcctgagcaatcgcaataatcgggttcattgatattcctggtatagtagatgctatcacacatacaatcatactcaattcgatggaattgtttgatcttaaaggggatattctataatttcgcatgtgaggggttatttcttggtttcgtccagtcattaataacttgattatttttagataatagtagatagaaagaacgctcgtaaggagtcctattgaaaccaagaaatataggcctgcctgccatccacaccagaataaatggagttttccaaaaaaacctgctagtggaggaagacctcctagggataagagacatagagctaaagagagagccaaaaaaggatcttttgtgtataatcctgcataatctcgaatgttatcagttccggtacgtagaccaaataatataatgcaagcaaaagttcctagattcatggcgatatagaacagcatataagttatcatgctcgcatatccaccatttgagtctccaacaattattccaataattacatatccgatttgacctatggacgaatatgcaagcatacgtttcatgcttgtttgagtaatagcaatgagattcccgaatatcatgctaagaatagctaggatttccagaagaagatgccattcatttgatgagaaataaaaaggaatatcgaaaattcgagtggctgaagctgaagcagctactttcgaagtaacagaaagaaaagcaacgactggagtgggagagtcagagtcgaaaagaggattcctcacttctttctctcattcaaaaccgtgcatgagactttcatctcgcacggctcctaagtgataaaagtaaagaagaactcatcttctttcttttttgattactttcctcgcgtatgtataagatcgaatcctttctatttctaaaacggattactaatccttaacttttcgaggaatccttcatcagtggttgtgaatgactgatttttctcaatcttttcgaccttggttccgtaggagcacgtccgaaagattgagaaatggaaccatctgatttgattcgttctcaatagccatgagattatcatcttagggtgatccttttgtcgacggatgctcctattacactcgtagtctctgaaggatgagaaccaactatgtagcatctacatcgagaattcaagtctttcttgtatacgtcattagtccgatcctttgcaggaactacccgtaataacaaacttgcaaaatggatccgtttatcataaagagattcgttgttcctgaccctgcttcaccttaattgttatttgaacaagtcaaagttctgtcttggtctgcgtggggatagcatttctcttctgcatgtccatagagttttgaaaaatccaaacatctcagagatagatagagaggtaggaatttctcaaacgaaccgcactccttcgtatacgtcaggagtccattgatgagaaggggctagggaaagcttgaacccaattcctacagtgatgaatataagcgcaattgaaattcctggggagttatacatttgtgtattgataagaccattcactatttcttgaagctcaatctctcccccggatgaaccatatagccaagagaaaccatgaaccagaatagaagagcttgccccacccatgagtaaatatttcatagtagcctcattagatcgtatatctttcttggtatatccagataataggtaggagcataaactgaaacattctggagctacaaagatagttattaaatcgttagcaccacataaaaacattcctcctagagtagctgttaatatgaataacagaaactctgttatagccatttctgtacattcaatgtactctacggatagaggaatacagagagttgaacatagtaaaataagaaattgaaagatttcgttgaaattgttcgtttggaaatttcctgaaaagctaatcataggttcttctctccatcggaacaatagggccgttatgctcattacgaaacttgttgaagagatgaaatataaccaaggtatatctttttgatcagaggttgaatcgatcatcagaagaagaattaggccaaaaattaggatacattctgggaaaataaaacttccatcgaagagaagcaaatgaaaggctttcataaaaattctcgtagaatcgagaatgaaattttcattctgtacatgccagatcatgaattagtaactgcatccaatctccaaaaaaaaaccaatttttgatttttggaatggaatatttacggaatccccatgaataggataaaaccttattccatggtatttacatgagattgctctttcttattcttaagcaagtccccgagagggcttagttgatccatgatttctgtttcgtcttttctttccttttcgtttgtttcgagaaagagatcgatcaattccgattttttctttttctattgattcttttcggatcgagatgtatggatccatggatctatgtgtctatatagatcctgttcctggattaacgaaaatgtgcaaaagctctatttgcctctgccattctatgagtctcttcctttttgcgtatggcatcgccactccctttggcagcatccactaattcggaacttaatttgaaagccatatttcgacccggacgttttcgggatgcccctaataaccaacgaatggcaagtgcttttccttgcgtggatcctatttcaatgggaacttgatgagttgacccgcctacacgtcttgcttttactgctatatcgggagttactccacgtattgcttgacgtaaaacagatagtggatttgtttctgtcttttgttgaatctttttcaaggctcgatagataatttgataagccaatgatttttttccgtgtttcagaatacggttaaccaacatgttaactaatcgattacgataaattggatcggattttgcagttttttcttctgcagtacctcggcgtgacatgagcgtgaaaggggttcaagaatctgttttctttttataagggctcaaatcttttattttggctttttgaccccatattgtagggtggatctcgaaagatatgaaagatctccctccaaaccgtacatacgactttcatcgaatacggctttccacagaattatatatgtatctctgaaatcgagtatggaattctgtttactcacttttaaattgagtatccgtttccctccttttcctgctaggattggaaatcctgtattttacatatccatacgattgagtccttgggtttccgaaatagtgtaaaaataagtgcttcgaatcattgctatttgacccggacctgttctaaaaaagtcgaggcatttcgaattgtttgttgacacggacaaagtcagggaaaacctctgaaattatttcaatattgaaccttggacatataagagttccgaatcgaatctcttttgaaagaagatcttttgtctcgtggtagcctgctccagtccccttacgaaactttcgttattgggttagccatacacttcacatgtttctagcgattcacatggcatcatcaaatgatacaagtcttggataagaatctacaacgcactagaacgcccttgttgacgatcctttactccgacagcatctagggttcctcgaacaatgtgatatctcacaccgggtaaatccttaacccttccccctcttactaagactacagaatgttcttgtaaattatggccaataccaggtatataagcagtgatttcaaatcccgaggttaatcgtactctggcaactttacgtaaagcagagtttggttttttgggggtgatagtggaaaagttgacagataagtcacccttactgccactctacagaaccgtacatgagattttcacctcatacggctcctcgttcaattctttcgaagtcattgggtccctttcctcgttcgcgaatctcctcccttcttccactccgtcccgaagagtaactaggacaaactcggtcacgttttcatgttccaactgaacactttctatttttgattattctcaaaggataagattattctttttaccaaacatctgcgggtccaatcacacgatcttataataagaacaagagatctttctcaatcaatctctttgcccctcattcttcgagaatcagaaagagactttttcaagtttgaatttgttcatttggaatctgggttcttctacttcattttgatttacttattttttctttattttctctctcttttctttatttgatttcttttttgattttattcccttccatcattcttaagtcccataagtttgatcctatagaatctgacccattttctcattgagcgaaggggtacgaaataaattcaatcagatttatttttgatcaaaaaaaaaaaaaaaaatcactatgtgaaatcttcgtttttttttttctctttctctatcgctttcccataagtacagcacttgttgaatcgatagagaaccttttcttctgtatcgatatgaatccattatgaatcgatattattacattccaattccttaccaatatccctcaaggaaaatcccgaattggatcccaaattgacgggttagtgtgagcttatccatgcggttatgcactcttcgaataggaattcattttctgaaagattctggctttcgtgctttggcgggtctccgagatcctttcgacgacctatgttgtgttgaagggatatctagatgatccgatcaattgcgtaaagcccgcagtagcaacggaaccggggaaagtatacataagtatacagaaaagacagttcttttcttttctattatattaggattttctattctattagattagttagtgatcttggcgcagtgagtcctttcttccgtgattaactgttggcaccagtcctacattttgtctctgcggaccgagaagaaaggaggctccgcgggaagaggattgtaccatagaagcacggaggtaaacctctttccaatatataaattctggcaatgtagttgggctttcatgttgatccgaatgaatcatctttttcgcggagtgaaatctttgcctgctaggcaagatgataggatagcaagttacaaattctgtttcggtaggacatgtatttctattactatgaaattcataaataaaatagttaatcgtggggttaccattctctctttttttttttcgttatctcgcatgtggtcctaagaaaagggaatttgtcgatttttcggggtcttaaaggggcgtggaaacacataagaactcttgaatggaaatggaaaagagatgtaactccagttcctttggaaataggaagatctttggcgcaagaataaaggattaatccgtatcatcttgacttggttcttatttctctatttttttaagtttaagaaaagaataccgtttctcctacccgtatcgaatagaacatgccgagtcaaatcttcttcatgtaaaaccggcttgatttagatcgggagaatcgtacggttttatgaaaccatgtgctatggctcgaatccgtagtcaatcctatttccgataggagtagttgacaattgaatccaactttttccattattttcatttcatacccgtataaagtgcgaaaggaaagcccggctccaatccaagttgttcaagaatagtggccttgagtttctcgaccctttgacttaggattagtcagttctatttcttgatgggggaagggatataactcagcggtagagtgtcaccttgacgtggtggaagtcatcagttcgagcctgattatccctaaacccaatgaatgtgagtttttctattttgacttgctccctcgctgtgatcgaataagaatggataagaggctcgtgggattgacgtgagggggtaggggtagctatatttctgggagcgaactccatgcgaatatgaagcgcatggatacaagttatgacttggaatgaaagacaattccgaatcagctttgtctacgaagaaggaagctataagtaatgcaactatgaatctcatggagagttcgatcctggctcaggatgaacgctggcggcatgcttaacacatgcaagtcggacgggaagtggtgtttccagtggcggacgggtgagtaacgcgtaagaacctgcccttgggaggggaacaacagctggaaacggctgctaataccccgtaggctgaggagcaaaaggaggaatccgcccgaggaggggctcgcgtctgattagctagttggtgaggcaatagcttaccaaggcgatgatcagtagctggtccgagaggatgatcagccacactgggactgagacacggcccagactcctacgggaggcagcagtggggaattttccgcaatgggcgaaagcctgacggagcaatgccgcgtggaggtagaaggcctacgggtcctgaacttcttttcccagagaagaagcaatgacggtatctggggaataagcatcggctaactctgtgccagcagccgcggtaatacagaggatgcaagcgttatccggaatgattgggcgtaaagcgtctgtaggtggctttttaagtccgccgtcaaatcccagggctcaaccctggacaggcggtggaaactaccaagcttgagtacggtaggggcagagggaatttccggtggagcggtgaaatgcgtagagatcggaaagaacaccaacggcgaaagcactctgctgggccgacactgacactgagagacgaaagctaggggagcgaatgggattagataccccagtagtcctagccgtaaacgatggatactaggcgctgtgcgtatcgacccgtgcagtgctgtagctaacgcgttaagtatcccgcctggggagtacgttcgcaagaatgaaactcaaaggaattgacgggggcccgcacaagcggtggagcatgtggtttaattcgatgcaaagcgaagaaccttaccagggcttgacatgccgcgaatcctcttgaaagagaggggtgccttcgggaacgcggacacaggtggtgcatggctgtcgtcagctcgtgccgtaaggtgttgggttaagtcccgcaacgagcgcaaccctcgtgtttagttgccaccgttgagtttggaaccctgaacagactgccggtgataagccggaggaaggtgaggatgacgtcaagtcatcatgccccttatgccctgggcgacacacgtgctacaatggccgggacaaagggtcgcgatcccgcgagggtgagctaactccaaaaacccgtcctcagttcggattgcaggctgcaactcgcctgcatgaagccggaatcgctagtaatcgccggtcagccatacggcggtgaattcgttcccgggccttgtacacaccgcccgtcacactatgggagctggccatgcccgaagtcgttaccttaaccgcaaggaggggggtgccgaaggcagggctagtgactggagtgaagtcgtaacaaggtagccgtactggaaggtgcggctggatcacctccttttcagggagagctaatgcttcttgggtatttaggtttgacacagcttcacacccaaaaagaagggagctacgtctgagttaaacttggaggtggaagccttctttcgtttctcgacggtgaagtaagaccaaacccatgagcttattatcctaggtcggaacaagttgataggatccccttttacgcccccatgtccctctcgtgtggcggcagggaggcgtaaaaaggaaagagagagatggggtttctctcgcttttggcttggcatagcgggcccccagcaggaggcccgcacgacgggctattagctcagtggtagagcgcgcccctgataattgcgtcgttgtgcctgggctgtgagggctctcagccacatggatagttcaatgtgctcatcagcgcctgaccctgagatgtggatcatccaaggcacattagcatggcgtactcctcctgttcgaaccggggtttgaaaccaaacttctcctcaggaggatagatggggcgattcaggtgagatccaatgtagatccaactttctattcactcgtgggatccgggcggtccggaggggaccactatggctcctctcttctcgagaatccatacatcccttatcagtgtatggacagctatctctcgagcgcaggtttaggttcggcctcaatgggaaaataaaatggagcacctaacaacgtatcttcacagaccaagaactacgagatcacccctttcattctggggtgacggagggatcgtaccgttcgagcctttttttcatgttatctatctcttgactcgaaatgggagcaggtttgaaaaaggatcttagagtgtctagggttaggccagtagggtctcttaacgccctcttttttcttctcatcgaagttatttcacaaatacttcctatggtaaggaagagggggggaacaagcacacttggagagcgcagtacaacggagagttgtatgctgcgttcgggaaggatgaatcgctcccgaaaaggaatctattgattctctcccaattggttggaccataggtgcgatgatttacttcacgggcgaggtctctggttcaaatccaggatggcccagctgcgccaaggaaaagaatataagaaggatctgactccttcatgcatgctccacttggctcgggggatatagctcagttggtagagctccgctcttgcaattgggtcgttgcgattacgggttgggtgtctaattgtccaggcggtaatgatagtatcttgtacctgaaccggtggctcactttttctaagtaatggggaaaaggaccgaaacatgccactgaaagactctactgagacaaagatgggctgtcaagaacgtagaggaggtaggatggtcagttggtcagatctagtatggatcgtacatggacggtagttggagtcggcggctctcctagggttccctcgtctgggattgatccctggggaagaggatcaagttggcccttgcgaacagcttgatgcactatctcccttcaaccctttgagcgaaatgcggcaaaaggaaggaaaatccatggaccgaccccatcgtctccaccccgtaggaactacgagatcaccccaaggacgccttcggtatccaggggtcgcggaccgaccatagaaccctgttcaataagtggaatgcattagctgtccgctcgcaggttgggcagtaagggtcggagaagggcaatcactcattcttaaaaccagcattcgaaagagttggggcggaaaagggggggaaagctctccgttcctggttctcctgtagctggatcctctagaaccacaagaatccttagttggaatgggattccagctcatcaccttttgagattttgagaagagttgctctttggagagcacagtacgatgaaagttgtaagctgtgttcgggggggagttcttgtctatcgttggcctctatggtagaatcagtcaggggcctgataggcggtggtttaccctgtggcggatgtcagcggttcgagtccgcttatctccaactcgtgaacttagccgatacaaagctatatgatagcacccaatttttccgattcggcagttcgatctatgatttttcattcatggacgttgataagatctttccatttagcagcaccttaggatggcatagccttaaagttaagggcgaggttcaaacgaggaaaggcttacggtggatacctaggcacccagagacgaggaagggcgtagtaagcgacgaaatgcttcggggagttgaaaataagcgtagatccggagattcccgaataggttaaccttttgaactgctgctgaatccatgggcaggcaagagacaacctggcgaactgaaacatcttagtagccagaggaaaagaaagcaaaagcgattcccgtagtagcggcgagcgaaatgggagcagcctaaaccgtgaaaacggggttgtgggagagcaaaaaaagcgtcgtgctgctaggcgaagcggtggagtgccgcaccctagatggcgagagtccagtagccgaaagcatcactagcttatgctctgacccgagtagcatggggcacgtggaatcccgtgtgaatcagcaaggaccaccttgcaaggctaaatactcctgggtgaccgatagcgaagtagtaccgtgagggaagggtgaaaagaacccccatcggggagtgaaatagaacatgaaaccgtaagctcccaagcagtgggaggagccctgggctctgaccgcgtgcctgttgaagaatgagccggcgactcataggcagtggcttggttaagggaacccaccggagccgtagcgaaagcgagtcttcatagggcaattgtcactgcttatggacccgaacctgggtgatctatctatgaccaggatgaagcttgggtgaaactaagtggaggtccgaaccgactgatgttgaaaaatcagcggatgagttgtggttaggggtgaaatgccactcgaacccagagctagctggttctccccgaaatgcgttgaggcgcagcagttgactggacatctaggggtaaagcactgtttcggtgcgggccgcgagagcggtaccaaatcgaggcaaactctgaatactagatatgacctcaaaataactggggtcaaggtcggccagtgagacggtgggggataagcttcatcgtcgagagggaaacagcccggatcaccagctaaggcccctaaatgaccgctcagtgataaaggaggtaggggtgcagagacagccaggaggtttgcctagaagcagccacccttgaaagagtgcgtaatagctcactgatcgagcgctcttgcgccgaagatgaacggggctaagcgatctgccgaagctgtgggatgtcaaaatgcatcggtaggggagcgttccgccttagggggaagcaaccgcgcgagcggcggtggacgaagcggaagcgagaatgtcggcttgagtaacgcaaacattggtgagaatccaatgccccgaaaacccaagggttcctccgcaaggttcgtccacggagggtgagtcagggcctaagatcaggccgaaaggcgtagtcgatggacaacaggtgaatattcctgtactaccccttgttggtcccgagggacggaggaggctaggttagccgaaagatggttatcggttcaaggacgcaaggtgtccctgttttttcagggtaagaaggggtagagaaaatgccccgagccaatgttcgagtaccaggcgctacggcgctgaagtaacccatgctatactcccaggaaaagctcgaacgaccttcaacaaaagggtacctgtacccgaaaccgacacaggtgggtaggtagagaatacctaggggcgcgagacaactctctctaaggaactcggcaaaatagccccgtaacttcgggagaaggggtgcctcctcacaaagggggtcgcagtgaccaggcccgggcgactgtttaccaaaaacacaggtctccgcaaagtcgtaagaccatgtatgggggctgacgcctgcccagtgccggaaggttaaggaagttggtgacctgatgacaggggagccggcgaccgaagccccggtgaacggcggccgtaactataacggtcctaaggtagcgaaattccttgtcgggtaagttccgacccgcacgaaaggcgtaacgatctgggcactgtctcggagagaggctcggtgaaatagacatgtctgtgaagatgcggactacctgcacctggacagaaagaccctatgaagcttcactgttccctgggattggctttgggcttttcctgcgcagcttaggtggaaggcgaagaaggcccccttccgggggggcccgagccatcagtgagataccactctggaagagctagaattctaaccttgtgtcaggacctacgggccaagggacagtctcaggtagacagtttctatggggcgtaggcctcccaaaaggtaacggaggcgtgcaaaggtttcctcgggccggacggagattggccctcgagtgcaaaggcagaagggagcttgactgcaagacccacccgtcgagcagggacgaaagtcggccttagtgatccgacggtgccgagtggaagggccgtcgctcaacggataaaagttactctagggataacaggctgatcttccccaagagctcacatcgacgggaaggtttggcacctcgatgtcggctcttcgccacctggggctgtagtatgttccaagggttgggctgttcgcccattaaagcggtacgtgagctgggttcagaacgtcgtgagacagttcggtccatatccggtgtgggcgttagagcattgagaggacctttccctagtacgagaggaccgggaaggacgcacctctggtgtaccagttatcgtgcccacggtaaacgctgggtagccaagtgcggagcggataactgctgaaagcatctaagtagtaagcccaccccaagatgagtgctctcctattccgacttccccagagcctccggtagcacagccgagacagcaacgggttctccgcccctgcggggatggagtgacagaagttttgagaattcaagagaaggtcacggcgagacgagccgtttatcattacgataggtgtcaagtggaagtgcagtgatgtatgcagctgaggcatcctaacagaccggtagacttgaaccttgttcctacatgacctgatcaattcgatcaggcactcgccatctattttcatagttcaactctttgacaacacgaaaaaaccattgttcaactctttgacaacatgaaaaaacctaaaattctgcccttctatccaaaggatgggggggcagaggcctttggtgtccactccagtcaagaattggagcctcacaatcactagccaatatgcttttctcgcatgcctttcttcgttcatggttcgatattctggtgtcctaggcgtagaggaacaacaccaatccatcccgaacttggtggttaaactctactgcggtgacgatactgtaggggaggtcctgcggaaaaatagctcgacgccaggatgatgaaaagcttaacacctctcattcttattactttttcatattgaaaaaaaaaatgaaaaatgaaaaggttgtcttattcaaaaccccaattatgaaatcatcccacttcacaccccggaacgcaccgttcttatagagagaaaggcactttcacatccgaaatggctggggagaggaaaggttcctttttttagggtactcctgggaacagatccagtggagacggggtggggcttgtagctcagaggattagagcacgtggctacgaaccacggtgtcgggggttcgaatccctcctcgcccacaaccggcccaaaagggaaggacctttccctccgggggggtaggaaaatcatgctcgggatagcgatagcggactcaaagctatggaacttggggatgggtcttttgtcgaaatagagtggagtgaccttcttttttatttgaatttagatatatatctattatatctatcgcttttttaattttacatatagtatttttaaacggccgaatcagcatattttttgaagccccgtaactcttcctcagccaggcttgggcagaatagcggagcaagtattagtagcatagcaaaaatgcgttcctcatcattaagtcattaaattcatatgtttgctcgcggtaattgtgaactctcgggagaatcgatgactgcatcaaagatgcacttgttagtacatctgaaaattctgaattggctagttgtaaatagccccaggactatagaataaaggattatcccgaacctacaccgaggtattgacggtgattctcaaatatcacagaacagaatgtgatacgatgagatagaatgcaatagaaacaaagacacagggaacgggttaccgactcttaacggtcaaagcgaacccgttcattcttacattctgaattcttaaattcggaatgaatcaaatctccccaagtaggattcgaacctacgaccaatcagttaacagccgaccgctctaccactgagctactgaggaacaacgggagattagatctcatagagttcaattcccgttctcaacccatgaccaatatgaactcgaagtttccttcgtaacccccggaacttcttcgtagtggctccgttccatgcctaatttaatagggaacctcaaagcggctctatttcattatattccatccatatcccaattccattcatttaatatccctttggtgtcattgacataagagatgtcgtttctagtctatctctttctatttctatatatggaaagttgcaaaatcatcatataataatccagaaattgaaatagaaaagaaaaaagggaggtttgtgatggtttttcaatcttttatactaggtaatctagtatccttatgcatgaagataataaattcggtcgttgtggtcggactctattatggatttctgaccacattttccatagggccctcttatctcttccttctccgagctcgggttatggacgaaggagaagaaggaaccgagaagaaagtatcagcaacaacaggttttattgcgggacagctcatgatgttcatatcgatctattatgcgcctctgcatttagcattgggtagacctcatacaataactgtcctagctctaccgtatcttttgtttcatttcttctggaacaatcacaaacacttttttgattatggatctactaccagaaatgaaatgcgtaatcttcgcattcaatgtgtattcctgaataatctcatttttcaattattcaaccatttcattttaccaagttcaatgttagccagattagtcaacatttatatgtttcgatgcaacaacaagatgttatttgtaacaagtagttttgttggttggttaattggtcacattttattcatgaaatgggttggattggtattagtctggatacagcaaaataattctattaggtctaatgtagttattagatctaataagtataagttccttgtgtcagaattgagaaattctatggctcgaatctttagtattctcttatttattacctgtgtctactatttaggcagaataccatcacccatttttactaagaaacttaaaggaacctcagaaacgggtgggactaaacaggaccaagaggtatccaccgaagaagctccttttccttctcttttttcggaagaaggggaagatctggacaaaatcgatgaaatggaagaaatccgagtgaatggaaaagacaaaattaataaggatgatgaattccacgttcgaacatactataactataaaactgtttctgaaaatctatatggaaataaagaaaattcgaatttagaatttttcaaaataaaaaaaaaagaggatcattaaaaaaatcaatacataggacaaatataagaacagataagaagagatgcgacttccacctatatattttgttacttctcctacaaagaaacttgtaatacctactccatttgtaattccatcaatgattcgtttatcaaaaaaagtcgtttgttttgctaatcttcttatactttcaattaaagatgttttaaaaaaagaatctatgtaaccacgattatatgaccaattatatacaaaatttattagtttttcccaatgaattcgtttagaattccatttttgaaatgaattaagtaaggttaaatttaataaagatgaataaaaaggcttatataaacagtatgctataaatattccaaaaaaggctatactgaccgaaaaagttgcatttctcaaaaattcataccaatctacaaaattttgtgaatttttatgcaaaaggtttattgacggcgtgaaaaattttgataatatatcaaagtctattccttcttgattgaaaggaattcctatggctccaataaacaaagtaaataaaaccaaaataagcataggaaatagaatagtattgtctgattcatgcggataatagaaagttcttgtattaagtccaaaattttcaacagtaataaaaatttgatttcttacattattacttattttatatgttttattgcaaaaaaaagaagctctttttgtattattcattgttaataatggtactaacccaaaatttttattaagttttttttcttcttctttaccccataaagagagtgaatagaaggagccacttttttttccactgtaatttagaaaataagtgtttaaatgtccttcaaaagtaagtaaataaatccgaaacatataaaatgcggttaatcccgctgttgaacaagctattattgcaaaaattggcgaaaataacaaactatcattaagaatttcatctttcgaccaaaaacaagcaaggggggggataccacaaagagagagtgttcctattaaaaaggccgtttttgtaatcgggacatgttttgtcaaaccacccataagaatcatattctgacttttatcgggagaatatccaactatagcttccattgaatgaataatggatccagatcctaaaaacaacaaagctttcgaataagcatgagtaatcaaatgaaataaagcagatcgataagaccccatacctagagctaacatcatataaccgagttgagacattgtagaataggctaaaccccgcttaatgtctttttgagcaagagctaaagtggctcctaagagtactgttattatacctatcaaagatattatatacattatagaagggataacgataaaaagaggaagaagacgagctacaagaaaaatacccgccgctaccatagtagcagcatgtataagagccgaaatgggagtagggccctccatggcatcaggtaaccatacatgaagaggaaattgtgcggatttagcaataggacctacaaataatagaaatgcacacaaagtaaggaataagagatttactctattatttaaaattaaattattgaatatttcgaacaaatcctgaaattcaaaactgccagttatccaataaagacctaaaattcctaataataaaccaaaatcccctacacgattagttacaaaagctttttgacaagcattcgctgcaataggtcgtgtgaaccaaaaacctattaataaatacgaacacattccaactaattcccaaaaaaaataaacttggatcaaattagaactagtaactaatcctaacattgaagtattaaaaaaacccatataagcaaaaaatctcaggtatccttgatcatgcgacatataattgtcactataaatcagaaccaaaatcccaacagttgtaattaatattgacataatagaagtaagtggatcgataaagtaaccgaactcaaaagaaaattcattatttatggtccaagaccatacattttgatgaatgcaacttagaaaaatttgttgaatagatagatagattgaaaagatcataactatacttaacaaaaaaatactaagaaaagtccacatgcggcgaaggttttttgttgctgtcggaaaaaggagaagtccaactcctagtaaaataggtactggaagtggaatgaaagggatgatccatgaatattgatatgtatgttccataaaataaaaaatcctttttattttattcttaattttattttttcttattcactggtttgtatatatatatttttttttcaaaggggacaataaaaaagcacgcgatttcaaacctaaatagaaatgttttcgaattaatataatccttcataaatctttgaaaagcaatatatattcaaataaaaaaattagaaatgattaaaaaatattactaagttactgtcaaaagattttatttgtctttttttattactactaaataaaattttattgtgattttatgcaaatacagaaaaagtgaattataattccatattacaataatttatatacatatattaagaatagaacaaagatttccacgacaaaaaaaaacttaatattaattatataaaaaaagcttgacctaaaacaaagttatttgagtttgattatttaggattgttaaggaatggattttcatcgtggaatttagtgattgtctttcagtacactaagtgagctttttttatttatattttttaagaaagattactataatgatatgttttttttacatatgatgtgaagaaatattataatttttttataatataagctatcagtatagattatttaaatgagtactctcatacggatttcaaacgttaaaaaaaaaagttgggtttgaaacttttgaatgtcttttttgttttgaaaataatatataataaaatttgaaagaaaaaaactcgtacggagtacgaaagaataaaataataaatgtctttgacatccaattataccactgaaattttttttcatttttgaatggcagttccaaaaaaacgtacttctatctcgaaaaagcgtattcgtaaaaaaatttggaaaaggaagggatattggacatcgttgaaagctttttcattagggaaatcactttctacaggtaattcaaaaagtttttttgtacagcaaaataaataaaaaacactataataattagaattagcctaacttaaaaaccaatttgtttaaatacatctaaaaaaaataggaagcaaaagaagaaaaaaagacaatatatagataaaatatataaaaaataaaggttcgcatttttttagttccaaaaaggggattcgtattgttcccatcactaccttgagacaataataaaaaaagatcttttatttcctcttaatgaggaaataaaagatcttgaaattaattactttaagtgagcaaaaaatcttatgtttgtacaatataaaaagatacatcaaaaaaaatattttgataatttttttgatttctcttgagcaattaggaaaatctaattttatttaaaattgctaaggattttgaagaagtttttatttttcgaaaaagcatttttttatcaattttttttcatataaatgaaaaaaaatgataaagagcatttagagttttgtctttgggttgaagttccaactactttaatttagttacatttttcattgtattctcgaaaaaaatataaaggacaaaaagtcaattgaaataattttaaaaatcaattggaaattttaataaattggcttctttatttaaattttaatctcgacgattgaatcaaaacttgttaatattgttttgaacaagttgccgctatggtgaaattggtagacacgctgctcttaggaagcagtgctagagcatctcggttcgagtccgagtagcggcataagatcttctaaaagagatattataagttttataatcaaaataatacccgacttttttctaaaatcgggtaaaacctagtattaatttattaatttttaacaaattttttatgattttttcaattttagagcatatattaactcatatatctttttcggtcgtttcaattgtgctgacaatttattttttaactttattagttaatttagatgaaatcataggattttttgattcatcagataaaggaatcataattacgttttttggtataacaggattattattaactcgttggatttattcaggacattttccattaagtaatttatatgaatcattaatttttctttcgtgggctttttcaattattcatatggtttcctattttaataaaaaacaacaaaataagttaaacacaataactgcgccaagtgttatttttattcagggttttgctacttcaggtcttttaaacaaaatgcctcagtctgcaatattagtaccagctctccagtcccagtggttaatgatgcacgtaagtatgatgatattaggctatggcgctctgttatgcggatcattattatcaatagctcttctagtgattacatttcgcaaagtcggacctactttttggaaaaagaatataaaaaaaaattttttattaaatgaattattttcttttgatgtactttactacataaatgaaagaaattctattttactacaacaaaacattaattttagtttttctagaaattattataggtatcaactgattcaacaattagatttttggagttttcgtattattagtcttggatttatctttttaaccgtcggcattctttcaggagctgtctgggctaatgagacatggggttcatattggaactgggacccaaaagaaacttgggcatttattacttggactatattcgcaatttatttacatattaaaacaaataggaatgttaggggtataaattctgcaattgtggctttgatcggttttattttaatttggatatgctattttggcgtcaatcttttaggaataggtttacatagttatggttcatttacatcgaattaaagtaacaaataagaaggaatcgaaatctaaataaaaaaataaaaaaatagcatctatatctaacttcatataagttaagaaatctcatttagttttagtagtaaatcataaagaaccttttgaatcaagtagtacaatgattcaaaaggttctcacaatacaaagaccaaagacttctgattacaattcactttaatgcttttttttttcctgaaaactatccataaaaataattagataaaatggattcgaccttgtcacttgctaatgagagcacaaaatcaggataaatcccaataccaattatgggtaaaagaatagagattgaaagaaataactctcggggtccagaatcaaaaaaagaaaagtttttgatattaattaacttgtatccatagaacatttggcgtaacatagataataaatatataggagttaatatcattccaattgccattacaaaaataatgaaaattttggaaattaagaaatatttttggctggtaattattccaaaaaaaacaatgaattctgcaataaaaccactcatgcccggcaatgcaagggaagccatcgataaaatagtgaacattgtaaatatttttggaatggagatagccattccacccatttcatcaagataaacaagcctaattctatcataactcgttcctgccaagaaaaaaagtgcagcgccaataaatccatgagaaattatttgtaaaatagctccattaagtccaggatccgttatagaactaatacctataattataaaacccatatgagatacagaagaataggctattctcttttttaaattacgttgaccgggagatgttgaagctgcataaattatttggattgtaccgactaccaacaaccaaggagaaaacatagaatgagcgtggggtaataattccatattgattcgaaccaacccataggctcccatttttaataagattccagcgagaagcatacaggtactgtaatgtgcctcaccgtgggtgtcaggtaaccaagtatgtaaaggtataatcggtgatttgacggcaaaagcaataagaaatccaatataaaatagtatttcaagtgtaacaggataggatttattagctaagagttctaaatttaatgttggttcgttcgaaccatataaacttatacctaaaactcctattaataaaaaaatagaacttcctgccgtgtacaaaataaattttgtagccgaatacagacgtttctttccaccccacatggataaaagtagataaacgggaattaattctaattcccacatgatgaaaaaaagtagaagatcccgagaagaaaatgatcctatttgaccgctgtacattgctaacatcaggaaatgaaaaaatcgggaatcccgagtaactggaaaagccgctaaagtggctaaagtagtaataaatcccgtcagtaaaatagttcctatagaaagtccatctattcccattctccagtaaaaatcaaaaaaatcgatccatttataatcttcggacagttgaattaatggatcgtccattttaaaattataacaaaaagcgtaggtcgttagaagaagttctaagatgcaaatgcatatagtataccatttattgactttatttcccctatgcgggagaaataacattaatgaaccagcagatattggaaaaacaacaattattgttaaccaaggaaaatcattcgtggtaaagacaagatacaccaggtccaaagaacgcgtactcaaaaaaaatatataaataaaaaatttttaacttttttgagtacgagtacttgtcaataaaaaaaataaaatgtattccaaatttattcaaatgaggttttcggtaacgtatcaataagctagacccatacttcgagttgtttcatgccataaataaactcgaacgctcaaaaaatccgttggacaggcggattcacatctcttacaaccaacacagtcctcggttcttggagcagaagctatttgcttagctttacatccatcccaaggtatcatttctaatacgtctgtagggcatgctcggacacattgagtacatcctatacaagtatcataaatttttactgaatgtgacataggatcgatagttttttgaatgtcataaattttcaatctagtaaacttctaactgaatggtatattaaaatactagatgaagcaatgatttcctttaatagaatttttgtaatgaattttggctcaattcataaaaaatggggctaaaatactttgatttcttagatttttacaaatagaatctcgtaggtcataacttatcatatatgcaaatttcaatctataatttttttagttatgttacttatttaataaggtcgattggtttatgcgaattgattttctgttacgataaattgacgagactatagctaatccaatagctgcttcagcggctgcaattgctataacaaaaatgcagaaaatttccccttttagttgggaattatcaaaaaaatcagaaaatgttacgaaattcatattaactgcattgagtataagttcaagacacataagagccctaaccatatttcgacttgtgatcaatccataaagaccaatcaaaaataaataggcactcaaaacaagtacatgttcgagtatcattcagcaactccttatcaattttgattcatttcaatatgaaaaataattcaccggattccatcaactagaatataacaaaaaagtacgaataaaaaaaatatttaggtaaaaaaaattttcaaatatatatcaaatacaaatatatatcaaatataaaaattgatccttaaaatatgaaatagtattcaatcaaatttaattgaatgaacggaaaaaatcataacatacacaaagttttctttggtctttaataatttagaacattttttattgacgagccacagaaattgcacctatcaaagcaactaaaagaattattgaaatgagttcaaatggcagaaaaaaatctgttgataaatgaattcctatttgttgactattacttattaaatcttgctctagaatctggtttaattttgtagtccaaataaccccgtaccatgacgtatcgagaatagtagacattaataaaaaaagaatagttgtacaaaccaacgaagtaatcccattcccaatggtccacagattgaaatctgtggaatattctgaatcattcatgaacatcacagcaaatatgattaaaacatttatggcccccacataaataaggagttgtgcagcagctacaaaatgggaatttgatagaatatacaataaagatatacaaacaagaacaaatcctaaggaaaaggctgaaaatattgggttgggaagtaataccactcccagaccccctactagaagaccggatcccagaaaaactaaaagaaaatcatgtattggtccaggcaaatccattatattattaaaataagaaaaaatcgaaatccttttcatgaccttattaatttaaccaggaaatttgttttttatatgtttctaaatagagtgaaattagaatctaatggatatgaattgatgtagatacaattattagtattaggctgttttctctttttttttttctaaagtgtattttcaacctatcaatttcaagaaagtaattacgaatatattatattaaaagaatgtgccttaatacttaatattattattattatataaatacaatacaagtttttaattaaattctttatataaatataattcaacaacttggaattctttttttaatcaaattaaagggtttaccccattttttgtttgaggtgaattccaaattgttcgaatagtgtaatcgtcaattactgacattggtaaacgacccaaagctatttgattataattcaattcgtgacgatcataagtggaaaattcatattcttcagtcattgacaaacaatttgttggacaatactcaacacaattaccacaaaatatacaaattccaaaatcaatactgtaattaagcaatcgtttttttcgaatattagtttccaatttccaatcaacaacaggcaaatctataggacatactcgaacacatacttcacaagcaatgcatttatcaaattcaaaatggattcgaccgcggaaacgttccgatgttattaatttttcatagggatattgaatagttacaggtaaacgatttgtgtgggataaggtaatcatgaaaccttgaccaatataccttgcagctcgtagggtttgttgaccataattcatgaacccggttatcataggaagcatattgtaattatctctgaataattttatctttgtttctgtctcttgtttaaaacaaataatgaatatattagattcattttaaatttagagtgaaaagagttggaaagaagtggttaataatagattaccaagggaaataggtaaaagaaatttccatccaagatttaatagttgatccattcttagcctaggtaaagtccatcttgttgcgatagaaacgaacaaaaacaaataagttttagctaatgtaataaagataccaattgttgttccaaaaatttgatccctttgaaatagctccagaatagatatatacggaatagaaatattccaaccgcctaagtatagaactgttacaaataatgaggaaattaatagatttagataagaagcaacgtaaaataaaccaaattttatacctgaatattcagtttgataacctgctattaattcttcttccgcttctggtaaatcaaacggtaacctctcgcattctgctagggaagaaattagaaaaatgataaaacctataggttgacgccacaaattccatccccaaaaaccatattttgattgtgcctcaactatatcaactgtacttaaactgttagataatcctagtcggcgagaacattactattttcaccgctatttcagaaccgtacatgaggtcttggcctcatacggctcctcgggggccataaataaatctaaggaccagattataatttagatggatatgatgtgttctaaaatggattaaatatatctggggtcccgaattataccaatggaattctgtctgctcaaattctaagaataaaaaacgcgcttcggaattcatctcacccctttacaaatttgaatttctatttgttgagtaataacttaaccctttaataaaaaactcctaaaaaaaaaaagtatttaagcccatcgtggttttcgattacgaaaaataattagacatcctatttttttattattcatgacagaaattcgattttattttcgaaatatatgaaaaaaaaaagagccttgtttcgttcctattcttctttcttttttagaaaaaagttggtagacttataaaaaataaaggattatttcgtttctgatagtcattacatttgtcggtggataggagcatactctgaatcggaatcttggggagtactgtctgatcatttctactaatttaaagccccaattaaccttcttttttttatcttatgttaggcctaaatatccttttcaatttggttaatctctattacaaattctttgtgtattttggtgtttctaaccatccactcacttttacctaattgccgctcactttgtaatacatgtatgttaatctatataactgatagtgaaaacgtcatccggttaccggttaatatatttaacccgcttcaagtcaggatgactaatcaaccaaccttggggtaaagtgattcttacacttatgtttatttccgtttaacctttgtacataggaaatgagactcatttttcgttttactgcaaatttcagagcagtttttttttcactcatatataactatcaaattccttttattaattatttcgattaattcgaaagataaatatatattccgttttttaactgattcgtctagaagaaacggaatagtaaaaataaacgtttctgtttcaacgaatcgcacgtagagatattgataaaacacatagagttaatggtatttcataactaatcgattgggcagcagctcgcagaccacctaaaaaagaatatttattatttgatccatatcctgacataagaagtccaataggagcaatacttgagatggcaatccataaaaaaataccgatattgagatccgctaaaacaaggtgattgctaaagggaattactgaataacttagtaaaatagagataactgctatagatggtccaatactaaataaaggagtatttcctctagatggacgaagattttctttgaaaagtagttttgtcccatcggctagagcttgaagaattcccaacgggccggcgtattcaggtccaatacgttgttgtatccctgcagatatttctctttctaaccacacaattactagtacacctgttatgattcccaatacaagagaaaatatagggacaaatatccatatgagtccatagacctcttttaaagattccaatttaacaaaagaatttatagtttggactgctgttgcataaattatcattttaacgatcaacttctcccataattatatctatgctaccgagtatcgtcataatatcagccaatttcattcttttaactagttcaggaagaatttgcaaattaataaaacccggtggtcgtattttccatctccaaggaaaaccgctttgatctcctatgagaaaaattcccaactccccttttggagcttcaactcttacataaagttcttgttttgataattcaaaagtaggagaaggttttttactaatgaatcgatattcaaaatcattccattctggattcctttttctatcaaagcccctgctttctaaattctcatagggaccccctggaagtccttccagagcctgttgaataatttttatggattctgtcatttcgctaagtcgtactaaataacgagctaatgaatctccttgtttttgccattgaatttcccattcaaattcatcgtaagactcataacgatcaattttacgaagatcccatggtattccggatgcgcgtagcattggtccggataaaccccaatttattgcttcttccccaccaataatcccaactccttcaacccgttctaaaaaaataggatttcgtgtaatgagtttttgatattcaacaacctctgttaaaaaataatcacaaaaatccaagcatttatctatccaaccataaggtaaatcagccgctattcctccaatacgaaaaaaattatgcatcattctcataccggtggcagcttcgaatagatcatatacaaattctcgttctctgaaaatatagaaaaagggagtctgtgcaccaatatctgccataaaagggccgagccataacagatgagaagctatacgactcaattccagcataattactctgatatagctggcccttttaggaacttgaatatttcccaattgttctggtccatttactgttattgcttctgtaaacatagtagctaaataatcccatcgcgttacatacggtaaatattgtataattgctcggttttctgcaattttttccattcctctgtgtaaataacctaatatgggttcacagtcaacaacatcctcaccatctagagtaacaattaagcgaagaacaccatgcatggatgggtggtgaggtcccatattgactatcataagatcttttcctgtaactggtctcttcataagtttttccttgattcgttctggcatgaattagatttctgaataaagaagtttatcaaaaaattcaagatctaaaaaattcactaattcacaatttttgaatttaacgagtttttaattcccgaatattcaactgattaattaattctttataacgtactctatttttttttgacaaataagccagcagtcgttgacgttttcccagaatttttcgtagaccccgctgagataaataatcttttctgtgcaattccaaatgtgaagtaagtcttcgtatcttattagtgaaactaaatacttgaaattcaacggatcccctgctttcttctttttgttcttcaaatgaaatgactatattttttatcataaaaagaaatccttccccttttaatatgaattgaaagatattaattttactgatcagtaataataatggtagtttttttgtacaaggatcttaatttaattatcaacctcttaattcttcattttagaaaaaaatctaaatttagatctcaaaaagaaggattctgttaatttatttatgaatccgctataattggtatctatgtgattgattaaattaatctcatgtataaagatttaatttaaaacaatccctcatatttgtgcatatagttgttttcatataccgtaacttattatatatagtaaaaagtatttatgattaaggaattggaaatcgcgtatacatgcgtattcttatcatactgaaatgatttccgttagtagtattaaaccaatagcgattcatacaagctaaatcttctaatttaaaattgggccaaagaaaggattttaaattaattaagttatttttatccttatcaagatcaagatctttctttttatgcaaaacggtggtcaagttttgaatattcttatcaaatcttgaatttgtatccctagcattttttttttttaagttgaaacaaattagaattcgaaattctctacgtcgtttaggggatagaattttttcagggacaaagaaatcataattatttttttttttatttacagttttgttttgatattttgtaatggatttttcaaaaaattttttattaatatagcttttttttttgtatcttttacttattttgtgtttatttttatgaaccaatgaaatacctatggttctatatataataagttgtccatcgttttgtacagacaaacgcacaggttcaataatcaatattccttttttcattaattttgcaaaagtgaaatttttctcaatcattagaatgtctaggctcatctctcctctttcaatagaagataccgctatttcgtttggattgtttagtctaaccaagagacagtatacttttacattattgagaattttttgattaaaaaaacaattccatcgcaattgaaaacgcgaatatcttgtcagaaataaatcaagttccgcttctgtattacttttgtattgttttttatttttacgtttttttattgttgattctgcaaaattttcttcaatatttttttcttggtttaatcgagctgcttcgggatttctttttgtttctttatctgattcaagttctacttgaccggccgattctttttcttctttattcagattataaaatcgaagggattctttttcatttgatggtataaaaccttttttctttcgaatgatctttttattaacatttatgttttcattaaaatttaaaagaagtaatttgattggtatgacccatggtttcattttatatgtactagaaaataagaaaaattccggaaagaaaaaaaattcaaaatttgttatacgctgatttagtatttcttcattcattcccatccaatcaaaaaagtttctttttttattagcaagatccgtctgcgttattttatcaattttttgataattctgaactttagtattaatatatttttttttactcttagtatcaacccaaggctcaatagttactttttttgtaaaccaaaagttaagaattctccaatccaaatattttctatgccgaatttcccccataccccgaatattatatttttctagaaaagaagagactaaacaattatctagggcaatgcctatagacatgtcaaaatttttttctgtagaatgaatagatttatagcaaaaaagattatatatagaatctttttttacattatgttttggatttaataatgagtcggcctcaaaaaatttttgttttttataattatcaaatttctttttttcatatgaatcctctttggttaaacttgggtttagaactagagaatctttatttattttatttttccaattttgggttactaatctagcccatgaaatctggggtaaattgtattgatactgacttcgtaaccagtttttccattgatttacttcggaattcaaaaaggttttatttttcaattcataatgaaagattccgtgttcttgaaaaaaaacctttattttattcttaacaaaaaaggatgttatgcatatgttatattcaagaacagcctttaatttacaaaagttactaactttaatttgtgataatttgtaaaatacatatgcttgtgataaagagcataggtcataactcattttttttttattggatattaaattttttatagtcgaaataaaataaagagtatttttttttttttctccattttcttcattcttgtaaatatatttatcaagaattttttttgttgattcaaaaaaaagttgtgtagtaattcttggaatattaatgatacctagaaaaatagctatagacatttgttcgatgcaaaatttaaaaaaaaaaatggatttacgaattaatcgggtattttttcttttgaatgtctgccaaattttttttgatgactcaattattttagaatcataacgcagtttggtacaactattagttaagttttgtttttcttttgaaatttcttctatttgatttctgattgtcttttttctatcaatcaaatttttgatttttttttcgctaagtgaagaatttgtccactccaaggatttattttgaacagatagttcatgaatcatctgattacttattattgaatcttttttaggttcatttaattcatatatttctctcgggccaaataatggaattagatttcgttttgaaattccttttataaaaataaagtttttgagaatccagtttttagtttcttttgcgacttttaggaaaatgggtgctctttctttgaaaatctttaaaaccacaaaagactttttttttaattttttgattcttttttttaattctttagaaataggttcaaaaaaagaaggctttctttgggcagaaccaaacggtagttcggtttccattccccaaactgttaagaaacaaaaatcatttttttctcctttgtcttttgttttttttagtcgagccttctgagatgcttgaaatttagatttatgccaaggtttaagataaaaaggaaataggatttttatctgaataccatccgttaaccagtttcttggaaattctgtttcggatagttgaaccccattataagtacatttaacatgcatttcacgtttccaatcctttaaatcctgggaccactcgggaaattgaaataataacatacggacactgtttttaattattatcaataaaggtaatataatatattttctaagaattgattgagttactaagagagaacctcttattatttgagcaaataggaagctatcccaagtttctgcaatttctatccgtcttgtttcttctctttttgattgttcttcttcttttttatcaattttttttttccaaatgaaatttttaataatttttttttttagcccccatatatcaaacgaaaaaaaaaaaagtttatctattctatcaaaaaaaaggggggaatgtacttttgcttgaaaaaattcccaaataacagttttacgcctttgggaacgcatggatcctttaattatctctcgacgaaaatcagattgttgcgaataacggatcaaagccatttcatcgttttgatcagaattttgattatctttgagattagtataaatctcgccatgtggctctttatcagtaaaaaccactacacgttttgcttttcttgaacgaattccaggctccattggtacattttcttcattttcgccttccaattcttccaactcacttattaatttgtatgaccatcgaggaacttttttattgatttcagggaaatccataaaattttttataagcgtttgatcgttgctatcagttctaacaatatcaaataaaaatttgaaagttttgatttcttcttctgaattaattttttcttcttgttggggttctgaaaaaaaagaaagttttttctctattgacaaagattttctattaaatttttctattgtttgctcaaattttttataattaatcttcagaagtagaccatgaatcttgtttatccaggatcctcctaaattgttttttctataggtttcggttatgatttggaatggaggtaattttttgattcttccccgagagattccatgcaaaaaaggatcataaattttaggtaaatattcttttttagcttcgttataacaaaagcgagtcgttttttccagtatattttcaacagaccattccttatctaaagcttcaattctatttaaaaattctttttttaagttttcccttttttcttcatggatcaaactccaataagtagaaacttggtcaaaggtttttttttcttttgtaaatgaaggtatccttttttggatcatttcaaaaaaggtggaaaggttggggggatatgtaaaagatattcgttcttttccatcactttggcatgtataaaaaaaatattgtgacatttcatttcttacaatattttcaattttatcattttttatatatcggtttggtcgattccatcttttataatcgaaaacgagagttacaaatggtttttcaaaccataaaaaatgatcctcttttttttttattttgaaaaattctaaattcgaattttctttatttccatatagattttcagaaacagttttatagttatagtatgttcgaacgtggaattcatcatccttattaattttgtcttttccattcactcggatttcttccatttcatcgattttgtccagatcttccccttcttccgaaaaaagagaaggaaaaggagcttcttcggtggatacctcttggtcctgtttagtcccacccgtttctgaggttcctttaagtttcttagtaaaaatgggtgatggtattctgcctaaatagtagacacaggtaataaataagagaatactaaagattcgagccatagaatttctcaattctgacacaaggaacttatacttattagatctaataactacattagacctaatagaattattttgctgtatccagactaataccaatccaacccatttcatgaataaaatgtgaccaattaaccaaccaacaaaactacttgttacaaataacatcttgttgttgcatcgaaacatataaatgttgactaatctggctaacattgaacttggtaaaatgaaatggttgaataattgaaaaatgagattattcaggaatacacattgaatgcgaagattacgcatttcatttctggtagtagatccataatcaaaaaagtgtttgtgattgttccagaagaaatgaaacaaaagatacggtagagctaggacagttattgtatgaggtctacccaatgctaaatgcagaggcgcataatagatcgatatgaacatcatgagctgtcccgcaataaaacctgttgttgctgatactttcttctcggttccttcttctccttcgtccataacccgagctcggagaaggaagagataagagggccctatggaaaatgtggtcagaaatccataatagagtccgaccacaacgaccgaatttattatcttcatgcataaggatactagattacctagtataaaagattgaaaaaccatcacaaacctcccttttttcttttctatttcaatttctggattattatatgatgattttgcaactttccatatatagaaatagaaagagatagactagaaacgacatctcttatgtcaatgacaccaaagggatattaaatgaatggaattgggatatggatggaatataatgaaatagagccgctttgaggttccctattaaattaggcatggaacggagccactacgaagaagttccgggggttacgaaggaaacttcgagttcatattggtcatgggttgagaacgggaattgaactctatgagatctaatctcccgttgttcctcagtagctcagtggtagagcggtcggctgttaactgattggtcgtaggttcgaatcctacttggggagatttgattcattccgaatttaagaattcagaatgtaagaatgaacgggttcgctttgaccgttaagagtcggtaacccgttccctgtgtctttgtttctattgcattctatctcatcgtatcacattctgttctgtgatatttgagaatcaccgtcaatacctcggtgtaggttcgggataatcctttattctatagtcctggggctatttacaactagccaattcagaattttcagatgtactaacaagtgcatctttgatgcagtcatcgattctcccgagagttcacaattaccgcgagcaaacatatgaatttaatgacttaatgatgaggaacgcatttttgctatgctactaatacttgctccgctattctgcccaagcctggctgaggaagagttacggggcttcaaaaaatatgctgattcggccgtttaaaaatactatatgtaaaattaaaaaagcgatagatataatagatatatatctaaattcaaataaaaaagaaggtcactccactctatttcgacaaaagacccatccccaagttccatagctttgagtccgctatcgctatcccgagcatgattttcctacccccccggagggaaaggtccttcccttttgggccggttgtgggcgaggagggattcgaacccccgacaccgtggttcgtagccacgtgctctaatcctctgagctacaagccccaccccgtctccactggatctgttcccaggagtaccctaaaaaaaggaacctttcctctccccagccatttcggatgtgaaagtgcctttctctctataagaacggtgcgttccggggtgtgaagtgggatgatttcataattggggttttgaataagacaaccttttcatttttcattttttttttcaatatgaaaaagtaataagaatgagaggtgttaagcttttcatcatcctggcgtcgagctatttttccgcaggacctcccctacagtatcgtcaccgcagtagagtttaaccaccaagttcgggatggattggtgttgttcctctacgcctaggacaccagaatatcgaaccatgaacgaagaaaggcatgcgagaaaagcatattggctagtgattgtgaggctccaattcttgactggagtggacaccaaaggcctctgcccccccatcctttggatagaagggcagaattttaggttttttcatgttgtcaaagagttgaacaatggttttttcgtgttgtcaaagagttgaactatgaaaatagatggcgagtgcctgatcgaattgatcaggtcatgtaggaacaaggttcaagtctaccggtctgttaggatgcctcagctgcatacatcactgcacttccacttgacacctatcgtaatgataaacggctcgtctcgccgtgaccttctcttgaattctcaaaacttctgtcactccatccccgcaggggcggagaacccgttgctgtctcggctgtgctaccggaggctctggggaagtcggaataggagagcactcatcttggggtgggcttactacttagatgctttcagcagttatccgctccgcacttggctacccagcgtttaccgtgggcacgataactggtacaccagaggtgcgtccttcccggtcctctcgtactagggaaaggtcctctcaatgctctaacgcccacaccggatatggaccgaactgtctcacgacgttctgaacccagctcacgtaccgctttaatgggcgaacagcccaacccttggaacatactacagccccaggtggcgaagagccgacatcgaggtgccaaaccttcccgtcgatgtgagctcttggggaagatcagcctgttatccctagagtaacttttatccgttgagcgacggcccttccactcggcaccgtcggatcactaaggccgactttcgtccctgctcgacgggtgggtcttgcagtcaagctcccttctgcctttgcactcgagggccaatctccgtccggcccgaggaaacctttgcacgcctccgttaccttttgggaggcctacgccccatagaaactgtctacctgagactgtcccttggcccgtaggtcctgacacaaggttagaattctagctcttccagagtggtatctcactgatggctcgggcccccccggaagggggccttcttcgccttccacctaagctgcgcaggaaaagcccaaagccaatcccagggaacagtgaagcttcatagggtctttctgtccaggtgcaggtagtccgcatcttcacagacatgtctatttcaccgagcctctctccgagacagtgcccagatcgttacgcctttcgtgcgggtcggaacttacccgacaaggaatttcgctaccttaggaccgttatagttacggccgccgttcaccggggcttcggtcgccggctcccctgtcatcaggtcaccaacttccttaaccttccggcactgggcaggcgtcagcccccatacatggtcttacgactttgcggagacctgtgtttttggtaaacagtcgcccgggcctggtcactgcgaccccctttgtgaggaggcaccccttctcccgaagttacggggctattttgccgagttccttagagagagttgtctcgcgcccctaggtattctctacctacccacctgtgtcggtttcgggtacaggtacccttttgttgaaggtcgttcgagcttttcctgggagtatagcatgggttacttcagcgccgtagcgcctggtactcgaacattggctcggggcattttctctaccccttcttaccctgaaaaaacagggacaccttgcgtccttgaaccgataaccatctttcggctaacctagcctcctccgtccctcgggaccaacaaggggtagtacaggaatattcacctgttgtccatcgactacgcctttcggcctgatcttaggccctgactcaccctccgtggacgaaccttgcggaggaacccttgggttttcggggcattggattctcaccaatgtttgcgttactcaagccgacattctcgcttccgcttcgtccaccgccgctcgcgcggttgcttccccctaaggcggaacgctcccctaccgatgcattttgacatcccacagcttcggcagatcgcttagccccgttcatcttcggcgcaagagcgctcgatcagtgagctattacgcactctttcaagggtggctgcttctaggcaaacctcctggctgtctctgcacccctacctcctttatcactgagcggtcatttaggggccttagctggtgatccgggctgtttccctctcgacgatgaagcttatcccccaccgtctcactggccgaccttgaccccagttattttgaggtcatatctagtattcagagtttgcctcgatttggtaccgctctcgcggcccgcaccgaaacagtgctttacccctagatgtccagtcaactgctgcgcctcaacgcatttcggggagaaccagctagctctgggttcgagtggcatttcacccctaaccacaactcatccgctgatttttcaacatcagtcggttcggacctccacttagtttcacccaagcttcatcctggtcatagatagatcacccaggttcgggtccataagcagtgacaattgccctatgaagactcgctttcgctacggctccggtgggttcccttaaccaagccactgcctatgagtcgccggctcattcttcaacaggcacgcggtcagagcccagggctcctcccactgcttgggagcttacggtttcatgttctatttcactccccgatgggggttcttttcacccttccctcacggtactacttcgctatcggtcacccaggagtatttagccttgcaaggtggtccttgctgattcacacgggattccacgtgccccatgctactcgggtcagagcataagctagtgatgctttcggctactggactctcgccatctagggtgcggcactccaccgcttcgcctagcagcacgacgctttttttgctctcccacaaccccgttttcacggtttaggctgctcccatttcgctcgccgctactacgggaatcgcttttgctttcttttcctctggctactaagatgtttcagttcgccaggttgtctcttgcctgcccatggattcagcagcagttcaaaaggttaacctattcgggaatctccggatctacgcttattttcaactccccgaagcatttcgtcgcttactacgcccttcctcgtctctgggtgcctaggtatccaccgtaagcctttcctcgtttgaacctcgcccttaactttaaggctatgccatcctaaggtgctgctaaatggaaagatcttatcaacgtccatgaatgaaaaatcatagatcgaactgccgaatcggaaaaattgggtgctatcatatagctttgtatcggctaagttcacgagttggagataagcggactcgaaccgctgacatccgccacagggtaaaccaccgcctatcaggcccctgactgattctaccatagaggccaacgatagacaagaactcccccccgaacacagcttacaactttcatcgtactgtgctctccaaagagcaactcttctcaaaatctcaaaaggtgatgagctggaatcccattccaactaaggattcttgtggttctagaggatccagctacaggagaaccaggaacggagagctttcccccccttttccgccccaactctttcgaatgctggttttaagaatgagtgattgcccttctccgacccttactgcccaacctgcgagcggacagctaatgcattccacttattgaacagggttctatggtcggtccgcgacccctggataccgaaggcgtccttggggtgatctcgtagttcctacggggtggagacgatggggtcggtccatggattttccttccttttgccgcatttcgctcaaagggttgaagggagatagtgcatcaagctgttcgcaagggccaacttgatcctcttccccagggatcaatcccagacgagggaaccctaggagagccgccgactccaactaccgtccatgtacgatccatactagatctgaccaactgaccatcctacctcctctacgttcttgacagcccatctttgtctcagtagagtctttcagtggcatgtttcggtccttttccccattacttagaaaaagtgagccaccggttcaggtacaagatactatcattaccgcctggacaattagacacccaacccgtaatcgcaacgacccaattgcaagagcggagctctaccaactgagctatatcccccgagccaagtggagcatgcatgaaggagtcagatccttcttatattcttttccttggcgcagctgggccatcctggatttgaaccagagacctcgcccgtgaagtaaatcatcgcacctatggtccaaccaattgggagagaatcaatagattccttttcgggagcgattcatccttcccgaacgcagcatacaactctccgttgtactgcgctctccaagtgtgcttgttccccccctcttccttaccataggaagtatttgtgaaataacttcgatgagaagaaaaaagagggcgttaagagaccctactggcctaaccctagacactctaagatcctttttcaaacctgctcccatttcgagtcaagagatagataacatgaaaaaaaggctcgaacggtacgatccctccgtcaccccagaatgaaaggggtgatctcgtagttcttggtctgtgaagatacgttgttaggtgctccattttattttcccattgaggccgaacctaaacctgcgctcgagagatagctgtccatacactgataagggatgtatggattctcgagaagagaggagccatagtggtcccctccggaccgcccggatcccacgagtgaatagaaagttggatctacattggatctcacctgaatcgccccatctatcctcctgaggagaagtttggtttcaaaccccggttcgaacaggaggagtacgccatgctaatgtgccttggatgatccacatctcagggtcaggcgctgatgagcacattgaactatccatgtggctgagagccctcacagcccaggcacaacgacgcaattatcaggggcgcgctctaccactgagctaatagcccgtcgtgcgggcctcctgctgggggcccgctatgccaagccaaaagcgagagaaaccccatctctctctttcctttttacgcctccctgccgccacacgagagggacatgggggcgtaaaaggggatcctatcaacttgttccgacctaggataataagctcatgggtttggtcttacttcaccgtcgagaaacgaaagaaggcttccacctccaagtttaactcagacgtagctcccttctttttgggtgtgaagctgtgtcaaacctaaatacccaagaagcattagctctccctgaaaaggaggtgatccagccgcaccttccagtacggctaccttgttacgacttcactccagtcactagccctgccttcggcacccccctccttgcggttaaggtaacgacttcgggcatggccagctcccatagtgtgacgggcggtgtgtacaaggcccgggaacgaattcaccgccgtatggctgaccggcgattactagcgattccggcttcatgcaggcgagttgcagcctgcaatccgaactgaggacgggtttttggagttagctcaccctcgcgggatcgcgaccctttgtcccggccattgtagcacgtgtgtcgcccagggcataaggggcatgatgacttgacgtcatcctcaccttcctccggcttatcaccggcagtctgttcagggttccaaactcaacggtggcaactaaacacgagggttgcgctcgttgcgggacttaacccaacaccttacggcacgagctgacgacagccatgcaccacctgtgtccgcgttcccgaaggcacccctctctttcaagaggattcgcggcatgtcaagccctggtaaggttcttcgctttgcatcgaattaaaccacatgctccaccgcttgtgcgggcccccgtcaattcctttgagtttcattcttgcgaacgtactccccaggcgggatacttaacgcgttagctacagcactgcacgggtcgatacgcacagcgcctagtatccatcgtttacggctaggactactggggtatctaatcccattcgctcccctagctttcgtctctcagtgtcagtgtcggcccagcagagtgctttcgccgttggtgttctttccgatctctacgcatttcaccgctccaccggaaattccctctgcccctaccgtactcaagcttggtagtttccaccgcctgtccagggttgagccctgggatttgacggcggacttaaaaagccacctacagacgctttacgcccaatcattccggataacgcttgcatcctctgtattaccgcggctgctggcacagagttagccgatgcttattccccagataccgtcattgcttcttctctgggaaaagaagttcaggacccgtaggccttctacctccacgcggcattgctccgtcaggctttcgcccattgcggaaaattccccactgctgcctcccgtaggagtctgggccgtgtctcagtcccagtgtggctgatcatcctctcggaccagctactgatcatcgccttggtaagctattgcctcaccaactagctaatcagacgcgagcccctcctcgggcggattcctccttttgctcctcagcctacggggtattagcagccgtttccagctgttgttcccctcccaagggcaggttcttacgcgttactcacccgtccgccactggaaacaccacttcccgtccgacttgcatgtgttaagcatgccgccagcgttcatcctgagccaggatcgaactctccatgagattcatagttgcattacttatagcttccttcttcgtagacaaagctgattcggaattgtctttcattccaagtcataacttgtatccatgcgcttcatattcgcatggagttcgctcccagaaatatagctacccctaccccctcacgtcaatcccacgagcctcttatccattcttattcgatcacagcgagggagcaagtcaaaatagaaaaactcacattcattgggtttagggataatcaggctcgaactgatgacttccaccacgtcaaggtgacactctaccgctgagttatatcccttcccccatcaagaaatagaactgactaatcctaagtcaaagggtcgagaaactcaaggccactattcttgaacaacttggattggagccgggctttcctttcgcactttatacgggtatgaaatgaaaataatggaaaaagttggattcaattgtcaactactcctatcggaaataggattgactacggattcgagccatagcacatggtttcataaaaccgtacgattctcccgatctaaatcaagccggttttacatgaagaagatttgactcggcatgttctattcgatacgggtaggagaaacggtattcttttcttaaacttaaaaaaatagagaaataagaaccaagtcaagatgatacggattaatcctttattcttgcgccaaagatcttcctatttccaaaggaactggagttacatctcttttccatttccattcaagagttcttatgtgtttccacgcccctttaagaccccgaaaaatcgacaaattcccttttcttaggaccacatgcgagataacgaaaaaaaaaaagagagaatggtaaccccacgattaactattttatttatgaatttcatagtaatagaaatacatgtcctaccgaaacagaatttgtaacttgctatcctatcatcttgcctagcaggcaaagatttcactccgcgaaaaagatgattcattcggatcaacatgaaagcccaactacattgccagaatttatatattggaaagaggtttacctccgtgcttctatggtacaatcctcttcccgcggagcctcctttcttctcggtccgcagagacaaaatgtaggactggtgccaacagttaatcacggaagaaaggactcactgcgccaagatcactaactaatctaatagaatagaaaatcctaatataatagaaaagaaaagaactgtcttttctgtatacttatgtatactttccccggttccgttgctactgcgggctttacgcaattgatcggatcatctagatatcccttcaacacaacataggtcgtcgaaaggatctcggagacccgccaaagcacgaaagccagaatctttcagaaaatgaattcctattcgaagagtgcataaccgcatggataagctcacactaacccgtcaatttgggatccaattcgggattttccttgagggatattggtaaggaattggaatgtaataatatcgattcataatggattcatatcgatacagaagaaaaggttctctatcgattcaacaagtgctgtacttatgggaaagcgatagagaaagagaaaaaaaaaaacgaagatttcacatagtgatttttttttttttttttgatcaaaaataaatctgattgaatttatttcgtaccccttcgctcaatgagaaaatgggtcagattctataggatcaaacttatgggacttaagaatgatggaagggaataaaatcaaaaaagaaatcaaataaagaaaagagagagaaaataaagaaaaaataagtaaatcaaaatgaagtagaagaacccagattccaaatgaacaaattcaaacttgaaaaagtctctttctgattctcgaagaatgaggggcaaagagattgattgagaaagatctcttgttcttattataagatcgtgtgattggacccgcagatgtttggtaaaaagaataatcttatcctttgagaataatcaaaaatagaaagtgttcagttggaacatgaaaacgtgaccgagtttgtcctagttactcttcgggacggagtggaagaagggaggagattcgcgaacgaggaaagggacccaatgacttcgaaagaattgaacgaggagccgtatgaggtgaaaatctcatgtacggttctgtagagtggcagtaagggtgacttatctgtcaacttttccactatcacccccaaaaaaccaaactctgctttacgtaaagttgccagagtacgattaacctcgggatttgaaatcactgcttatatacctggtattggccataatttacaagaacattctgtagtcttagtaagagggggaagggttaaggatttacccggtgtgagatatcacattgttcgaggaaccctagatgctgtcggagtaaaggatcgtcaacaagggcgttctagtgcgttgtagattcttatccaagacttgtatcatttgatgatgccatgtgaatcgctagaaacatgtgaagtgtatggctaacccaataacgaaagtttcgtaaggggactggagcaggctaccacgagacaaaagatcttctttcaaaagagattcgattcggaactcttatatgtccaaggttcaatattgaaataatttcagaggttttccctgactttgtccgtgtcaacaaacaattcgaaatgcctcgacttttttagaacaggtccgggtcaaatagcaatgattcgaagcacttatttttacactatttcggaaacccaaggactcaatcgtatggatatgtaaaatacaggatttccaatcctagcaggaaaaggagggaaacggatactcaatttaaaagtgagtaaacagaattccatactcgatttcagagatacatatataattctgtggaaagccgtattcgatgaaagtcgtatgtacggtttggagggagatctttcatatctttcgagatccaccctacaatatggggtcaaaaagccaaaataaaagatttgagcccttataaaaagaaaacagattcttgaacccctttcacgctcatgtcacgccgaggtactgcagaagaaaaaactgcaaaatccgatccaatttatcgtaatcgattagttaacatgttggttaaccgtattctgaaacacggaaaaaaatcattggcttatcaaattatctatcgagccttgaaaaagattcaacaaaagacagaaacaaatccactatctgttttacgtcaagcaatacgtggagtaactcccgatatagcagtaaaagcaagacgtgtaggcgggtcaactcatcaagttcccattgaaataggatccacgcaaggaaaagcacttgccattcgttggttattaggggcatcccgaaaacgtccgggtcgaaatatggctttcaaattaagttccgaattagtggatgctgccaaagggagtggcgatgccatacgcaaaaaggaagagactcatagaatggcagaggcaaatagagcttttgcacattttcgttaatccaggaacaggatctatatagacacatagatccatggatccatacatctcgatccgaaaagaatcaatagaaaaagaaaaaatcggaattgatcgatctctttctcgaaacaaacgaaaaggaaagaaaagacgaaacagaaatcatggatcaactaagccctctcggggacttgcttaagaataagaaagagcaatctcatgtaaataccatggaataaggttttatcctattcatggggattccgtaaatattccattccaaaaatcaaaaattggtttttttttggagattggatgcagttactaattcatgatctggcatgtacagaatgaaaatttcattctcgattctacgagaatttttatgaaagcctttcatttgcttctcttcgatggaagttttattttcccagaatgtatcctaatttttggcctaattcttcttctgatgatcgattcaacctctgatcaaaaagatataccttggttatatttcatctcttcaacaagtttcgtaatgagcataacggccctattgttccgatggagagaagaacctatgattagcttttcaggaaatttccaaacgaacaatttcaacgaaatctttcaatttcttattttactatgttcaactctctgtattcctctatccgtagagtacattgaatgtacagaaatggctataacagagtttctgttattcatattaacagctactctaggaggaatgtttttatgtggtgctaacgatttaataactatctttgtagctccagaatgtttcagtttatgctcctacctattatctggatataccaagaaagatatacgatctaatgaggctactatgaaatatttactcatgggtggggcaagctcttctattctggttcatggtttctcttggctatatggttcatccgggggagagattgagcttcaagaaatagtgaatggtcttatcaatacacaaatgtataactccccaggaatttcaattgcgcttatattcatcactgtaggaattgggttcaagctttccctagccccttctcatcaatggactcctgacgtatacgaaggagtgcggttcgtttgagaaattcctacctctctatctatctctgagatgtttggatttttcaaaactctatggacatgcagaagagaaatgctatccccacgcagaccaagacagaactttgacttgttcaaataacaattaaggtgaagcagggtcaggaacaacgaatctctttatgataaacggatccattttgcaagtttgttattacgggtagttcctgcaaaggatcggactaatgacgtatacaagaaagacttgaattctcgatgtagatgctacatagttggttctcatccttcagagactacgagtgtaataggagcatccgtcgacaaaaggatcaccctaagatgataatctcatggctattgagaacgaatcaaatcagatggttccatttctcaatctttcggacgtgctcctacggaaccaaggtcgaaaagattgagaaaaatcagtcattcacaaccactgatgaaggattcctcgaaaagttaaggattagtaatccgttttagaaatagaaaggattcgatcttatacatacgcgaggaaagtaatcaaaaaagaaagaagatgagttcttctttacttttatcacttaggagccgtgcgagatgaaagtctcatgcacggttttgaatgagagaaagaagtgaggaatcctcttttcgactctgactctcccactccagtcgttgcttttctttctgttacttcgaaagtagctgcttcagcttcagccactcgaattttcgatattcctttttatttctcatcaaatgaatggcatcttcttctggaaatcctagctattcttagcatgatattcgggaatctcattgctattactcaaacaagcatgaaacgtatgcttgcatattcgtccataggtcaaatcggatatgtaattattggaataattgttggagactcaaatggtggatatgcgagcatgataacttatatgctgttctatatcgccatgaatctaggaacttttgcttgcattatattatttggtctacgtaccggaactgataacattcgagattatgcaggattatacacaaaagatccttttttggctctctctttagctctatgtctcttatccctaggaggtcttcctccactagcaggtttttttggaaaactccatttattctggtgtggatggcaggcaggcctatatttcttggtttcaataggactccttacgagcgttctttctatctactattatctaaaaataatcaagttattaatgactggacgaaaccaagaaataacccctcacatgcgaaattatagaatatcccctttaagatcaaacaattccatcgaattgagtatgattgtatgtgtgatagcatctactataccaggaatatcaatgaacccgattattgcgattgctcaggataccctttttagcttctagaatctatttcttagttcaagatccctcttactaatactaactggaatcaaagaattagtagatcggttccgcccaaaatgggaatggactaaggttatgaacttataatctataatctgatgatcgagtcgattccatgattataagttcattccataccggaccagaccggaataaggttatatacattctcattatgagaaggggtcattcgagcgtatctaaatagatactatgtttacatagggatccctacgtcgttacattccatttaggattaggaataggcgaaatctgacctactttttacatatctctcgttatttgggaccctattcacctctttggttggacttctattgaatcgagaaatagatttgattgtccatctttttgatataatatatattaatatatatataaggcatcctccggataattcaaatctaagcaattagatgtccgactcgggcctatatgacatgaccgatcaatagaaatacttcaacactccacttttgtcatatattcaataccttactagatagatatcatatttatggaatacgattcactttgaagatgccttggtggtgaaatggtagacacgcgagactcaaaatctcgtgctaaagagcgtggaggttcgagtcctcttcaaggcataatattgaaatggaataagttcggcagcggatcgcgaaatattggcgatcttctctatctaatgaatggggagggggagtccgctttgaaatcgtccgccctgcgccccgcagtatatgattcaacaggaatcacacaagggtagattgatacaatctaaacctctggtaaaaagccccccgtaacccggcagattcaagtacattacatagtccgttttagggattggtgacttacccattcagtgactttggcactggatggacgttaccaaaattggtactatcgggtcgggtgaattcaataatagacgcctggcggcattccagccttccttctcctttcaggacctatcctaaagagaatccagtacttcttggtcgtgaatatctgaatagggcgaaccactccgtggatatctttacttcggaacaaaacaattagaattaggctcggtcaactggaatgtgtcttatccatataggggatcttccaattgagaagatctatcgacctgagacgaagagaaaggtctatctattttatttagttattcagttgattcgttattggaacagatagcaacaacaatttaatccgacatgcgtatttttgattttccaatggatttccatcttttattaatggaaatttttttgatgtagtgagtaatagctccggttgttcgctgttcaagaattcttgtttaggcagttcataccatccatacatagtgttttgatctaagatttcaattcttccatgtttcagtagtagcatattgttccatggagctaagtggaagaaacaggtgtttatacaactctaccacccagtcaattccgttccacttaatccctatttcatggccacatatctttccggctaagtaatgggaaacccttctcctgttacattacatgaatcctattttcatttcatccgagaaaagccatctttttttcaacaatgtctttgtcattcgatccaatagcgttccgttagatatgaacagatttgataaatactgataactctcggatcgagtattagaacggaaaaatccattagataatgaactattggttctaagccatctctggcgctgaatcaacaattcgaagtgcttttcttgcgtattcttgataaaccagcgtttatatatagatgtaggaggatccgtttgggaagtaagaagcccctttgacatctcttcatctgcaaagaattctcgatgtgaaaacacagagacaaagggttgatctttgaataggaaaaagagtggatctgcggggtcccaaatgaattggcttattctaaaaaagccttgttctttggaagacctatctcgtctctggtactgcatggttccgctctgcaagaactccgaatcattctcttgaagctcatacttttcatcataaatgatccgcttgccccgaaatgacccggccgaatagggaaatcccaattcattaggcctttcgatacaatcaaatagaaagccccgagggcgccatattctaggagcccaaactatgtgattgaataaatcctcctctatctgttgcgggtcgaggactccttctccttccccttcttcaaactccgattcgtatttttcatagagaaatctctgatcaacgatagaacaagatccatcttgcatcatatataagggatcccttggttcggagcgaaaaagcaatgtcactcgatcattatcaaactgactgcaatctttttctgtccgtgaggatcccaccaaagcgccttgcacttctaataggccatgaactagatccgaatcattctcaacgaatccataagaagtgatcctatttttttcatcgggtacgggtagagaccaaaggtcttgagcgaccgatccggcagaacaactcaaaagataaagaagtatcgtgaatttcttcatgctcgttccaagctcgaagtaccatttgtacaaataagaatccccttcgttacatgatttcttcttcatatagatagatataggatctatggggcaattacttataagtacattttgtgcaacagcccttcctatctgatagaaaaggatcccatgatcctgaaccgatcttacctgggatcgcaaatcccaagtttgtctatgaagagcagatctaattgtattagtgtctataattgatttcttctgtgtaatactaattgatagggcctcattggtaagtgctacaagatctcgtgcactggaacccatggttatagactcgaatccattagtatggaacattttcttttccaagtgaaatcccctagtataggaaagagtgaaaaagtgctttcgttgttgtggaataagaagccttcgtattttaatgcatgtatttaatttattcggggctattagagcgggatccactttttggggaatatgagtcgaagcaataacaagaatatttctagtggaacatctttcacaatccctggagagagagttcaccaatagaccgagggctaagtaactcgactcattcacatcaagatcatgaatgtttggaatccatattatgcaaggagacattgcttttgctaattcgaattgaagggtgatataaaatcggtctatttccaacatcatatccatagttagcgcattcatcatagttagaagctccagctccgtatcaagttcacgatcaatatcgttactagcatcaatatcgtcactatcatcaatatcgatatcatcaataaaaaaacctttcggcttgttatccaggaacttgttcagaaatactgtaatgaaaggaacataggagtttgtcgctaggtatttgaccaaataggatcgtccagttcctatagaacctatcactaaaatactcctagagggggatagggctaagcggagcgaaaagggttttccatgagacgggaaatgaaaactattagccccacacgaagtttgtgaataagtgattgtctgataatgagcaaggaatatccgtctttctgctaaacaggatgtattgaactcataattcattagatactttttatgaatgtcaactaagtatcgtaagtaaattgttcccggttgttcaatcatttgataaccagagtcattctttgataaatgatcactatgagtcagactcaatagaatttgatcaatccttttttctgcccttaaggtggagaactgaaccaagaattctctttctttatcatcaatcgaatcactgttcgcgacccaggattctattttatcatcaatccaatcaccgctcacgttttttctttttcttatcaatgaatagatctctttacttgtatgacttagatgtctcgtatttctcgaaaaagtgattcgattgatgggatttggtatgatacttatgagatcgatgatatcgatgaaatttattttcaaatctttcttcttagaacgtattgatttgaccccataagcgggatcaccaccccatagcatgttgccgccagaaccccgtatttcttctagacaatctcctaattgttccagagcaactagaaaaagattctttaaccagaaagaattcagttcagatgtaggatacctatccagaagttttcgcaactcaatcatgtatgatggaatcatcaaagatttgatcttttcgaactctgtctgtaactcactataggctcgggaaacaaagagaagatgtgtacgaacgatatatccagcaacaagaagaaggaaaaggattgaatagaggacctcacgaacatttggcgatctcagatgtgtcgatatcaatgatgactcattatttcgatgaatcatttcttcggacagaagaagattatgtaaagacttactcgaaatctcacttatcagattcctttgtggaagacacaattttttctgaagaattcgccatgatatatctaatccatgcataatatcatgaaaaatggatacaaatttttgactgctacttagtatccgcaataggtctgaaaaagtatctaaaaatatcaaatttagatatttgtaccctgtcgaagtaaagaaccatggcatatatgtttggaatagattccattttgagagagttgaaaaagcactatctcgttgaaaggttctatccatctgccctttgtcaacgcatttttttaggcaaagactccgttttttcctctgtaaatatttctcagaacatggagtgtgaatcaaacccatgtttgaattgaaattgagatactgatgcaagctcttctcttctgaatcggatagattcatatctgaaagagtttgacaatacgttctttcaaaattgactctttgtccctctattagaggtgttccagaaatgtctgcaatcgagtaaatagctctacgaactaatggatcggatcgaattggaaaatggaaagatttgtacaagttatacctttcgtcaccactttgtggaaaatcgttagatatgaatatgttagatacctgtgactcgattgacgaaggtgaaatagtatctctctccaaaaaagcatgtttttttttaccaccgcacgaagaaaatgttttgttgtgaatgaacaagatagtgaggaattgtccatacgtaaacgtaaaatcagaattattgagacgggccttttccacataaaaagggaatcttttgttacaatagaaacagaagtgatgtggattattcaagaatcgaagtcgatttgctttagaaaaagaagatatcaatgaacttctctgaaatggtttcacgggattcagccaattgtcttgatcgtgggatacgattgagaaataggctgaatccgtgttatcaaaagatttcctgcgattctttctagtatggaatgagtcaatcatccactttggtattttattgaacaaaaatggtgatattgttcctccattgatcaagaatttcgatttttgagaagtattatgatcatccaataaaaagggtttcaactttttcaaatgaacgatttgaagacctattgattctaacaactgattgcagagttgatcgttcggacctttcaattcatagatgtggatctcagacctatgaatagggatattctcgaaactcacaaagaaaaaaggaagtgagttagacaaaaagagaagtaacttggacaaaaaaagaagtaacttggacaaaaagaaacgaagtaacttagacaaaaagaaacgaagtgacttagacaaatcttttttatcaataacctcagaccaatcaatcgaatattgattaatacataattgatcgaacactacttgaaaacggctcttccgctcagaaacgaaatgttccaaatgctcctggaaattcttgctcccattggaccatttgtatctatatgcattaggatcccgatttatggatctctcggtttgagaaagaaaaataagaggatcgaaccatttcttctgactctttttcaaattcgataaatgttggttgatcgtatctttcattatagttctatgattcagagtatcatttcctattagatccctttgaattccatattcgaagttgcgatcaggtctcttcattaaaaagaatcgattcaatacatttcttatgtacccatagggactatattggaattggatttgaatcatatttcggatcaatctatattgattgactgcctccattatgttgttgctagcaaataccactcttttttgatcttccaaataattcccgcaggagatccggacccaaatttttctgagccttcgataaaaagattcattttcttcataaaaaataggaggtagaaccaataaagatttcttttttgattcatccctgaagttgaaaacctccttcaagaattgtctttgatccaatccgtaggaatcaatagaaaaggcaaatcccttatgatacaccagatccggctcggttattgatagagtgaatagatctgccatttcttgaaatctctcttctgactcgtggcgtaacgtgtatccccccctcttccgttcatggaatagatgaaataaatcaaaaaatggatttttgttcaagaatgaaatcttattggaactgtccatatccagttcatccttcggaaccatatcacatcccagatctgatgaaataggatgaattgagacggtattttgtaaatacgtaattatcttgaatatattaactatttctttattttccgatcgcctggaagggacaaaagaaacatcttgttctttcttcaacaatttctgatccctagtggacctctcagtaggattcgaacccagatgaagttctgaccatctgtcagagaaaaaagaacgaatggctcttgtaggattcccaagaaattcttcgctttcttccggaagcagatgattattcattcgcttctcacgttccgtgaatagccggggcattgaggaatagccagaaaggtatttagggaatcggtctgattctatctctcttccttccgtttgaataaaggaaggatccaaaagaatcgatctttcttttagttgttgaatctctctttgattgatcaatgtgtgatagtgatattccgaatcctcattactaatggaatcgaaaggatctatgaattgatcagaagatccgttcaattggctagaatccgttacttgaacgaaactagatcttgtagaatcatattgaatatttgacgatacgtttcgtaccttgctaaaaaatctatccttgtttaccaaccacacattgtctaaccaaatccaattctctctcgatattttcctaaaaaaatccgattcgtgcggattcttcccccaactaacgaagagatcttggtggaattgccacatatgaaattgagcacaattttgcaaagaaatagcccacttgtttctcgagaagagatgggaaacatgctcaatatcatttgattgaatagttgacccagctccttgttgtttgcagaaaccctccacttcaattggtattttttcacgaaaagcaaacatgagataacaaatccagtctttcactaagatttcgaatagctgtcccgaattcaagttgattatgtttcgcctcttactcggagaaagacgatcaaacaattcccaatcatggcccttgcggatcggatcatccatataatatacaaaaagaaactccagatatttgatatctttctctttaaatgagatatcaattccagcgacggtttcattagatatcttacaacaaaaacccctcttttttccgatccagttcctccaccaccgcgaactccagttagattcaggcatgatacacttttgagttattgggagaacccaagtactctctttcggatcccggaaacagctctcagagatcttttttccttttgtaagatacaggagcgaaacaatcaacctattgatattgcaagacccaaaagattcttccgatgtatcatttctgggtccaatggaattcataggtataggaagaagccctttcaaatagagatttttgctttcgaccatatttcgattgttaatacgatatagaagggccgctactacaaatagtactacacccttgatcgtgaaatatcgattgcttgttgaaccctgtgaattgcgcaaaagtaggatactaaaaatccgagggtccaagagttttctaaaacgttcttggtggaaaaaaatatgaatgaaagatcccactgaattgaattgggtccatgaatctaagaaatagtgagcattcttgatctctctcactatttctctcaattcgaaaatccaggatttgaattgatgtcctttcattgattcctcctaaattgcattgatttatcctaaagatttcatttcaattggaatttggttattcaccatgtacgaggatccccactaagcatccatggctgaatggttaaagcgcccaactcataattggcgaattcgtaggttcaattcctactggatgcacgccaatcggaccctccaataagtctattggaattggctctgtatcaatggaatcttctcatcatctatacataacgaattggtgtggtatattcatatcataacatatgaacagtaagaactagcattcttattgagactagaactcatagggaagaaaatcgatttatggatggaatcaaatatgcagtatttacagacaaaagtattcggttattggggaaaaatcaatatacttttaatgtcgaatcaggatcaactaggacagaaataaagcattgggtcgaactcttctttggtgtcaaggtaatagctatgaatagtcatcgactccccggaaaggttaaaagaatgggacctattctgggacatacaatgcattacagacgtatgatcattacgcttcaaccgggttattctattccacctcttagaaagaaaagaacttaaatcaaaatacttaatagcatggcgatacatttatacaaaacttctaccccgagcacacgcaatggagccgtagacagtcaagtgaaatccaatccacgaaataatttgatctgtgggcagcatcattgtggtaaaggtcgtaatgccagaggaataattaccgcaaggcatagagggggaggtcataagcgtctataccgtaaaatagattttcgacgaaatgcaaaagacatatatggtagaatcgtaaccatagaatacgaccctaatcgaaatgcatacatttgtctcatacactatggggatggtgagaagagatatattttacatcccagaggggctataattggagataccattgtttctggtacagaagttcctataaaaatgggaaatgccctacctttgagtgcggtttgaactatttgatttacgtaattggaagtaaccaattaggtttacgacgaaacctagaaatcgatcactgatccaatttgagtacctctacaggatagacctcaacagaaaactgaagagtaacggcagcaagtgattgagttcagtagttcctcatataaaattattgactctagagatatagtaatatggagaagacaaaattgtttcaagcaccgacagaaccataagcgccccttgtttcaaagagaggaggacgggttattcacatttcatttgatggtcagaggcgaattgaaagctaagcagtggtaattctaaagattcccccggggaaaaatagagatgtctcctacgttacccataatatgtggaagtatcgacgtaatttcatagagtcattcggtctgaatgctacatgaagaacataagccagatgacggaacgggaagacctaggatgtagaagatcataacataagttattcggcagattttgattcctatatatccactcgtgtggtacttctaccatatatagaagaattctacgatatatataagatccatccgtatagatatcatcatctacatccagaaagccgtatgctttggaagaagcttgtacagtttgggaaggggttttgattgatcaaaaagaagaatctacttcaaccgatatgcccttaggcacggccatacataatatagaaatcacacttggaaggggtggacaattagctagagcagcgggtgctgtagcgaaactgattgcaaaagaggggaaatcggccacattaaaattaccttctggagaggtccgtttgatatccaaaaactgctcagcaacagtcggacaagtgggaaatgttggggtaaaccagaaaagtttgggtagagccggatcgaaatgttggctaggtaaacgtcctgtagtaagaggagtagttatgaaccctgtcgaccatccccatggaggtggtgaagggagggctccaattggtagaaaaaaacccgtaaccccctggggttatcctgcacttggaagaagaactagaaaaaggaaaaaatatagtgagactttgattcttcgtcgccgtagtaaataggagagaaaatcgaatttctttcttcgtcttaaaaaaataggagttaattaactgtgacacgttcactaaaaaaaaacccttttgtagcaaagcatttattaagaaaaatagagaagcttaatacaaaggcggaaaaagaaatcataataacttggtcccgggcatc